(19) United States
(12) Patent Application Publication
(10) Pub. No.: US 2024/0093078 A1
(43) Pub. Date: Mar. 21, 2024

(54) STABILIZED HEAT TRANSFER COMPOSITIONS, METHODS AND SYSTEMS

(71) Applicant: HONEYWELL INTERNATIONAL INC., Charlotte, NC (US)

(72) Inventors: Ankit Sethi, Charlotte, NC (US); Ryan Hulse, Charlotte, NC (US); Christopher Roger, Charlotte, NC (US); Alexey Kruglov, Charlotte, NC (US); Haridasan Nair, Charlotte, NC (US)

(73) Assignee: HONEYWELL INTERNATIONAL INC., Charlotte, NC (US)

(21) Appl. No.: 18/241,651

(22) Filed: Sep. 1, 2023

Related U.S. Application Data
(60) Provisional application No. 63/403,719, filed on Sep. 3, 2022.

(51) Int. Cl. C09K 5/04

(52) U.S. Cl. CPC C09K 5/045; C09K 2205/104; C09K 2205/11; C09K 2205/24; C09K 2205/32; C09K 2205/41

(57) ABSTRACT

The present invention relates to heat transfer compositions comprising refrigerant, lubricant and stabilizer, wherein the refrigerant comprises from about 5% by weight to 100% by weight of trans-1,2-difluorethylene (R1132(E)), and wherein said lubricant comprises polyol ester (POE) lubricant and/or polyvinyl ether (PVE) lubricant, and wherein said stabilizer comprises an alkylated naphthalene and optionally but preferably an acid depleting moiety.

### CROSS REFERENCE

The present application is related to, claims the priority benefit of the incorporates by reference U.S. Provisional Application 63/403,719, filed Sep. 3, 2022.

### FIELD OF THE INVENTION

The present invention relates to compositions, methods and systems having utility in heat exchange applications, including in air conditioning and refrigeration applications. In particular aspects, the invention relates to compositions useful in heat transfer systems of the type in which the refrigerant R-410A would have been used. The compositions of the invention are useful in particular as a replacement of the refrigerant R-410A for heating and cooling applications and for retrofitting heat exchange systems, including systems designed for use with R-410A.

### BACKGROUND

Mechanical refrigeration systems, and related heat transfer devices, such as heat pumps and air conditioners, are well known in the art for industrial, commercial and domestic uses. Chlorofluorocarbons (CFCs) were developed in the 1930s as refrigerants for such systems. However, since the 1980s, the effect of CFCs on the stratospheric ozone layer has become the focus of much attention. In 1987, a number of governments signed the Montreal Protocol to protect the global environment, setting forth a timetable for phasing out the CFC products. CFCs were replaced with more environmentally acceptable materials that contain hydrogen, namely the hydrochlorofluorocarbons (HCFCs).

One of the most commonly used hydrochlorofluorocarbon refrigerants was chlorodifluoromethane (HCFC-22). However, subsequent amendments to the Montreal protocol accelerated the phase out of the CFCs and scheduled the phase-out of HCFCs, including HCFC-22.

In response to the need for a non-flammable, non-toxic alternative to the CFCs and HCFCs, industry has developed a number of hydrofluorocarbons (HFCs) which have zero ozone depletion potential. R-410A (a 50:50 w/w blend of difluoromethane (HFC-32) and pentafluoroethane (HFC-125)) was adopted as the industry replacement for HCFC-22 in air conditioning and chiller applications as it does not contribute to ozone depletion. However, R-410A is not a drop-in replacement for R-22. Thus, the replacement of R-22 with R-410A required the redesign of major components within heat exchange systems, including the replacement and redesign of the compressor to accommodate the substantially higher operating pressure and volumetric capacity of R-410A, when compared with R-22.

While R-410A has a more acceptable Ozone Depleting Potential (ODP) than R-22, the continued use of R-410A is problematic since it has a high Global Warming Potential of 2088. There is therefore a need in the art for the replacement of R-410A with a more environmentally acceptable alternative.

The EU implemented the F-gas regulation to limit HFCs which can be placed on the market in the EU from 2015 onwards, as shown in Table 1. By 2030, only 21% of the quantity of HFCs that were sold in 2015 will be available. Therefore, it is desired to limit GWP below 427 as a long-term solution.

TABLE 1
F-Gas Regulation

| Year | Phasedown Percentage | GWP Level |
|---|---|---|
| 2015 | 100% | 2034* |
| 2016-2017 | 93% | 1891 |
| 2018-2020 | 63% | 1281 |
| 2021-2023 | 67% | 915 |
| 2024-2026 | 31% | 630 |
| 2027-2029 | 24% | 488 |
| After 2030 | 21% | 427 |

*2015 GWP level is based on UNEP 2012 Use Study with no growth rate.

It is understood in the art that it is highly desirable for a replacement heat transfer fluid to possess a difficult to achieve mosaic of properties including excellent heat transfer properties (and in particular heat transfer properties that are well matched to the needs of the particular application), chemical stability, low or no toxicity, non-flammability, lubricant miscibility and/or lubricant compatibility amongst others. In addition, any replacement for R-410A would ideally be a good match for the operating conditions of R-410A in order to avoid modification or redesign of the system. The development of a heat transfer fluid meeting all of these requirements, many of which are unpredictable, is a significant challenge, especially in connection with the chemical stability of such fluids.

It is very important for maintenance of system efficiency, and proper and reliable functioning of the compressor, that the combination of refrigerant and lubricant circulating in a vapor compression heat transfer system remains sufficiently stable so as to not deteriorate the performance of the lubricant and/or the refrigerant and/or any aspect of the operating equipment used in the heat transfer system. For example, lubricant/refrigerant decomposition products might accumulate and become lodged in the coils and piping of the system, including in the heat transfer components, and/or decomposition may prevent the full and effective lubrication of the compressor.

Applicants have come to appreciate that it is desirable to be able to provide compositions which are capable of being used as a replacement for R-410A in air conditioning applications, and in particular in residential air conditioning and commercial air conditioning applications, which include rooftop air conditioning, variable refrigerant flow (VRF) air conditioning and chiller air conditioning applications. Applicants have also come to appreciate that the compositions, methods and systems of the invention have advantage in, for example, heat pump and low temperature refrigeration systems.

### SUMMARY

The present invention provides heat transfer compositions, including those which can be used as replacements for R-410A, which exhibit excellent thermal and chemical stability.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising one or more of alkylated naphthalene, epoxylated naphthalene, acid depleting moiety, nitrogen-containing stabilizer, phosphorous-containing stabilizer and a diene stabilizer. The heat transfer composition according to this paragraph is sometimes referred to herein for convenience as Heat Transfer Composition 1A.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising alkylated naphthalene. The heat transfer composition according to this paragraph is sometimes referred to herein for convenience as Heat Transfer Composition 1B.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising ethoxylated naphthalene. The heat transfer composition according to this paragraph is sometimes referred to herein for convenience as Heat Transfer Composition 1C.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising acid depleting moiety. The heat transfer composition according to this paragraph is sometimes referred to herein for convenience as Heat Transfer Composition 1D.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising nitrogen-containing stabilizer. The heat transfer composition according to this paragraph is sometimes referred to herein for convenience as Heat Transfer Composition 1E.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising phosphorous-containing stabilizer. The heat transfer composition according to this paragraph is sometimes referred to herein for convenience as Heat Transfer Composition 1F.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising a diene stabilizer. The heat transfer composition according to this paragraph is sometimes referred to herein for convenience as Heat Transfer Composition 1G.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising alkylated naphthalene. The heat transfer composition according to this paragraph is sometimes referred to herein for convenience as Heat Transfer Composition 1H.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising alkylated naphthalene, wherein said alkylated naphthalene is present in the composition in an amount of from 1% to less than 10% by weight by weight based on the weight of the alkylated naphthalene and the lubricant. The heat transfer composition according to this paragraph is sometimes referred to herein for convenience as Heat Transfer Composition 11.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising epoxylated naphthalene. The heat transfer composition according to this paragraph is sometimes referred to herein for convenience as Heat Transfer Composition 1J.

The present invention includes heat transfer compositions comprising refrigerant, lubricant and stabilizer, said refrigerant comprising from about 5% by weight to 100% by weight of trans-1,2-difluorethylene (R1132(E)), said lubricant preferably comprising polyol ester (POE) lubricant and/or polyvinyl ether (PVE) lubricant, and said stabilizer comprising epoxylated naphthalene, wherein said epoxylated naphthalene is present in the composition in an amount of from 1% to less than 10% by weight by weight based on the weight of the epoxylated naphthalene and the lubricant. The heat transfer composition according to this paragraph is sometimes referred to herein for convenience as Heat Transfer Composition 1K.

As used herein with respect to percentages based on a list of identified compounds, the term “relative percentage” means the percentage of the identified compound based on the total weight of the listed compounds.

As used herein with respect to weight percentages, the term “about” with respect to an amount of an identified component means the amount of the identified component can vary by an amount of +/−2% by weight.

In connection with the use of stabilizers comprising alkylated naphthalene in heat transfer compositions comprising refrigerant containing R1132(E) and lubricant, especially lubricant that comprises POE and/or PVE, applicants believe that a critical range exists in which the stabilizing effect of the alkylated naphthalene is beneficially and unexpectedly enhanced relative to the stabilizing effect outside of the range of from 1% to less than 10% by weight based on the alkylated naphthalene and the lubricant, or preferably from 1.5% to less than 8%, or preferably from 1.5% to about 6%, or preferably from 1.5 to 5%. In particular, the applicants believe that enhanced performance within this critical range will be achieved because the stabilizing performance of the alkylated naphthalene can, in the absence of the solutions described hereinafter, deteriorate to an undesirable extent when used in amounts above about 10%. Furthermore, applicants believe that the stabilizing performance of alkylated naphthalene will be less than desirable for some applications when used in amounts of less than 1%. The existence of this critical range with heat transfer compositions that comprise R1132(E) and POE and/or PVE lubricant is unexpected.

The present invention includes heat transfer compositions comprising refrigerant, lubricant and stabilizer, said refrigerant comprising from about 10% by weight to about 75% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1% to less than 10% by weight based on the weight of the alkylated naphthalene and the lubricant. The heat transfer composition according to this paragraph is sometimes referred to herein for convenience as Heat Transfer Composition 2A.

The present invention includes heat transfer compositions comprising refrigerant, lubricant and stabilizer, said refrigerant comprising from about 10% by weight to about 75% by weight of trans-1,2-difluorethylene (R1132(E)), said lubricant comprising polyol ester (POE) lubricant and/or polyvinyl ether (PVE) lubricant, and said stabilizer comprising epoxylated naphthalene, wherein said epoxylated naphthalene is present in the composition in an amount of from 1% to less than 10% by weight based on the weight of the epoxylated naphthalene and the lubricant. The heat transfer composition according to this paragraph is sometimes referred to herein for convenience as Heat Transfer Composition 2B.

The present invention includes heat transfer compositions comprising refrigerant, lubricant and stabilizer, said refrigerant comprising from about 40% by weight to about 50% by weight by weight of R-1234yf and from about 40% by weight to about 50% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1% to less than 10% by weight based on the weight of the alkylated naphthalene and the lubricant. The heat transfer composition according to this paragraph is sometimes referred to herein for convenience as Heat Transfer Composition 3A.

The present invention includes heat transfer compositions comprising refrigerant, lubricant and stabilizer, said refrigerant comprising from about 40% by weight to about 50% by weight by weight of R-1234yf and from about 40% by weight to about 50% by weight of trans-1,2-difluorethylene (R1132(E)), said lubricant comprising polyol ester (POE) lubricant and/or polyvinyl ether (PVE) lubricant, and said stabilizer comprising epoxylated naphthalene, wherein said epoxylated naphthalene is present in the composition in an amount of from 1% to less than 10% by weight based on the weight of the epoxylated naphthalene and the lubricant. The heat transfer composition according to this paragraph is sometimes referred to herein for convenience as Heat Transfer Composition 3B.

The present invention includes heat transfer compositions comprising refrigerant, lubricant and stabilizer, said refrigerant consisting essentially of from about 40% by weight to about 50% by weight by weight of R-1234yf, from about 1% by weight to about 20% by weight by weight of difluoromethane (HFC-32), and from about 40% by weight to about 50% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1% to less than 10% by weight based on the weight of the alkylated naphthalene and the lubricant. The heat transfer composition according to this paragraph is sometimes referred to herein for convenience as Heat Transfer Composition 4A.

The present invention includes heat transfer compositions comprising refrigerant, lubricant and stabilizer, said refrigerant consisting essentially of from about 40% by weight to about 50% by weight by weight of R-1234yf, from about 1% by weight to about 20% by weight by weight of difluoromethane (HFC-32), and from about 40% by weight to about 50% by weight of trans-1,2-difluorethylene (R1132(E)), said lubricant comprising polyol ester (POE) lubricant and/or polyvinyl ether (PVE) lubricant, and said stabilizer comprising epoxylated naphthalene, wherein said epoxylated naphthalene is present in the composition in an amount of from 1% to less than 10% by weight based on the weight of the epoxylated naphthalene and the lubricant. The heat transfer composition according to this paragraph is sometimes referred to herein for convenience as Heat Transfer Composition 4B.

The present invention includes heat transfer compositions comprising refrigerant, lubricant and stabilizer, said refrigerant comprising from about 5% by weight to 100% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1% to 8% by weight by weight based on the weight of the alkylated naphthalene and the lubricant. The heat transfer composition according to this paragraph is sometimes referred to herein for convenience as Heat Transfer Composition 5.

The present invention includes heat transfer compositions comprising refrigerant, lubricant and stabilizer, said refrigerant comprising from about 10% by weight to about 75% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1% to 8% by weight based on the weight of the alkylated naphthalene and the lubricant. The heat transfer composition according to this paragraph is sometimes referred to herein for convenience as Heat Transfer Composition 6.

The present invention includes heat transfer compositions comprising refrigerant, lubricant and stabilizer, said refrigerant comprising from about 5% by weight to about 50% by weight by weight of R1234yf and from about 35% by weight to about 70% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1% to 8% by weight based on the weight of the alkylated naphthalene and the lubricant. The heat transfer composition according to this paragraph is sometimes referred to herein for convenience as Heat Transfer Composition 7.

The present invention includes heat transfer compositions comprising refrigerant, lubricant and stabilizer, said refrigerant consisting essentially of from about 30% by weight to about 50% by weight by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1% to 8% by weight based on the weight of the alkylated naphthalene and the lubricant. The heat transfer composition according to this paragraph is sometimes referred to herein for convenience as Heat Transfer Composition 8.

The present invention includes heat transfer compositions comprising refrigerant, lubricant and stabilizer, said refrigerant comprising from about 5% by weight to 100% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1.5% to 8% by weight by weight based on the weight of the alkylated naphthalene and the lubricant. The heat transfer composition according to this paragraph is sometimes referred to herein for convenience as Heat Transfer Composition 9.

The present invention includes heat transfer compositions comprising refrigerant, lubricant and stabilizer, said refrigerant comprising from about 10% by weight to about 75% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1.5% to 8% by weight based on the weight of the alkylated naphthalene and the lubricant. The heat transfer composition according to this paragraph is sometimes referred to herein for convenience as Heat Transfer Composition 10A.

The present invention includes heat transfer compositions comprising refrigerant, lubricant and stabilizer, said refrigerant comprising from about 10% by weight to about 75% by weight of trans-1,2-difluorethylene (R1132(E)), said lubricant comprising polyol ester (POE) lubricant and/or polyvinyl ether (PVE) lubricant, and said stabilizer comprising alkylated naphthalene, wherein said alkylated naphthalene is present in the composition in an amount of from 1.5% to 6% by weight based on the weight of the alkylated naphthalene and the lubricant. The heat transfer composition according to this paragraph is sometimes referred to herein for convenience as Heat Transfer Composition 10B.

The present invention also includes any of Heat Transfer Compositions 1-10 wherein said stabilizer comprises BHT. The heat transfer composition according to this paragraph is sometimes referred to herein for convenience as Heat Transfer Composition 11.

The present invention also includes any of Heat Transfer Compositions 1-11 wherein said stabilizer is essentially free of an ADM as defined hereinafter. The heat transfer composition according to this paragraph is sometimes referred to herein for convenience as Heat Transfer Composition 12.

As used herein, the term “acid depleting moiety” (which is sometimes referred to herein for convenience as “ADM”) means a compound or radical which when present in a heat transfer composition comprising a refrigerant that contains about 5% by weight or greater of R1132(E) (said percentage being based in the weight of all the refrigerants in the heat transfer composition), has the effect of substantially reducing the acid moieties that would otherwise be present in the heat transfer composition. As used herein, the term “substantially reducing” as used with respect to the acid moieties in the heat transfer composition means that acid moieties are reduced sufficiently to result in a reduction in TAN value (as defined hereinafter) of at least about 10 relative percent.

In connection with the use of stabilizers comprising alkylated naphthalene and an ADM, applicants have found that certain materials are able to substantially and unexpectedly enhance the performance of stabilizers which comprise or consist essentially of alkylated naphthalene stabilizer(s). In particular, applicants have found that certain materials are able to aid in the depletion of acidic moieties in heat transfer compositions containing R1132(E), including any heat transfer compositions of the present invention. Applicants have found that formulating heat transfer compositions to have an ADM provides an unexpected and synergistic enhancement to the stability function of at least the alkylated naphthalene stabilizers according to the present invention. The reason for this synergistic effect is not understood with certainty, but without being bound by or to any theory of operation, it is believed that the alkylated naphthalene stabilizers of the present invention function in large part by stabilizing free radicals formed from the R1132(E) of the present refrigerants, but that this stabilizing effect is at least somewhat diminished in the presence of acid moieties. As a result, the presence of the ADM of the present invention allows the alkylated naphthalene stabilizers to perform with an unexpected and synergistically enhanced effect. Furthermore, applicants have found that the deterioration in performance which applicants have observed at relatively high concentrations of alkylated naphthalene (i.e., about 10%) can be counteracted by the incorporation into the heat transfer composition (or into a stabilized lubricant) of an ADM.

The heat transfer compositions of the present invention therefore in preferred embodiments includes a stabilizer comprising an alkylated naphthalene and an ADM. The stabilizer according to this paragraph is sometimes referred to herein for convenience as Stabilizer 1.

The heat transfer compositions of the present invention therefore in preferred embodiments includes a stabilizer comprising from about 40% by weight to about 99.9% of alkylated naphthalenes and from 0.05% to about 50% by weight of ADM based on the weight of the stabilizer. The stabilizer according to this paragraph is sometimes referred to herein for convenience as Stabilizer 2.

The heat transfer compositions of the present invention therefore in preferred embodiments includes a includes stabilizer comprising from about 40% by weight to about 95% of alkylated naphthalenes and from 5% to about 20% by weight of ADM based on the weight of the alkylated naphthalenes and ADM in the stabilizer. The stabilizer according to this paragraph is sometimes referred to herein for convenience as Stabilizer 3.

The heat transfer compositions of the present invention in preferred embodiments include a stabilizer comprising an alkylated naphthalene and at least one co-stabilizer selected from acid depleting moiety, nitrogen-containing stabilizer, phosphorous-containing stabilizer, a diene stabilizer and combinations of two or more of these. The stabilizer according to this paragraph is sometimes referred to herein for convenience as Stabilizer 4A.

The heat transfer compositions of the present invention in preferred embodiments include a stabilizer comprising an epoxylated naphthalene. The stabilizer according to this paragraph is sometimes referred to herein for convenience as Stabilizer 4B.

The heat transfer compositions of the present invention in preferred embodiments include a stabilizer comprising an epoxylated naphthalene and at least one co-stabilizer selected from acid depleting moiety, nitrogen containing stabilizer, phosphorous containing stabilizer, diene stabilizer and combinations of two or more of these. The stabilizer according to this paragraph is sometimes referred to herein for convenience as Stabilizer 4C.

The heat transfer compositions of the present invention in preferred embodiments include a stabilizer comprising nitrogen-containing stabilizer. The stabilizer according to this paragraph is sometimes referred to herein for convenience as Stabilizer 4D.

The heat transfer compositions of the present invention in preferred embodiments include a stabilizer comprising nitrogen-containing stabilizer and at least one co-stabilizer comprising an epoxylated naphthalene, alkylated naphthalene, acid depleting moiety, phosphorous containing stabilizer, terpinene stabilizer and combinations of two or more of these. The stabilizer according to this paragraph is sometimes referred to herein for convenience as Stabilizer 4E.

The heat transfer compositions of the present invention in preferred embodiments include a stabilizer comprising a phosphorous containing stabilizer. The stabilizer according to this paragraph is sometimes referred to herein for convenience as Stabilizer 4F.

The heat transfer compositions of the present invention in preferred embodiments include a stabilizer comprising a phosphorous containing stabilizer and at least one co-stabilizer selected from alkylated naphthalene, epoxylated naphthalene, acid depleting moiety, nitrogen containing stabilizer, terpinene stabilizer and combinations of two or more of these. The stabilizer according to this paragraph is sometimes referred to herein for convenience as Stabilizer 4G.

The heat transfer compositions of the present invention in preferred embodiments include a stabilizer comprising a triaryl phosphate. The stabilizer according to this paragraph is sometimes referred to herein for convenience as Stabilizer 4H.

The heat transfer compositions of the present invention in preferred embodiments include a stabilizer comprising a triaryl phosphate and at least one co-stabilizer selected from acid depleting moiety, nitrogen containing stabilizer, epoxylated naphthalene, alkylated naphthalene, diene stabilizer and combinations of two or more of these. The stabilizer according to this paragraph is sometimes referred to herein for convenience as Stabilizer 41.

The present invention also includes heat transfer compositions comprising refrigerant, lubricant comprising POE lubricant and/or polyvinyl ether (PVE) lubricant and Stabilizer 1, said refrigerant comprising from about 5% by weight to 100% by weight of trans-1,2-difluorethylene (R1132(E)). The heat transfer composition according to this paragraph is sometimes referred to herein for convenience as Heat Transfer Composition 13.

The present invention also includes heat transfer compositions comprising refrigerant, lubricant comprising POE lubricant and/or polyvinyl ether (PVE) lubricant and Stabilizer 2, said refrigerant comprising from about 5% by weight to 100% by weight of trans-1,2-difluorethylene (R1132(E)). The heat transfer composition according to this paragraph is sometimes referred to herein for convenience as Heat Transfer Composition 14.

The present invention also includes heat transfer compositions comprising refrigerant, lubricant comprising POE lubricant and/or polyvinyl ether (PVE) lubricant and Stabilizer 3, said refrigerant comprising from about 5% by weight to 100% by weight of trans-1,2-difluorethylene (R1132(E)). The heat transfer composition according to this paragraph is sometimes referred to herein for convenience as Heat Transfer Composition 15A.

The present invention also includes heat transfer compositions comprising refrigerant, lubricant comprising POE lubricant and/or polyvinyl ether (PVE) lubricant and Stabilizer 4, said refrigerant comprising from about 5% by weight to 100% by weight of trans-1,2-difluorethylene (R1132(E)). The heat transfer composition according to this paragraph is sometimes referred to herein for convenience as Heat Transfer Composition 15B.

The present invention also includes heat transfer compositions comprising refrigerant, lubricant comprising POE lubricant and/or polyvinyl ether (PVE) lubricant and Stabilizer 1, said refrigerant comprising from about 20% by weight to about 75% by weight of trans-1,2-difluorethylene (R1132(E)). The heat transfer composition according to this paragraph is sometimes referred to herein for convenience as Heat Transfer Composition 16.

The present invention also includes heat transfer compositions comprising refrigerant, lubricant comprising POE lubricant and/or polyvinyl ether (PVE) lubricant and Stabilizer 2, said refrigerant comprising from about 20% by weight to about 75% by weight of trans-1,2-difluorethylene (R1132(E)). The heat transfer composition according to this paragraph is sometimes referred to herein for convenience as Heat Transfer Composition 17.

The present invention also includes heat transfer compositions comprising refrigerant, lubricant comprising POE lubricant and/or polyvinyl ether (PVE) lubricant and Stabilizer 3, said refrigerant comprising from about 20% by weight to about 75% by weight of trans-1,2-difluorethylene (R1132(E)). The heat transfer composition according to this paragraph is sometimes referred to herein for convenience as Heat Transfer Composition 18.

The present invention also includes heat transfer compositions comprising refrigerant, lubricant comprising POE lubricant and/or polyvinyl ether (PVE) lubricant and Stabilizer 4, said refrigerant comprising from about 20% by weight to about 75% by weight of trans-1,2-difluorethylene (R1132(E)). The heat transfer composition according to this paragraph is sometimes referred to herein for convenience as Heat Transfer Composition 19.

The present invention also includes heat transfer compositions comprising refrigerant, lubricant comprising POE lubricant and/or polyvinyl ether (PVE) lubricant and Stabilizer 1, said refrigerant comprising from about 5% by weight to about 50% by weight difluoromethane (HFC-32) and from about 35% by weight to about 70% by weight of trans-1,2-difluorethylene (R1132(E)). The heat transfer composition according to this paragraph is sometimes referred to herein for convenience as Heat Transfer Composition 20.

The present invention also includes heat transfer compositions comprising refrigerant, lubricant comprising POE lubricant and/or polyvinyl ether (PVE) lubricant and Stabilizer 2, said refrigerant comprising from about 40% by weight to about 50% by weight R1234yf and from about 40% by weight to about 50% by weight of trans-1,2-difluorethylene (R1132(E)). The heat transfer composition according to this paragraph is sometimes referred to herein for convenience as Heat Transfer Composition 21A.

The present invention also includes heat transfer compositions comprising refrigerant, lubricant comprising POE lubricant and/or polyvinyl ether (PVE) lubricant and Stabilizer 3, said refrigerant comprising from about 5% by weight to about 50% by weight difluoromethane (HFC-32) and from about 35% by weight to about 70% by weight of trans-1,2-difluorethylene (R1132(E)). The heat transfer composition according to this paragraph is sometimes referred to herein for convenience as Heat Transfer Composition 21B.

The present invention also includes heat transfer compositions comprising refrigerant, lubricant comprising POE lubricant and/or polyvinyl ether (PVE) lubricant and Stabilizer 4, said refrigerant comprising from about 40% by weight to about 50% by weight R1234yf and from about 40% by weight to about 50% by weight of trans-1,2-difluorethylene (R1132(E)). The heat transfer composition according to this paragraph is sometimes referred to herein for convenience as Heat Transfer Composition 21C.

The present invention also includes heat transfer compositions comprising refrigerant, lubricant comprising POE lubricant and/or polyvinyl ether (PVE) lubricant and Stabilizer 1, said refrigerant comprising from about 30% by weight to about 50% by weight difluoromethane (HFC-32), from 3 to 15% by weight pentafluoroethane (HFC-125) and from about 35% by weight to about 70% by weight of trans-1,2-difluorethylene (R1132(E)). The heat transfer composition according to this paragraph is sometimes referred to herein for convenience as Heat Transfer Composition 22.

The present invention also includes heat transfer compositions comprising refrigerant, lubricant comprising POE lubricant and/or polyvinyl ether (PVE) lubricant and Stabilizer 2, said refrigerant comprising from about 1% by weight to about 20% by weight difluoromethane (HFC-32), from about 40% to about 50% by weight R-1234yf and from about 40% by weight to about 50% by weight of trans-1,2-difluorethylene (R1132(E)). The heat transfer composition according to this paragraph is sometimes referred to herein for convenience as Heat Transfer Composition 23.

The present invention also includes heat transfer compositions comprising refrigerant, lubricant comprising POE lubricant and/or polyvinyl ether (PVE) lubricant and Stabilizer 3, said refrigerant comprising from about 30% by weight to about 50% by weight difluoromethane (HFC-32), from 3 to 15% by weight pentafluoroethane (HFC-125) and from about 35% by weight to about 70% by weight of trans-1,2-difluorethylene (R1132(E)). The heat transfer composition according to this paragraph is sometimes referred to herein for convenience as Heat Transfer Composition 24.

The present invention also includes heat transfer compositions comprising refrigerant, lubricant comprising POE lubricant and/or polyvinyl ether (PVE) lubricant and Stabilizer 4, said refrigerant comprising from about 1% by weight to about 20% by weight difluoromethane (HFC-32), from about 40% to about 50% by weight R-1234yf and from about 40% by weight to about 50% by weight of trans-1,2-difluorethylene (R1132(E)). The heat transfer composition according to this paragraph is sometimes referred to herein for convenience as Heat Transfer Composition 25A.

### DESCRIPTION

### Definitions

For the purposes of this invention, the term “about” in relation to temperatures in degrees centigrade (° C.) means that the stated temperature can vary by an amount of +/−5° C. In preferred embodiments, temperature specified as being about is preferably +/−2° C., more preferably +/−1° C., and even more preferably +/−0.5° C. of the identified temperature.

The term “capacity” is the amount of cooling provided, in BTUs/hr., by the refrigerant in the refrigeration system. This is experimentally determined by multiplying the change in enthalpy in BTU/lb., of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The time period usually used for GWP is 100 years. GWP provides a common measure, which allows analysts to add up emission estimates of different gases. See www.epa.gov.

The phrase “Life Cycle Climate Performance” (hereinafter “LCCP”) is a method by which air conditioning and refrigeration systems can be evaluated for their global warming impact over the course of their lifetime. LCCP includes the direct impacts of refrigerant emissions and the indirect impacts of energy consumption used to operate the system, energy to manufacture the system, and transport and safely dispose of the system. The direct impacts of refrigerant emissions are obtained from the refrigerant's GWP value. For the indirect emissions, the measured refrigerant properties are used to obtain the system performance and energy consumption. LCCP is determined by using Equations 1 and 2 as follows. Equation 1 is Direct Emissions=Refrigerant Charge (kg)×(Annual Loss Rate×Lifetime+End-of-Life Loss)×GWP. Equation 2 is Indirect Emissions=Annual Power Consumption×Lifetime×CO₂ per kW-hr of electrical production. The Direct Emissions as determined by Equation 1 and the Indirect Emissions as determined by Equation 2 are added together to provide the LCCP. TMY2 and TMY3 data produced by the National Renewable Laboratory and available in BinMaker® Pro Version 4 Software is used for the analysis. The GWP values reported in the Intergovernmental Panel on Climate Change (IPCC)'s Assessment Report 4 (AR4) 2007 are used for the calculations. LCCP is expressed as carbon dioxide mass (kg-CO_{2eq}) over the lifetime of the air conditioning or refrigeration systems.

The term “mass flow rate” is the mass of refrigerant passing through a conduit per unit of time.

The term “Occupational Exposure Limit (OEL)” is determined in accordance with ASHRAE Standard 34-2016 Designation and Safety Classification of Refrigerants.

As the term is used herein, “replacement for” with respect to a particular heat transfer composition or refrigerant of the present invention as a “replacement for” a particular prior refrigerant means the use of the indicated composition of the present invention in a heat transfer system that heretofore had been commonly used with that prior refrigerant. By way of example, when a refrigerant or heat transfer composition of the present invention is used in a heat transfer system that has heretofore been designed for and/or commonly used with R410A, such as residential air conditioning and commercial air conditioning (including roof top systems, variable refrigerant flow (VRF) systems and chiller systems) then the present refrigerant is a replacement for R410A is such systems.

The phrase “thermodynamic glide” applies to zeotropic refrigerant mixtures that have varying temperatures during phase change processes in the evaporator or condenser at constant pressure.

The phrase “thermodynamic glide” applies to zeotropic refrigerant mixtures that have varying temperatures during phase change processes in the evaporator or condenser at constant pressure.

As the term is used herein, “TAN value” refers to the total acid number as determined in accordance with ASHRAE Standard 97—“Sealed Glass Tube Method to Test the Chemical Stability of Materials for Use within Refrigerant Systems” to simulate long-term stability of the heat transfer compositions by accelerated aging.

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase “saturation temperature” means the temperature at which the liquid refrigerant boils into vapor at a given pressure.

The phrase “no or low toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and low-toxicity would be classified as “A1” by ASHRAE Standard 34-2016 Designation and Safety Classification of Refrigerants and described in Appendix B1 to ASHRAE Standard 34-2016 (as each standard exists as of the filing date of this application).

The term “degree of superheat” or simply “superheat” means the temperature rise of the refrigerant at the exit of the evaporator above the saturated vapor temperature (or dew temperature) of the refrigerant.

As used herein, the term “trans-1,2-difluorethylene” means the trans isomer of 1,2-difluorethylene and is abbreviated as R1132(E).

As used herein, the term “E-1,3,3,3-tetrafluoropropene” means the trans isomer of HFO-1234ze and is abbreviated as HFO-1234ze (E).

As used herein, the term “2,3,3,3-tetrafluoropropene” is abbreviated as HFO-1234yf.

As used herein, the term “1,1,1,2-tetrafluoroethane” is abbreviated as HFC-134a.

As used herein, the term “1,1,1,2-tetrafluoroethane” is known in the industry by the abbreviation HFC-134a and is abbreviated herein as HFC-134a.

As used herein, the term “E-1,1,1,4,4,4-hexafluorobut-2-ene” means the trans isomer of HFO-1336mzz and is abbreviated as HFO-1336mzz (E).

As used herein, the term “1,1,1,2,3,3,3-heptafluoropropane” is abbreviated as HFC-227ea.

As used herein, the term “difluoromethane” means CH₂F₂ and is abbreviated as HFC-32.

As used herein, the term “residential air conditioning” refers to a refrigeration system that operates with a heat exchanger that absorbs or adds heat to the indoor air in a structure in which humans reside.

As used herein, the term “split direct expansion air conditioning system” refers to an air conditioning system that operates with an indoor unit that is located inside the residence and contains a heat exchanger that absorbs heat from or adds heat to the indoor air in a structure in which humans reside and with an outdoor unit that includes a heat exchanger located outside the residence that rejects heat to or absorbs heat from outdoor air.

As used herein, the term “secondary loop air conditioning system” refers to an air conditioning system having an inside refrigeration circuit using an indoor (or secondary) refrigerant to heat and/or cool the inside air and an outside refrigeration circuit that uses an outdoor (or primary) refrigerant that is different than the indoor refrigerant and that rejects heat to or absorbs heat from the outside air.

As used herein, reference to a defined group, such as “Heat Transfer Compositions 1-25,” refers to each composition within that group, including wherein a definition number includes a suffix. For example, reference to “Heat Transfer Compositions 1-25” is intended to include each composition within that group, including Heat Transfer Compositions 10A and 10B, Heat Transfer Compositions 15A and 15B, and so on.

### Heat Transfer Compositions

Applicants have found that the heat transfer compositions of the present invention, including each of Heat Transfer Compositions 1-25 as described herein, are capable of providing exceptionally advantageous properties and in particular stability in use, especially with the use of the heat transfer compositions as a replacement for R-410A and especially in prior 410A residential air conditioning systems, and prior R-410A low and medium temperature refrigeration systems, prior commercial air conditioning systems (including prior R-410A roof top systems, prior R-410A variable refrigerant flow (VRF) systems and prior R-410A chiller systems).

A particular advantage of the refrigerants included in the heat transfer compositions of the present invention is that provide refrigerants and heat transfer compositions which can be used as a replacement for R-410A in various systems, and which have excellent heat transfer properties, low environmental impact (including particularly low GWP and near zero ODP), excellent chemical and thermal stability, low or no toxicity, and/or lubricant compatibility, especially with POE and PVE lubricants. This desirable advantage can be achieved by refrigerants and heat transfer compositions of the present invention.

Preferably, the heat transfer compositions of the present invention, including each of Heat Transfer Compositions 1-25, include refrigerant in an amount of greater than 40% by weight, or greater than 70% by weight, or greater than 80% by weight, or greater than 90% of the heat transfer composition.

Preferably, the heat transfer compositions of the present invention, including each of Heat Transfer Compositions 1-25, consist essentially of the refrigerant, the lubricant and stabilizer.

The heat transfer compositions of the invention may include other components for the purpose of enhancing or providing certain functionality to the compositions, preferably without negating the enhanced stability provided in accordance with present invention. Such other components or additives may include, dyes, solubilizing agents, compatibilizers, auxiliary stabilizers, antioxidants, corrosion inhibitors, extreme pressure additives and anti-wear additives.

### Stabilizers:

### Alkylated Naphthalenes

Applicants have surprisingly and unexpectedly found that alkylated naphthalenes are highly effective as stabilizers for the heat transfer compositions of the present invention. As used herein, the term “alkylated naphthalene” refers to compounds having the following structure:

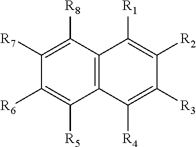

where each R₁-R₈ is independently selected from linear alkyl group, a branched alkyl group and hydrogen. The particular length of the alkyl chains and the mixtures or branched and straight chains and hydrogens can vary within the scope of the present invention, and it will be appreciated and understood by those skilled in the art that such variation is reflective of the physical properties of the alkylated naphthalene, including in particular the viscosity of the alkylated compound, and producers of such materials frequently define the materials by reference to one or more of such properties as an alternative the specification of the particular R groups.

Applicants have found unexpected, surprising and advantageous results are associated with the use of alkylated naphthalene as a stabilizer according to the present invention having the following properties, and alkylated naphthalene compounds having the indicated properties are referred to for convenience herein as Alkylated Naphthalene 1 (or AN1)-Alkylated Naphthalene 5 (or AN5) as indicated respectively in rows 1-5 in the Table below:

TABLE 1
ALKYLATED NAPHTHALENE

| Property | AN1 | AN2 | AN3 | AN4 | AN5 |
|---|---|---|---|---|---|
| Viscosity | 20-200 | 20-100 | 20-50 | 30-40 | about 36 |
| @ 40° C. (ASTM D467), cSt | | | | | |
| Viscosity | 3-20 | 3-10 | 3-8 | 5-7 | about 5.6 |
| @ 100° C. (ASTM D467), cSt | | | | | |
| Pour Point | −50 to −20 | −67 to −25 | −40 to −30 | −67 to −30 | about −33 |
| (ASTM D97), ° C. | | | | | |

As used herein in connection with viscosity at 40° C. measured according to ASTM D467, the term “about” means+/−4 cSt.

As used herein in connection with viscosity at 100° C. measured according to ASTM D467, the term “about” means+/−0.4 cSt.

As used herein in connection with pour point as measured according to ASTM D97, the term “about” means+/−5° C.

Applicants have also found that unexpected, surprising and advantageous results are associated the use of alkylated naphthalene as a stabilizer according to the present invention having the following properties, and alkylated naphthalene compounds having the indicated properties are referred to for convenience herein as Alkylated Naphthalene 6 (or AN6)-Alkylated Naphthalene 10 (or AN10) as indicated respectively in rows 6-10 in the Table below:

TABLE 2
ALKYLATED NAPHTHALENE

| Property | AN6 | AN7 | AN 8 | AN 9 | AN10 |
|---|---|---|---|---|---|
| Viscosity | 20-200 | 20-100 | 20-50 | 30-40 | about 36 |
| @ 40° C. (ASTM D467), cSt | | | | | |
| Viscosity | 3-20 | 3-10 | 3-8 | 5-7 | about 5.6 |
| @ 100° C. (ASTM D467), cSt | | | | | |
| Aniline Point | 40-110 | 50-90 | 50-80 | 60-70 | about 36 |
| (ASTM D611), ° C. | | | | | |
| NoackVolatility CEC | 1-50 | 5-30 | 5-15 | 10-15 | about 12 |
| L40 (ASTM D6375), wt. % | | | | | |
| Pour Point | −50 to −20 | −67 to −25 | −40 to −30 | −67 to −30 | about −33 |
| (ASTM D97), ° C. | | | | | |
| Flash Point | 200-300 | 200-270 | 220-250 | 230-240 | about 236 |
| (ASTM D92)), ° C. | | | | | |

Examples of alkylated naphthalenes within the meaning of Alkylated Naphthalene 1 and Alkylated Naphthalene 6 include those sold by King Industries under the trade designations NA-LUBE KR-007A; KR-008; KR-009; KR-015; KR-019; KR-005FG; KR-015FG; and KR-029FG.

Examples of alkylated naphthalenes within the meaning of Alkylated Naphthalene 2 and Alkylated Naphthalene 7 include those sold by King Industries under the trade designations NA-LUBE KR-007A; KR-008; KR-009; and KR-005FG.

An example of an alkylated naphthalene that is within the meaning of Alkylated Naphthalene 5 and Alkylated Naphthalene 10 includes the product sold by King Industries under the trade designation NA-LUBE KR-008.

The present invention includes heat transfer compositions, including each of Heat Transfer Compositions 1-25 hereof, wherein the alkylated naphthalene is AN1.

The present invention includes heat transfer compositions, including each of Heat Transfer Compositions 1-25 hereof, wherein the alkylated naphthalene is AN2.

The present invention includes heat transfer compositions, including each of Heat Transfer Compositions 1-25 hereof, wherein the alkylated naphthalene is AN3

The present invention includes heat transfer compositions, including each of Heat Transfer Compositions 1-25 hereof, wherein the alkylated naphthalene is AN4.

The present invention includes heat transfer compositions, including each of Heat Transfer Compositions 1-25 hereof, wherein the alkylated naphthalene is AN5.

The present invention includes heat transfer compositions, including each of Heat Transfer Compositions 1-25 hereof, wherein the alkylated naphthalene is AN6.

The present invention includes heat transfer compositions, including each of Heat Transfer Compositions 1-25 hereof, wherein the alkylated naphthalene is AN7.

The present invention includes heat transfer compositions, including each of Heat Transfer Compositions 1-25 hereof, wherein the alkylated naphthalene is AN8.

The present invention includes heat transfer compositions, including each of Heat Transfer Compositions 1-25 hereof, wherein the alkylated naphthalene is AN9.

The present invention includes heat transfer compositions, including each of Heat Transfer Compositions 1-25 hereof, wherein the alkylated naphthalene is AN10.

### Epoxylated Naphthalenes

Applicants have surprisingly and unexpectedly found that epoxylated naphthalenes are highly effective as stabilizers for the heat transfer compositions of the present invention. As used herein, the term “epoxylated naphthalene” refers to compounds having the following structure:

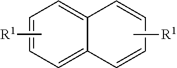

where each R¹ is independently an epoxy terminated ethoxy, propoxy or butoxy group, provided that at least one R¹ is an epoxy terminated ethoxy group. Stabilizer compounds according to this paragraph are referred to herein for convenience as EN1.

In preferred embodiments, R¹ is independently an epoxy terminated ethoxy or propoxy group, provided that at least one R¹ is an epoxy terminated ethoxy group. Stabilizer compounds according to this paragraph are referred to herein for convenience as EN2.

In preferred embodiments, R1 is independently an epoxy terminated ethoxy group. Stabilizer compounds according to this paragraph are referred to herein for convenience as EN3.

In preferred embodiments the epoxylated naphthalene is a compound according to the Formula in which each R1 is an epoxy terminated ethoxy group, as depicted below:

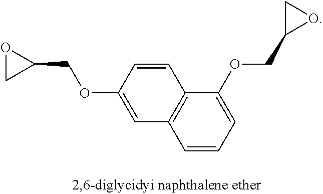 [SMILES: c1cc(OC[C@H]2CO2)c2ccc(OC[C@H]3CO3)cc2c1]

Stabilizer compounds according to this paragraph are referred to herein for convenience as EN4.

The present invention includes heat transfer compositions, including each of Heat Transfer Compositions 1-25, wherein the composition comprises EN1. Heat transfer composition according to this paragraph are sometimes referred to herein for convenience as Heat Transfer Composition 25B.

present invention includes heat transfer compositions, including each of Heat Transfer Compositions 1-25, wherein the composition comprises EN2. Heat transfer composition according to this paragraph are sometimes referred to herein for convenience as Heat Transfer Composition 25C.

The present invention includes heat transfer compositions, including each of Heat Transfer Compositions 1-25, wherein the composition comprises EN3. Heat transfer composition according to this paragraph are sometimes referred to herein for convenience as Heat Transfer Composition 25D.

The present invention includes heat transfer compositions, including each of Heat Transfer Compositions 1-25, wherein the composition comprises EN4. Heat transfer composition according to this paragraph are sometimes referred to herein for convenience as Heat Transfer Composition 25E.

### Acid Depleting Moieties (ADM)

Those skilled in the art will be able to determine, without undo experimentation, a variety of ADMs that are useful in accordance with the present invention, and all such ADMs are within the scope hereof.

Epoxides

Applicants have found that epoxides, and particularly alkylated epoxides, are effective at producing the enhanced stability discussed herein when used in combination with alkylated naphthalene stabilizers and/or epoxylated naphthalene stabilizers, and while applicants are not necessarily bound by theory it is believed that this synergistic enhancement stems at least in part due to its effective functioning as an ADM in the heat transfer compositions of the present invention.

In preferred embodiments the epoxide is selected from the group consisting of epoxides that undergo ring-opening reactions with acids, thereby depleting the system of acid while not otherwise deleteriously affecting the system.

Useful epoxides include aromatic epoxides, alkyl epoxides (including alkyl ether epoxides), and alkenyl epoxides.

Preferred epoxides include epoxides of the following Formula I:

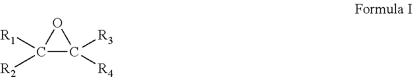

where at least one of said R₁-R₄ is selected from a two to fifteen carbon (C2-C15) acyclic group, a C2-C15 aliphatic group and a C2-C15 ether group. The group of epoxides according to Formula I with R groups as defined in this paragraph is sometimes referred to herein for convenience as ADM1A.

Preferred epoxides also include epoxides of the following Formula I:

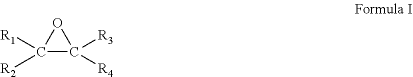

where each of said R₁-R₄ is independently selected from H, a C2-C15 acyclic group, a C2-C15 aliphatic group and C2-C15 ether group, provided that at least one of said R₁-R₄ is H and at least one of said R₁-R₄ is selected from a C2-C15 acyclic group, a C2-C15 aliphatic group and a C2-C15 ether group. The group of epoxides according to Formula I with R groups as defined in this paragraph is sometimes referred to herein for convenience as ADM1B.

Preferred epoxides also include epoxides of the following Formula I:

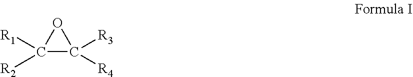

where each of said R₁-R₄ is independently selected from H, a C2-C15 acyclic group, a C2-C15 aliphatic group and a C2-C15 ether group, provided that at least two of said R₁-R₄ are H and at least one of said R₁-R₄ is selected from a C2-C15 acyclic group, a C2-C15 aliphatic group and a C2-C15 ether group. The group of epoxides according to Formula I with R groups as defined in this paragraph is sometimes referred to herein for convenience as ADM1C.

Preferred epoxides also include epoxides of the following Formula I:

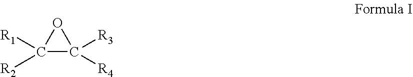

where each of said R₁-R₄ is independently selected from H, a C2-C15 acyclic group, a C2-C15 aliphatic group and a C2-C15 ether group, provided that three of said R₁-R₄ are H and one of said R₁-R₄ is selected from a C2-C15 acyclic group, a C2-C15 aliphatic group and a C2-C15 ether group. The group of epoxides according to Formula I with R groups as defined in this paragraph is sometimes referred to herein for convenience as ADM1 D.

In a preferred embodiment, at least one of R1-R4 of Formula I is an ether having the following structure:

R₅—O—R₆ Formula II

where each of R5 and R6 is independently a C1-C14 straight chain or branched chain, preferably unsubstituted, alkyl group. The group of epoxides according as defined in this paragraph is sometimes referred to herein for convenience as ADM2A.

In a preferred embodiment, at least one of R1-R4 of Formula I is an ether having the following structure:

R₅—O—R₆ Formula II

where
R5 is a C1-C3 alkyl group, preferably unsubstituted; and
R6 is a C3-C10 straight chain or branched chain, preferably unsubstituted, alkyl group. The group of epoxides as defined in this paragraph is sometimes referred to herein for convenience as ADM2B.

In a preferred embodiment, one of R₁-R₄ of Formula I is an ether having the following structure:

R₅—O—R₆ Formula II

where each of R₅ and R₆ is independently a C1-C14 straight chain or branched chain, preferably unsubstituted, alkyl group, and the remaining three of R₁-R₄ are H. The group of epoxides as defined in this paragraph is sometimes referred to herein for convenience as ADM3A.

In a preferred embodiment, one of R₁-R₄ of Formula I is an ether having the following structure:

R₅—O—R₆ Formula II

where
R₅ is connected to said epoxide group and is a C1-C3 straight chain or branched, unsubstituted alkyl group; and
R₆ is a C3-C10 straight chain or branched chain unsubstituted, alkyl group, and the remaining three of R₁-R₄ are H. The group of epoxides as defined in this paragraph is sometimes referred to herein for convenience as ADM3B.

In a preferred embodiment, one of R₁-R₄ of Formula I is an ether having the following structure:

R₅—O—R₆ Formula II

where
R₅ is connected to said epoxide group and is a C1 unsubstituted alkyl; and
R₆ is a C8 branched chain, unsubstituted alkyl group, and the remaining three of R₁-R₄ are H. The group of epoxides as defined in this paragraph is sometimes referred to herein for convenience as ADM3C.

In preferred embodiments the epoxide comprises, consists essentially of or consists of 2-ethylhexyl glycidyl ether, which is an ADM3C compound having the following structure:

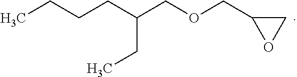

An epoxide according to this paragraph is sometimes referred to herein for convenience as ADM4.

In a preferred embodiment, one of R₁-R₄ of Formula I is an ether having the following structure:

R₅—O—R₆ Formula II

where each of R₅ and R₆ is independently a C1-C14 straight chain or branched chain, substituted or unsubstituted, alkyl group, and the remaining three of R₁-R₄ are H. The group of epoxides as defined in this paragraph is sometimes referred to herein for convenience as ADM5A.

In a preferred embodiment, one of R₁-R₄ of Formula I is an ether having the following structure:

R₅—O—R₆ Formula II

where
R₅ is connected to said epoxide group and is a C1-C3 straight chain or branched chain, unsubstituted alkyl group; and
R₆ is a C3-C10 straight chain or branched chain, substituted alkyl group, and the remaining three of R₁-R₄ are H. The group of epoxides as defined in this paragraph is sometimes referred to herein for convenience as ADM5B.

In a preferred embodiment, one of R₁-R₄ of Formula I is an ether having the following structure:

R₅—O—R₆ Formula II

where
R₅ is connected to said epoxide group and is a C1 unsubstituted alkyl; and
R₆ is a C8 branched chain, substituted alkyl group, and the remaining three of R₁-R4 are H. The group of epoxides according to Formula I with R groups as defined in this paragraph is sometimes referred to herein for convenience as ADM5C.

In a preferred embodiment, one of R₁-R₄ of Formula I is an ether having the following structure:

R₅—O—R₆ Formula II

where
R₅ is connected to said epoxide group and is a C1 unsubstituted alkyl; and
R₆ is a C8 branched chain, oxygen-substituted alkyl group, and the remaining three of R₁-R₄ are H. The group of epoxides according to Formula I with R groups as defined in this paragraph is sometimes referred to herein for convenience as ADMSD.

In preferred embodiments the epoxide comprises, consists essentially of or consists of glycidyl neodecanoate, which is an ADM5C compound in which the substituent on R6 is O and which has the following structure:

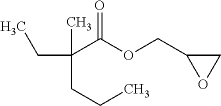

An epoxide according to this paragraph is sometimes referred to herein for convenience as ADM6.

The present invention includes heat transfer compositions, including each of Heat Transfer Compositions 1-25 (except Heat Transfer Compositions 12), wherein the composition comprises AN1 and ADM1.

The present invention includes heat transfer compositions, including each of Heat Transfer Compositions 1-25 (except Heat Transfer Compositions 12) wherein the composition comprises AN4 and ADM1.

The present invention includes heat transfer compositions, including each of Heat Transfer Compositions 1-25 (except Heat Transfer Compositions 12), wherein the composition comprises AN5 and ADM1.

The present invention includes heat transfer compositions, including each of Heat Transfer Compositions 1-25 (except Heat Transfer Compositions 12), wherein the composition comprises AN10 and ADM1.

The present invention includes heat transfer compositions, including each of Heat Transfer Compositions 1-25 (except Heat Transfer Compositions 12), wherein the composition comprises AN1 and ADM4.

The present invention includes heat transfer compositions, including each of Heat Transfer Compositions 1-25 (except Heat Transfer Compositions 12), wherein the composition comprises AN4 and ADM4.

The present invention includes heat transfer compositions, including each of Heat Transfer Compositions 1-25 (except Heat Transfer Compositions 12), wherein the composition comprises AN5 and ADM4.

The present invention includes heat transfer compositions, including each of Heat Transfer Compositions 1-25 (except Heat Transfer Compositions 12), wherein the composition comprises AN10 and ADM4.

The present invention includes heat transfer compositions, including each of Heat Transfer Compositions 1-25 (except Heat Transfer Compositions 12), wherein the composition comprises AN1 and ADM6.

The present invention includes heat transfer compositions, including each of Heat Transfer Compositions 1-25 (except Heat Transfer Compositions 12), wherein the composition comprises AN4 and ADM6.

The present invention includes heat transfer compositions, including each of Heat Transfer Compositions 1-25 (except Heat Transfer Compositions 12), wherein the composition comprises AN5 and ADM6.

The present invention includes heat transfer compositions, including each of Heat Transfer Compositions 1-25 (except Heat Transfer Compositions 12), wherein the composition comprises AN10 and ADM6.

The present invention includes heat transfer compositions, including each of Heat Transfer Compositions 1-25 (except Heat Transfer Compositions 12), wherein the composition comprises AN10 and ADM4.

The present invention includes heat transfer compositions, including each of Heat Transfer Compositions 1-25 (except Heat Transfer Compositions 12), wherein the composition comprises AN10 and ADM6.

The present invention includes heat transfer compositions, including each of Heat Transfer Compositions 1-25 (except Heat Transfer Compositions 12), wherein the alkylated naphthalene is AN10 and further comprising ADM6.

In the heat transfer compositions of the present invention, the ADM is preferably present in an amount of about 0.05% to about 2.5%, preferably 0.05% to about 1.5%, or preferably 0.05-0.5% by weight, all based on the weight of the lubricant plus the ADM.

Preferred heat transfer compositions of the present invention comprising a refrigerant of the present invention, alkylated naphthalene and an epoxide-based acid depleting moiety are described in the following Table 1 below.

TABLE 1

| | wt. % of | | |
|---|---|---|---|
| Heat Transfer | R1132(E) in | Alkylated | Acid Depleting |
| Composition | refrigerant | Naphthalene | Moiety |
| (HTC) No. | of HTC | (by AN No.) | (by ADM No.) |
| 26A | 10-75% | AN4 | ADM1A |
| 27A | 10-75% | AN4 | ADM1B |
| 28A | 10-75% | AN4 | ADM1C |
| 29A | 10-75% | AN4 | ADM1D |
| 30A | 10-75% | AN4 | ADM2A |
| 31A | 10-75% | AN4 | ADM2B |
| 32A | 10-75% | AN4 | ADM3A |
| 33A | 10-75% | AN4 | ADM3B |
| 34A | 10-75% | AN4 | ADM3C |
| 35A | 10-75% | AN4 | ADM4 |
| 36A | 10-75% | AN4 | ADM5A |
| 37A | 10-75% | AN4 | ADM5B |
| 38A | 10-75% | AN4 | ADM5C |
| 39A | 10-75% | AN4 | ADM5D |
| 40A | 10-75% | AN4 | ADM6 |
| 41A | 10-75% | AN4 | ADM1A |
| 42A | 10-75% | AN4 | ADM1B |
| 43A | 10-75% | AN4 | ADM1C |
| 44A | 10-75% | AN4 | ADM1D |
| 45A | 10-75% | AN4 | ADM2A |
| 46A | 10-75% | AN4 | ADM2B |
| 47A | 10-75% | AN4 | ADM3A |
| 48A | 10-75% | AN4 | ADM3B |
| 49A | 10-75% | AN4 | ADM3C |
| 50A | 10-75% | AN4 | ADM4 |
| 51A | 10-75% | AN4 | ADM5A |
| 52A | 10-75% | AN4 | ADM5B |
| 53A | 10-75% | AN4 | ADM5C |
| 54A | 10-75% | AN4 | ADM5D |
| 55A | 10-75% | AN4 | ADM6 |
| 56A | 10-75% | AN5 | ADM3A |
| 57A | 10-75% | AN5 | ADM3B |
| 58A | 10-75% | AN5 | ADM3C |
| 59A | 10-75% | AN5 | ADM4 |
| 60A | 10-75% | AN5 | ADM5A |
| 61A | 10-75% | AN5 | ADM5B |
| 62A | 10-75% | AN5 | ADM5C |
| 63A | 10-75% | AN5 | ADM5D |
| 64A | 10-75% | AN5 | ADM6 |
| 65A | 10-75% | AN10 | ADM3A |
| 66A | 10-75% | AN10 | ADM3B |
| 67A | 10-75% | AN10 | ADM3C |
| 68A | 10-75% | AN10 | ADM4 |
| 69A | 10-75% | AN10 | ADM5A |
| 70A | 10-75% | AN10 | ADM5B |
| 71A | 10-75% | AN10 | ADM5C |
| 72A | 10-75% | AN10 | ADM5D |
| 73A | 10-75% | AN10 | ADM6 |

For the purposes of convenience, each of the heat transfer compositions identified by number designation in the first column of Table 1 above and Tables 2-5 below represent a definition of a heat transfer composition, and reference to a heat transfer composition by that number is a reference to a composition having the constituents (and amounts where specified) described in the table. Also, as mentioned above, reference herein to a defined group, such as “Heat Transfer Compositions 1-73,” or to a composition defined by a number, refers to each composition within that group or composition, including wherein a definition number includes a suffix. For example, reference to “Heat Transfer Composition 26” is intended to include each composition that includes the root 26, for example, HTC26 includes HTC26A in Table 1, HTC26B in Table 2, etc.

In the heat transfer compositions of the present invention, including each of Heat Transfer Compositions 1-73, the alkylated naphthalene is preferably present in an amount of from 0.01% to about 10%, or from about 1.5% to about 4.5%, or from about 2.5% to about 3.5%, where amounts are in percent by weight based on the amount of alkylated naphthalene plus refrigerant in the system. The amounts specified in this paragraph are especially preferred when an ADM is also present.

In the heat transfer compositions of the present invention, including each of Heat Transfer Compositions 1-73, the alkylated naphthalene is preferably present in an amount of from 0.1% to about 20%, or from 1.5% to about 10%, or from 1.5% to about 8%, where amounts are in percent by weight based on the amount of alkylated naphthalene plus lubricant in the system. The amounts specified in this paragraph are especially preferred when an ADM is also present.

Carbodiimides

The ADM can include carbodiimides. In preferred embodiments the carbodiimides include compounds having the following structure:

R¹—N═C═N—R²

### Other Stabilizers

It is contemplated that stabilizers other than the alkylated naphthalenes and ADM may be included in the heat transfer compositions of the present invention, including each of Heat Transfer Compositions 1-73. Examples of such other stabilizers are described hereinafter.

Phenol-Based Compounds

In preferred embodiments, the stabilizer further includes a phenol-based compound.

The phenol-based compound can be one or more compounds selected from 4,4′-methylenebis(2,6-di-tert-butylphenol); 4,4′-bis(2,6-di-tert-butylphenol); 2,2- or 4,4-biphenyldiols, including 4,4′-bis(2-methyl-6-tert-butylphenol); derivatives of 2,2- or 4,4-biphenyldiols; 2,2′-methylenebis(4-ethyl-6-tertbutylphenol); 2,2′-methylenebis(4-methyl-6-tert-butylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol); 2,2′-methylenebis(4-methyl-6-cyclohexylphenol); 2,6-di-tert-butyl-4-methylphenol (BHT); 2,6-di-tert-butyl-4-ethylphenol: 2,4-dimethyl-6-tert-butylphenol; 2,6-di-tert-alpha-dimethylamino-p-cresol; 2,6-di-tert-butyl-4(N,N′-dimethylaminomethylphenol); 4,4′-thiobis(2-methyl-6-tert-butylphenol); 4,4′-thiobis(3-methyl-6-tert-butylphenol); 2,2′-thiobis(4-methyl-6-tert-butylphenol); bis(3-methyl-4-hydroxy-5-tert-butylbenzyl) sulfide; bis (3,5-di-tert-butyl-4-hydroxybenzyl)sulfide, tocopherol, hydroquinone, 2,2′6,6′-tetra-tert-butyl-4,4′-methylenediphenol and t-butyl hydroquinone, and preferably BHT.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight based on the weight of the lubricant in the heat transfer composition.

The present invention also includes stabilizer comprising from about 40% to about 95% by weight of alkylated naphthalenes, including each of AN1-AN10, and from 0.1 to about 10% by weight of BHT, based on the weight of the all the stabilizer components in the composition. The stabilizer according to this paragraph is sometimes referred to herein for convenience as Stabilizer 6.

The present invention also includes stabilizer comprising from about 40% to about 95% by weight of alkylated naphthalenes, including each of AN1-AN10, from 5% to about 30% by weight of ADM, including each of ADM1-ADM6, and from 0.1 to about 10% by weight of BHT, based on the weight of the all the stabilizer components in the composition. The stabilizer according to this paragraph is sometimes referred to herein for convenience as Stabilizer 7.

The present invention includes heat transfer compositions, including each of Heat Transfer Compositions 1-73 hereof, wherein the heat transfer composition comprises Stabilizer 6.

The present invention includes heat transfer compositions, including each of Heat Transfer Compositions 1-73 (except 12) hereof, wherein the heat transfer compositions comprise Stabilizer 7.

The present invention includes heat transfer compositions, including each of Heat Transfer Compositions 1-73 hereof, comprising AN1 and BHT. The present invention includes heat transfer compositions, including each of Heat Transfer Compositions 1-73 hereof, comprising AN5 and BHT.

The present invention includes heat transfer compositions, including each of Heat Transfer Compositions 1-73, comprising AN10 and BHT.

The present invention includes heat transfer compositions, including each of Heat Transfer Compositions 1-73 (except 12) hereof, comprising AN5, ADM4 and BHT.

The present invention includes heat transfer compositions, including each of Heat Transfer Compositions 1-73 (except 12) hereof, comprising AN5, ADM6 and BHT.

The present invention includes heat transfer compositions, including each of Heat Transfer Compositions 1-73 (except 12) hereof, comprising AN10, ADM4 and BHT.

The present invention includes heat transfer compositions, including each of Heat Transfer Compositions 1-73 (except 12) hereof, comprising AN10, ADM6 and BHT.

Diene-Based Compounds

The diene-based compounds include C3 to C15 dienes and to compounds formed by reaction of any two or more C3 to C4 dienes. Preferably, the diene-based compounds are selected from the group consisting of allyl ethers, propadiene, butadiene, isoprene, and terpenes. The diene-based compounds are preferably terpenes, which include but are not limited to terebene, retinal, geraniol, terpinene, delta-3 carene, terpinolene, phellandrene, fenchene, myrcene, farnesene, pinene, nerol, citral, camphor, menthol, limonene, nerolidol, phytol, carnosic acid, and vitamin A1. Preferably, the stabilizer is farnesene. Preferred terpene stabilizers are disclosed in U.S. Provisional Patent Application No. 60/638,003 filed on Dec. 12, 2004, published as US 2006/0167044A1, which is incorporated herein by reference. Among the terpenes, alpha-terpinene, gama terpinene, limonene and combinations of these are preferred in many embodiments.

In addition, the diene-based compounds can be provided in the heat transfer composition in an amount greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

Phosphorus-Based Compounds

The phosphorus compound can be a phosphite or a phosphate compound. For the purposes of this invention, the phosphite compound can be a diaryl, dialkyl, triaryl and/or trialkyl phosphite, and/or a mixed aryl/alkyl di- or tri-substituted phosphite, in particular one or more compounds selected from hindered phosphites, tris-(di-tert-butylphenyl)phosphite, di-n-octyl phosphite, iso-octyl diphenyl phosphite, iso-decyl diphenyl phosphite, tri-iso-decyl phosphate, triphenyl phosphite and diphenyl phosphite, particularly diphenyl phosphite. The phosphate compounds can be a triaryl phosphate, trialkyl phosphate, alkyl mono acid phosphate, aryl diacid phosphate, amine phosphate, preferably triaryl phosphate and/or a trialkyl phosphate, particularly tri-n-butyl phosphate.

The present invention includes heat transfer compositions, including each of Heat Transfer Compositions 1-73, wherein the composition comprises a phosphate.

The present invention includes heat transfer compositions, including each of Heat Transfer Compositions 1-73, wherein the composition comprises a triaryl phosphate.

The present invention includes heat transfer compositions, including each of Heat Transfer Compositions 1-73, wherein the composition comprises a trialkyl phosphate.

Preferred heat transfer compositions of the present invention comprising a refrigerant of the present invention, alkylated naphthalene, an epoxide-based acid depleting moiety and a phosphate are described in the following Table 2.

TABLE 2

| Heat Transfer | R1132(E), wt % | | Alkylated | Acid Depleting |
|---|---|---|---|---|
| Composition | based on refrigerant | | Naphthalene | Moiety |
| (HTC) No. | components in HTC | Phosphate | (by AN No.) | (by ADM No.) |
| 26B | 10-75% | Trialkyl phosphate | AN4 | ADM1A |
| 26C | 10-75% | Triaryl phosphate | AN4 | ADM1A |
| 27B | 10-75% | Trialkyl phosphate | AN4 | ADM1B |
| 27C | 10-75% | Triaryl phosphate | AN4 | ADM1B |
| 28B | 10-75% | Trialkyl phosphate | AN4 | ADM1C |
| 28C | 10-75% | Triaryl phosphate | AN4 | ADM1C |
| 29B | 10-75% | Trialkyl phosphate | AN4 | ADM1D |
| 29C | 10-75% | Triaryl phosphate | AN4 | ADM1D |
| 30B | 10-75% | Trialkyl phosphate | AN4 | ADM2A |
| 30C | 10-75% | Triaryl phosphate | AN4 | ADM2A |
| 31B | 10-75% | Trialkyl phosphate | AN4 | ADM2B |
| 31C | 10-75% | Triaryl phosphate | AN4 | ADM2B |
| 32B | 10-75% | Trialkyl phosphate | AN4 | ADM3A |
| 32C | 10-75% | Triaryl phosphate | AN4 | ADM3A |
| 33B | 10-75% | Trialkyl phosphate | AN4 | ADM3B |
| 33C | 10-75% | Trialkyl phosphate | AN4 | ADM3B |
| 34B | 10-75% | Trialkyl phosphate | AN4 | ADM3C |
| 34C | 10-75% | Triaryl phosphate | AN4 | ADM3C |
| 35B | 10-75% | Trialkyl phosphate | AN4 | ADM4 |
| 35C | 10-75% | Triaryl phosphate | AN4 | ADM4 |
| 36B | 10-75% | Trialkyl phosphate | AN4 | ADM5A |
| 36C | 10-75% | Triaryl phosphate | AN4 | ADM5A |
| 37B | 10-75% | Trialkyl phosphate | AN4 | ADM5B |
| 37C | 10-75% | Triaryl phosphate | AN4 | ADM5B |
| 38B | 10-75% | Trialkyl phosphate | AN4 | ADM5C |
| 38C | 10-75% | Triaryl phosphate | AN4 | ADM5C |
| 39B | 10-75% | Trialkyl phosphate | AN4 | ADM5D |
| 39C | 10-75% | Trialkyl phosphate | AN4 | ADM5D |
| 40B | 10-75% | Trialkyl phosphate | AN4 | ADM6 |
| 40C | 10-75% | Trialkyl phosphate | AN4 | ADM6 |
| 41B | 10-75% | Trialkyl phosphate | AN4 | ADM1A |
| 41C | 10-75% | Triaryl phosphate | AN4 | ADM1A |
| 42B | 10-75% | Trialkyl phosphate | AN4 | ADM1B |
| 42C | 10-75% | Triaryl phosphate | AN4 | ADM1B |
| 43B | 10-75% | Trialkyl phosphate | AN4 | ADM1C |
| 43C | 10-75% | Triaryl phosphate | AN4 | ADM1C |
| 44B | 10-75% | Trialkyl phosphate | AN4 | ADM1D |
| 44C | 10-75% | Triaryl phosphate | AN4 | ADM1D |
| 45B | 10-75% | Trialkyl phosphate | AN4 | ADM2A |
| 45C | 10-75% | Triaryl phosphate | AN4 | ADM2A |
| 46B | 10-75% | Trialkyl phosphate | AN4 | ADM2B |
| 46C | 10-75% | Triaryl phosphate | AN4 | ADM2B |
| 47B | 10-75% | Trialkyl phosphate | AN4 | ADM3A |
| 47C | 10-75% | Triaryl phosphate | AN4 | ADM3A |
| 48B | 10-75% | Trialkyl phosphate | AN4 | ADM3B |
| 48C | 10-75% | Triaryl phosphate | AN4 | ADM3B |
| 49B | 10-75% | Trialkyl phosphate | AN4 | ADM3C |
| 49C | 10-75% | Triaryl phosphate | AN4 | ADM3C |
| 50B | 10-75% | Trialkyl phosphate | AN4 | ADM4 |
| 50C | 10-75% | Triaryl phosphate | AN4 | ADM4 |
| 51B | 10-75% | Trialkyl phosphate | AN4 | ADM5A |
| 512C | 10-75% | Triaryl phosphate | AN4 | ADM5A |
| 52B | 10-75% | Trialkyl phosphate | AN4 | ADM5B |
| 52C | 10-75% | Triaryl phosphate | AN4 | ADM5B |
| 53B | 10-75% | Trialkyl phosphate | AN4 | ADM5C |
| 53C | 10-75% | Triaryl phosphate | AN4 | ADM5C |
| 544B | 10-75% | Trialkyl phosphate | AN4 | ADM5D |
| 54C | 10-75% | Triaryl phosphate | AN4 | ADM5D |
| 55B | 10-75% | Triaryl phosphate | AN4 | ADM6 |
| 55C | 10-75% | Trialkyl phosphate | AN4 | ADM6 |
| 56B | 10-75% | Trialkyl phosphate | AN5 | ADM3A |
| 56C | 10-75% | Triaryl phosphate | AN5 | ADM3A |
| 57B | 10-75% | Trialkyl phosphate | AN5 | ADM3B |
| 57C | 10-75% | Triaryl phosphate | AN5 | ADM3B |
| 58B | 10-75% | Trialkyl phosphate | AN5 | ADM3C |
| 58C | 10-75% | Triaryl phosphate | AN5 | ADM3C |
| 59B | 10-75% | Trialkyl phosphate | AN5 | ADM4 |
| 59C | 10-75% | Triaryl phosphate | AN5 | ADM4 |
| 60B | 10-75% | Trialkyl phosphate | AN5 | ADM5A |
| 60C | 10-75% | Triaryl phosphate | AN5 | ADM5A |
| 61B | 10-75% | Trialkyl phosphate | AN5 | ADM5B |
| 61C | 10-75% | Triaryl phosphate | AN5 | ADM5B |
| 62B | 10-75% | Trialkyl phosphate | AN5 | ADM5C |
| 62C | 10-75% | Triaryl phosphate | AN5 | ADM5C |
| 63B | 10-75% | Trialkyl phosphate | AN5 | ADM5D |
| 63C | 10-75% | Triaryl phosphate | AN5 | ADM5D |
| 64B | 10-75% | Trialkyl phosphate | AN5 | ADM6 |
| 64C | 10-75% | Triaryl phosphate | AN5 | ADM6 |
| 65B | 10-75% | Trialkyl phosphate | AN10 | ADM3A |
| 65C | 10-75% | Triaryl phosphate | AN10 | ADM3A |
| 66B | 10-75% | Trialkyl phosphate | AN10 | ADM3B |
| 66C | 10-75% | Triaryl phosphate | AN10 | ADM3B |
| 67B | 10-75% | Trialkyl phosphate | AN10 | ADM3C |
| 67C | 10-75% | Triaryl phosphate | AN10 | ADM3C |
| 68B | 10-75% | Trialkyl phosphate | AN10 | ADM4 |
| 68C | 10-75% | Triaryl phosphate | AN10 | ADM4 |
| 69B | 10-75% | Trialkyl phosphate | AN10 | ADM5A |
| 69C | 10-75% | Triaryl phosphate | AN10 | ADM5A |
| 70B | 10-75% | Trialkyl phosphate | AN10 | ADM5B |
| 70C | 10-75% | Triaryl phosphate | AN10 | ADM5B |
| 71B | 10-75% | Trialkyl phosphate | AN10 | ADM5C |
| 71C | 10-75% | Triaryl phosphate | AN10 | ADM5C |
| 72B | 10-75% | Trialkyl phosphate | AN10 | ADM5D |
| 72C | 10-75% | Triaryl phosphate | AN10 | ADM5D |
| 73B | 10-75% | Trialkyl phosphate | AN10 | ADM6 |
| 73C | 10-75% | Triaryl phosphate | AN10 | ADM6 |

The phosphorus compounds can be provided in the heat transfer composition of the present invention, including each of Heat Transfer Compositions 1-73, in an amount of greater than 0 and preferably from 0.0001% by weight to about 5% by weight, preferably 0.001% by weight to about 2.5% by weight, and more preferably from 0.01% to about 1% by weight. In each case, by weight refers to weight of the heat transfer composition, including specifically the phosphate stabilizers identified above in Table 2.

The phosphorus compounds can be provided in the heat transfer composition of the present invention, including each of Heat Transfer Compositions 1-73, in an amount of greater than 0 and preferably from 0.0002% by weight to about 10% by weight, preferably 0.002% by weight to about 5% by weight, and more preferably from 0.02% to about 2% by weight. In each case, by weight in this paragraph refers to weight of the lubricant and the phosphate stabilizer, including specifically the phosphate stabilizers identified above in Table 2.

Nitrogen Compounds

When the stabilizer is a nitrogen compound, the stabilizer of the present invention, including the stabilizer for use in each of Heat Transfer Compositions 1-73, may comprise an amine-based compound such as one or more secondary or tertiary amines selected from diphenylamine, p-phenylenediamine, triethylamine, tributylamine, diisopropylamine, triisopropylamine and triisobutylamine. The amine based compound including the amine-based stabilizer for use in each of Heat Transfer Compositions 1-73, can be an amine antioxidant such as a substituted piperidine compound, i.e. a derivative of an alkyl substituted piperidyl, piperidinyl, piperazinone, or alkyoxypiperidinyl, particularly one or more amine antioxidants selected from 2,2,6,6-tetramethyl-4-piperidone, 2,2,6,6-tetramethyl-4-piperidinol; bis-(1,2,2,6,6-pentamethylpiperidyl)sebacate; di(2,2,6,6-tetramethyl-4-piperidyl)sebacate, poly(N-hydroxyethyl-2,2,6,6-tetramethyl-4-hydroxy-piperidyl succinate; alkylated paraphenylenediamines such as N-phenyl-N′-(1,3-dimethyl-butyl)-p-phenylenediamine or N,N′-di-sec-butyl-p-phenylenediamine and hydroxylamines such as tallow amines, methyl bis tallow amine and bis tallow amine, or phenol-alpha-napththylamine or Tinuvin® 765 (Ciba), BLS®1944 (Mayzo Inc) and BLS® 1770 (Mayzo Inc). For the purposes of this invention, the amine-based compound also can be an alkyldiphenyl amine such as bis (nonylphenyl amine), dialkylamine such as (N-(1-methylethyl)-2-propylamine, or one or more of phenyl-alpha-naphthyl amine (PANA), alkyl-phenyl-alpha-naphthyl-amine (APANA), and bis (nonylphenyl) amine. Preferably the amine-based compound, including the amine-based stabilizer for use in each of Heat Transfer Compositions 1-73, is one or more of phenyl-alpha-naphthyl amine (PANA), alkyl-phenyl-alpha-naphthyl-amine (APANA) and bis (nonylphenyl) amine, and more preferably phenyl-alpha-naphthyl amine (PANA).

Alternatively, or in addition to the nitrogen compounds identified above, the nitrogen stabilizer for use in each of Heat Transfer Compositions 1-73, may include one or more compounds selected from dinitrobenzene, nitrobenzene, nitromethane, nitrosobenzene, and TEMPO [(2,2,6,6-tetramethylpiperidin-1-yl)oxyl] may be used as the stabilizer. The nitrogen compounds can be provided in the heat transfer composition, including each of Heat Transfer Compositions 1-73, in an amount of greater than 0 and from 0.0001% by weight to about 5% by weight, or 0.001% by weight to about 2.5% by weight, or from 0.01% to about 1% by weight. In each case, percentage by weight refers to the weight of the heat transfer composition.

Isobutylene

Isobutylene may also be used as a stabilizer according to the present invention.

### Additional Stabilizer Compositions

The present invention also provides a stabilizer consisting essentially of alkylated naphthalene, including each of AN1-AN10 and an ADM, including each of ADM1-ADM6 and a phenol. A stabilizer according to this paragraph is sometimes referred to herein for convenience as Stabilizer 8A.

The present invention also provides a stabilizer comprising alkylated naphthalene, including each of AN1-AN10 and a phosphorous containing compound. A stabilizer according to this paragraph is sometimes referred to herein for convenience as Stabilizer 8B.

The present invention also provides a stabilizer comprising alkylated naphthalene, including each of AN1-AN10 and a nitrogen containing compound. A stabilizer according to this paragraph is sometimes referred to herein for convenience as Stabilizer 8C.

The present invention also provides a stabilizer comprising alkylated naphthalene, including each of AN1-AN10, a phosphorous containing compound and a nitrogen containing compound. A stabilizer according to this paragraph is sometimes referred to herein for convenience as Stabilizer 8D.

The present invention also provides a stabilizer comprising alkylated naphthalene, including each of AN1-AN10, and terpinene. A stabilizer according to this paragraph is sometimes referred to herein for convenience as Stabilizer 8E.

The present invention also provides a stabilizer comprising alkylated naphthalene, including each of AN1-AN10, a phosphorous containing compound, a nitrogen containing compound and terpinene. A stabilizer according to this paragraph is sometimes referred to herein for convenience as Stabilizer 8F.

The present invention also provides a stabilizer comprising alkylated naphthalene, including each of AN1-AN10, and limonene. A stabilizer according to this paragraph is sometimes referred to herein for convenience as Stabilizer 8G.

The present invention also provides a stabilizer comprising alkylated naphthalene, including each of AN1-AN10, a phosphorous-containing compound, a nitrogen-containing compound and limonene. A stabilizer according to this paragraph is sometimes referred to herein for convenience as Stabilizer 8H.

The present invention also provides a stabilizer consisting of alkylated naphthalene, including each of AN1-AN10 and an ADM, including each of ADM1-ADM6 and a phosphate. A stabilizer according to this paragraph is sometimes referred to herein for convenience as Stabilizer 9A.

The present invention also provides a stabilizer consisting essentially of alkylated naphthalene, including each of AN1-AN10 and ADM4 and a phosphate. A stabilizer according to this paragraph is sometimes referred to herein for convenience as Stabilizer 9B.

The present invention also provides a stabilizer consisting essentially of alkylated naphthalene, AN4, ADM4 and a phosphate. A stabilizer according to this paragraph is sometimes referred to herein for convenience as Stabilizer 9C.

The present invention also provides a stabilizer consisting essentially of AN4, ADM6 and a phosphate. A stabilizer according to this paragraph is sometimes referred to herein for convenience as Stabilizer 9D.

The present invention also provides stabilizer comprising alkylated naphthalene, including each of AN1-AN10 and an ADM, including each of ADM1-ADM6 and a combination of a phosphate and a phenol. A stabilizer according to this paragraph is sometimes referred to herein for convenience as Stabilizer 10.

The present invention also provides a stabilizer comprising alkylated naphthalene, including each of AN1-AN10, in an amount of from about 40% by weight to about 95% by weight, an ADM, including each of ADM1-ADM6, in an amount of from about 0.5% by weight to about 25% by weight, and an additional stabilizer selected from a phosphate, a phenol and combinations of these in an amount of from about 0.1% by weight to about 50% by weight, wherein said weight percentages are based on the total weight of the stabilizer. A stabilizer according to this paragraph is sometimes referred to herein for convenience as Stabilizer 11.

The present invention also provides a stabilizer comprising alkylated naphthalene, including each of AN1-AN10, in an amount of from about 70% by weight to about 95% by weight, an ADM, including each of ADM1-ADM6, in an amount of from about 0.5% by weight to about 15% by weight, and an additional stabilizer selected from a phosphate, a phenol and combinations of these in an amount of from about 0.1% by weight to about 25% by weight, wherein said weight percentages are based on the total weight of the stabilizer. A stabilizer according to this paragraph is sometimes referred to herein for convenience as Stabilizer 12.

The present invention also provides a stabilizer consisting essentially of alkylated naphthalene, including each of AN1-AN10 and an ADM, including each of ADM1-ADM6 and BHT. A stabilizer according to this paragraph is sometimes referred to herein for convenience as Stabilizer 13.

The present invention also provides a stabilizer consisting of alkylated naphthalene, including each of AN1-AN10 and an ADM, including each of ADM1-ADM6 and BHT. A stabilizer according to this paragraph is sometimes referred to herein for convenience as Stabilizer 14.

The present invention also provides a stabilizer consisting essentially of alkylated naphthalene, including each of AN1-AN10 and an ADM, including each of ADM1-ADM6, BHT and a phosphate. A stabilizer according to this paragraph is sometimes referred to herein for convenience as Stabilizer 15.

The present invention also provides a stabilizer consisting of alkylated naphthalene, including each of AN1-AN10 and an ADM, including each of ADM1-ADM6, BHT and a phosphate. A stabilizer according to this paragraph is sometimes referred to herein for convenience as Stabilizer 16.

The present invention also provides a stabilizer comprising alkylated naphthalene, including each of AN1-AN10, in an amount of from about 40% by weight to about 95% by weight, an ADM, including each of ADM1-ADM6, in an amount of from about 0.5% by weight to about 10% by weight, and BHT, in an amount of from about 0.1% by weight to about 50% by weight, wherein said weight percentages are based on the total weight of the stabilizer. A stabilizer according to this paragraph is sometimes referred to herein for convenience as Stabilizer 17.

The present invention also provides a stabilizer comprising alkylated naphthalene, including each of AN1-AN10, in an amount of from about 70% by weight to about 95% by weight, an ADM, including each of ADM1-ADM6, in an amount of from about 0.5% by weight to about 10% by weight, and BHT, in an amount of from about 0.1% by weight to about 25% by weight, wherein said weight percentages are based on the total weight of the stabilizer. A stabilizer according to this paragraph is sometimes referred to herein for convenience as Stabilizer 18.

The present invention also provides a stabilizer comprising alkylated naphthalene, including each of AN1-AN10, in an amount of from about 40% by weight to about 95% by weight, an ADM, including each of ADM1-ADM6, in an amount of from about 5% by weight to about 25% by weight, and a third stabilizer compound selected from BHT, a phosphate and combinations of these in an amount of from 1% by weight to about 55% by weight, wherein said weight percentages are based on the total weight of the stabilizer. A stabilizer according to this paragraph is sometimes referred to herein for convenience as Stabilizer 19.

The present invention also provides a stabilizer comprising alkylated naphthalene, including each of AN1-AN10, in an amount of from about 40% by weight to about 95% by weight, an ADM, including each of ADM1-ADM6, in an amount of from about 5% by weight to about 25% by weight, and BHT, in an amount of from about 0.1% by weight to about 5% by weight, wherein said weight percentages are based on the total weight of the stabilizer. A stabilizer according to this paragraph is sometimes referred to herein for convenience as Stabilizer 20.

The stabilizers of the present invention, including each of Stabilizers 1-20, can be used in any of the heat transfer compositions of the present invention, including any of Heat Transfer compositions 1-70.

### Lubricants

In general, the heat transfer composition of the present invention, including each of Heat Transfer Compositions 1-70, comprises a POE lubricant and/or a PVE lubricant wherein the lubricant is present in amounts preferably of from about 0.1% by weight to about 5%, or from 0.1% by weight to about 1% by weight, or from 0.1% by weight to about 0.5% by weight, based on the weight of the heat transfer composition.

POE Lubricants

The POE lubricant of the present invention includes in preferred embodiments a neopentyl POE lubricant. As used herein, the term neopentyl POE lubricant refers to polyol esters (POEs) derived from a reaction between a neopentyl polyol (preferably pentaerythritol, trimethylolpropane, or neopentyl glycol, and in embodiments where higher viscosities are preferred, dipentaerythritol) and a linear or branched carboxylic acid.

Commercially available POEs include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred neopentyl POE lubricants having the properties identified below:

| Property | RL32-3MAF | RL68H |
|---|---|---|
| Viscosity | about 31 | about 67 |
| @ 40° C. (ASTM D467), cSt | | |
| Viscosity | about 5.6 | about 9.4 |
| @ 100° C. (ASTM D467), cSt | | |
| Pour Point | about −40 | about −40 |
| (ASTM D97), ° C. | | |

Other useful esters include phosphate esters, di-basic acid esters and fluoro esters.

A lubricant consisting essentially of a POE having a viscosity at 40° C. measured in accordance with ASTM D445 of from about 30 cSt to about 70 cSt and a viscosity Measured @ 100° C. in accordance with ASTM D445 of from about 5 cSt to about 10 cSt is referred to herein as Lubricant 1.

A lubricant consisting essentially of a neopentyl POE having a viscosity at 40° C. measured in accordance with ASTM D467 of from about 30 cSt to about 70 cSt is referred to for convenience as Lubricant 2.

In preferred embodiments, the present Heat Transfer Compositions, including each of Heat Transfer Compositions 1-73, comprise a POE lubricant.

In preferred embodiments, the present Heat Transfer Compositions, including each of Heat Transfer Compositions 1-73, comprise lubricant consisting essentially of a POE lubricant.

In preferred embodiments, the present Heat Transfer Compositions, including each of Heat Transfer Compositions 1-73, comprise lubricant consisting of a POE lubricant.

A preferred heat transfer composition comprises Heat Transfer Composition 1 wherein the lubricant is Lubricant 1 and/or Lubricant 2.

A preferred heat transfer composition comprises Heat Transfer Composition 2 wherein the lubricant is Lubricant 1 and/or Lubricant 2.

A preferred heat transfer composition comprises Heat Transfer Composition 3 wherein the lubricant is Lubricant 1 and/or Lubricant 2.

A preferred heat transfer composition comprises Heat Transfer Composition 4 wherein the lubricant is Lubricant 1 and/or Lubricant 2.

A preferred heat transfer composition comprises Heat Transfer Composition 5 wherein the lubricant is Lubricant 1 and/or Lubricant 2.

A preferred heat transfer composition comprises Heat Transfer Composition 6 wherein the lubricant is Lubricant 1 and/or Lubricant 2.

A preferred heat transfer composition comprises Heat Transfer Composition 7 wherein the lubricant is Lubricant 1 and/or Lubricant 2.

A preferred heat transfer composition comprises Heat Transfer Composition 8 wherein the lubricant is Lubricant 1 and/or Lubricant 2.

A preferred heat transfer composition comprises Heat Transfer Composition 9 wherein the lubricant is Lubricant 1 and/or Lubricant 2.

A preferred heat transfer composition comprises Heat Transfer Composition 10 wherein the lubricant is Lubricant 1 and/or Lubricant 2.

A preferred heat transfer composition comprises Heat Transfer Composition 11A wherein the lubricant is Lubricant 1 and/or Lubricant 2.

A preferred heat transfer composition comprises Heat Transfer Composition 11B wherein the lubricant is Lubricant 1 and/or Lubricant 2.

A preferred heat transfer composition comprises Heat Transfer Composition 12 wherein the lubricant is Lubricant 1 and/or Lubricant 2.

A preferred heat transfer composition comprises Heat Transfer Composition 13 wherein the lubricant is Lubricant 1 and/or Lubricant 2.

A preferred heat transfer composition comprises Heat Transfer Composition 14 wherein the lubricant is Lubricant 1 and/or Lubricant 2.

A preferred heat transfer composition comprises Heat Transfer Composition 15 wherein the lubricant is Lubricant 1 and/or Lubricant 2.

A preferred heat transfer composition comprises Heat Transfer Composition 16 wherein the lubricant is Lubricant 1 and/or Lubricant 2.

A preferred heat transfer composition comprises Heat Transfer Composition 17 wherein the lubricant is Lubricant 1 and/or Lubricant 2.

A preferred heat transfer composition comprises Heat Transfer Composition 18 wherein the lubricant is Lubricant 1 and/or Lubricant 2.

A preferred heat transfer composition comprises Heat Transfer Composition 19 wherein the lubricant is Lubricant 1 and/or Lubricant 2.

A preferred heat transfer composition comprises Heat Transfer Composition 20 wherein the lubricant is Lubricant 1 and/or Lubricant 2.

A preferred heat transfer composition comprises Heat Transfer Composition 21 wherein the lubricant is Lubricant 1 and/or Lubricant 2.

A preferred heat transfer composition comprises Heat Transfer Composition 22 wherein the lubricant is Lubricant 1 and/or Lubricant 2.

A preferred heat transfer composition comprises Heat Transfer Composition 23 wherein the lubricant is Lubricant 1 and/or Lubricant 2.

A preferred heat transfer composition comprises Heat Transfer Composition 24 wherein the lubricant is Lubricant 1 and/or Lubricant 2.

A preferred heat transfer composition comprises Heat Transfer Composition 25 wherein the lubricant is Lubricant 1 and/or Lubricant 2.

### PVE Lubricants

The lubricant of the present invention can include PVE lubricants generally. In preferred embodiments the PVE lubricant is as PVE according to Formula II below:

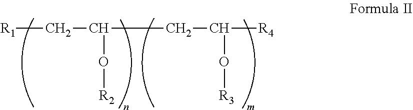

where R₂ and R₃ are each independently C1-C10 hydrocarbons, preferably C2-C8 hydrocarbons, and R₁ and R₄ are each independently alkyl, alkylene glycol, or polyoxyalkylene glycol units and n and m are selected preferably according to the needs of those skilled in the art to obtain a lubricant with the desired properties, and preferable n and m are selected to obtain a lubricant with a viscosity at 40° C. measured in accordance with ASTM D467 of from about 30 to about 70 cSt. A PVE lubricant according to the description immediately above is referred to for convenience as Lubricant 3. Commercially available polyvinyl ethers include those lubricants sold under the trade designations FVC32D and FVC68D, from Idemitsu.

In preferred embodiments, the present Heat Transfer Compositions, including each of Heat Transfer Compositions 1-73, comprise a PVE lubricant.

In preferred embodiments, the present Heat Transfer Compositions, including each of Heat Transfer Compositions 1-73, comprise lubricant consist essentially of a PVE lubricant.

In preferred embodiments, the present Heat Transfer Compositions, including each of Heat Transfer Compositions 1-73, comprise lubricant consisting of a PVE lubricant.

In preferred embodiments, the PVE in the present Heat Transfer Compositions, including each of Heat Transfer Compositions 1-73, is a PVE according to Formula II.

In preferred embodiments, the present Heat Transfer Compositions, including each of Heat Transfer Compositions 1-73, comprise lubricant consist essentially of Lubricant 3.

Stabilized Lubricants

The present invention also provides stabilized lubricants comprising: (a) POE lubricant; and (b) a stabilizer of the present invention, including each of Stabilizers 1-20. The stabilized lubricant according to this paragraph is sometimes referred to herein for convenience as Stabilized Lubricant 1.

The present invention also provides stabilized lubricants comprising: (a) neo pentyl POE lubricant; and (b) a stabilizer of the present invention, including each of Stabilizers 1-20. The stabilized lubricant according to this paragraph is sometimes referred to herein for convenience as Stabilized Lubricant 2.

The present invention also provides stabilized lubricants comprising: (a) Lubricant 1 or Lubricant 2; and (b) a stabilizer of the present invention, including each of Stabilizers 1-20. The stabilized lubricant according to this paragraph is sometimes referred to herein for convenience as Stabilized Lubricant 3.

The present invention also provides stabilized lubricants comprising: (a) Lubricant 3; and (b) a stabilizer of the present invention, including each of Stabilizers 1-20. The stabilized lubricant according to this paragraph is sometimes referred to herein for convenience as Stabilized Lubricant 4.

The present invention also includes stabilized lubricants comprising: (a) POE lubricant and/or polyvinyl ether (PVE) lubricant; and (b) Stabilizer 1. The stabilized lubricant according to this paragraph is sometimes referred to herein for convenience as Stabilized Lubricant 5.

The present invention also includes stabilized lubricants comprising: (a) POE lubricant and/or polyvinyl ether (PVE) lubricant; and (b) Stabilizer 2. The stabilized lubricant according to this paragraph is sometimes referred to herein for convenience as Stabilized Lubricant 6.

The present invention also includes stabilized lubricants comprising: (a) POE lubricant and/or polyvinyl ether (PVE) lubricant; and (b) Stabilizer 3. The stabilized lubricant according to this paragraph is sometimes referred to herein for convenience as Stabilized Lubricant 7.

The present invention also includes stabilized lubricants comprising: (a) POE lubricant and/or polyvinyl ether (PVE) lubricant; and (b) Stabilizer 4. The stabilized lubricant according to this paragraph is sometimes referred to herein for convenience as Stabilized Lubricant 8.

The present invention also includes stabilized lubricants comprising: (a) POE lubricant and/or polyvinyl ether (PVE) lubricant; and (b) Stabilizer 5. The stabilized lubricant according to this paragraph is sometimes referred to herein for convenience as Stabilized Lubricant 9.

The present invention also includes stabilized lubricants comprising: (a) POE lubricant and/or a PVE lubricant; and (b) from 1% to less than 10% by weight of alkylated naphthalene based on the weight of the lubricant and alkylated naphthalene. The stabilized lubricant according to this paragraph is sometimes referred to herein for convenience as Stabilized Lubricant 10.

The present invention also includes stabilized lubricants comprising: (a) POE lubricant and/or a PVE lubricant; and (b) from 1% to 8% by weight of alkylated naphthalene based on the weight of the lubricant and alkylated naphthalene. The stabilized lubricant according to this paragraph is sometimes referred to herein for convenience as Stabilized Lubricant 11.

The present invention also includes stabilized lubricants comprising: (a) POE lubricant and/or a PVE lubricant; and (b) from 1.5% to 8% by weight of alkylated naphthalene based on the weight of the lubricant and alkylated naphthalene. The stabilized lubricant according to this paragraph is sometimes referred to herein for convenience as Stabilized Lubricant 12.

The present invention also includes stabilized lubricants comprising: (a) POE lubricant and/or a PVE lubricant; and (b) from 1.5% to 6% by weight of alkylated naphthalene based on the weight of the lubricant and alkylated naphthalene. The stabilized lubricant according to this paragraph is sometimes referred to herein for convenience as Stabilized Lubricant 13.

The present invention includes heat transfer compositions of the invention, including each of Heat Transfer Compositions 1-73, in which the lubricant and stabilizer are a stabilized lubricant of the present invention, including each of Stabilized Lubricants 1-13.

Preferred heat transfer compositions of the present invention comprising a refrigerant of the present invention, lubricant, alkylated naphthalene and an epoxide-based acid depleting moiety are described in the following Table 3.

TABLE 3

| | | Lubricant (Indicated | | |
|---|---|---|---|---|
| | | generally as POE or | | |
| Heat | Wt. % of | PVE and if appropriate | | |
| Transfer | R1132(E) in | parenthetically by | Alkylated | Acid Depleting |
| Composition | refrigerant | Specific Lubricant | Naphthalene | Moiety |
| (HTC) No. | of HTC | No. defined above) | (by AN No.) | (by ADM No.) |
| 74 | 10-75% | POE | AN4 | ADM3 |
| 75 | 10-75% | POE | AN5 | ADM3 |
| 76 | 10-75% | POE | AN10 | ADM3 |
| 77 | 10-75% | POE | AN4 | ADM4 |
| 78 | 10-75% | POE | AN5 | ADM4 |
| 79 | 10-75% | POE | AN10 | ADM4 |
| 80 | 10-75% | POE | AN4 | ADM5 |
| 81 | 10-75% | POE | AN5 | ADM5 |
| 82 | 10-75% | POE | AN10 | ADM5 |
| 83 | 10-75% | POE | AN4 | ADM6 |
| 84 | 10-75% | POE | AN5 | ADM6 |
| 85 | 10-75% | POE | AN10 | ADM6 |
| 86 | 10-75% | POE (Lubricant 1) | AN4 | ADM4 |
| 87 | 10-75% | POE (Lubricant 1) | AN5 | ADM4 |
| 88 | 10-75% | POE (Lubricant 1) | AN10 | ADM4 |
| 89 | 10-75% | POE (Lubricant 1) | AN4 | ADM6 |
| 90 | 10-75% | POE (Lubricant 1) | AN5 | ADM6 |
| 91 | 10-75% | POE (Lubricant 1) | AN10 | ADM6 |
| 92 | 10-75% | POE (Lubricant 2) | AN4 | ADM4 |
| 93 | 10-75% | POE (Lubricant 2) | AN5 | ADM4 |
| 94 | 10-75% | POE (Lubricant 2) | AN10 | ADM4 |
| 95 | 10-75% | POE (Lubricant 2) | AN4 | ADM6 |
| 96 | 10-75% | POE (Lubricant 2) | AN5 | ADM6 |
| 97 | 10-75% | POE (Lubricant 2) | AN10 | ADM6 |
| 98 | 10-75% | PVE | AN4 | ADM4 |
| 99 | 10-75% | PVE | AN5 | ADM4 |
| 100 | 10-75% | PVE | AN10 | ADM4 |
| 101 | 10-75% | PVE | AN4 | ADM6 |
| 102 | 10-75% | PVE | AN5 | ADM6 |
| 103 | 10-75% | PVE | AN10 | ADM6 |
| 104 | 10-75% | PVE (Lubricant 3) | AN4 | ADM4 |
| 105 | 10-75% | PVE (Lubricant 3) | AN5 | ADM4 |
| 106 | 10-75% | PVE (Lubricant 3) | AN10 | ADM4 |
| 107 | 10-75% | PVE (Lubricant 3) | AN4 | ADM6 |
| 108 | 10-75% | PVE (Lubricant 3) | AN5 | ADM6 |
| 109 | 10-75% | PVE (Lubricant 3) | AN10 | ADM6 |

Preferred heat transfer compositions of the present invention comprising a refrigerant of the present invention, lubricant, alkylated naphthalene, an epoxide-based acid depleting moiety and a phosphate, are described in the following Table 4.

TABLE 4

| | | Lubricant (Indicated | | | |
|---|---|---|---|---|---|
| | | generally as POE or | | | |
| Heat | Wt. % of | PVE and if appropriate | | | |
| Transfer | R1132(E) in | parenthetically by | Alkylated | Acid Depleting | |
| Composition | refrigerant | Specific Lubricant No. | Naphthalene | Moiety | |
| (HTC) No. | of HTC | defined identified above) | (by AN No.) | (by ADM No.) | Phosphate |
| 74B | 10-75% | POE | AN4 | ADM3 | Trialkyl phosphate |
| 74C | 10-75% | POE | AN4 | ADM3 | Triaryl phosphate |
| 75B | 10-75% | POE | AN5 | ADM3 | Trialkyl phosphate |
| 75C | 10-75% | POE | AN5 | ADM3 | Triaryl phosphate |
| 76B | 10-75% | POE | AN10 | ADM3 | Trialkyl phosphate |
| 76C | 10-75% | POE | AN10 | ADM3 | Triaryl phosphate |
| 77B | 10-75% | POE | AN4 | ADM4 | Trialkyl phosphate |
| 77C | 10-75% | POE | AN4 | ADM4 | Triaryl phosphate |
| 78B | 10-75% | POE | AN5 | ADM4 | Trialkyl phosphate |
| 78C | 10-75% | POE | AN5 | ADM4 | Triaryl phosphate |
| 79B | 10-75% | POE | AN10 | ADM4 | Trialkyl phosphate |
| 79C | 10-75% | POE | AN10 | ADM4 | Triaryl phosphate |
| 80B | 10-75% | POE | AN4 | ADM5 | Trialkyl phosphate |
| 80C | 10-75% | POE | AN4 | ADM5 | Triaryl phosphate |
| 81B | 10-75% | POE | AN5 | ADM5 | Trialkyl phosphate |
| 81C | 10-75% | POE | AN5 | ADM5 | Trialkyl phosphate |
| 82B | 10-75% | POE | AN10 | ADM5 | Trialkyl phosphate |
| 82C | 10-75% | POE | AN10 | ADM5 | Triaryl phosphate |
| 83B | 10-75% | POE | AN4 | ADM6 | Trialkyl phosphate |
| 83C | 10-75% | POE | AN4 | ADM6 | Triaryl phosphate |
| 84B | 10-75% | POE | AN5 | ADM6 | Trialkyl phosphate |
| 84C | 10-75% | POE | AN5 | ADM6 | Triaryl phosphate |
| 85B | 10-75% | POE | AN10 | ADM6 | Trialkyl phosphate |
| 85C | 10-75% | POE | AN10 | ADM6 | Triaryl phosphate |
| 86B | 10-75% | POE (Lubricant 1) | AN4 | ADM4 | Trialkyl phosphate |
| 86C | 10-75% | POE (Lubricant 1) | AN4 | ADM4 | Triaryl phosphate |
| 87B | 10-75% | POE (Lubricant 1) | AN5 | ADM4 | Trialkyl phosphate |
| 87C | 10-75% | POE (Lubricant 1) | AN5 | ADM4 | Triaryl phosphate |
| 88B | 10-75% | POE (Lubricant 1) | AN10 | ADM4 | Trialkyl phosphate |
| 88C | 10-75% | POE (Lubricant 1) | AN10 | ADM4 | Triaryl phosphate |
| 89B | 10-75% | POE (Lubricant 1) | AN4 | ADM6 | Trialkyl phosphate |
| 89C | 10-75% | POE (Lubricant 1) | AN4 | ADM6 | Triaryl phosphate |
| 90B | 10-75% | POE (Lubricant 1) | AN5 | ADM6 | Trialkyl phosphate |
| 90C | 10-75% | POE (Lubricant 1) | AN5 | ADM6 | Triaryl phosphate |
| 91B | 10-75% | POE (Lubricant 1) | AN10 | ADM6 | Trialkyl phosphate |
| 91C | 10-75% | POE (Lubricant 1) | AN10 | ADM6 | Triaryl phosphate |
| 92B | 10-75% | POE (Lubricant 2) | AN4 | ADM4 | Trialkyl phosphate |
| 92C | 10-75% | POE (Lubricant 2) | AN4 | ADM4 | Triaryl phosphate |
| 93B | 10-75% | POE (Lubricant 2) | AN5 | ADM4 | Trialkyl phosphate |
| 93C | 10-75% | POE (Lubricant 2) | AN5 | ADM4 | Triaryl phosphate |
| 94B | 10-75% | POE (Lubricant 2) | AN10 | ADM4 | Trialkyl phosphate |
| 94C | 10-75% | POE (Lubricant 2) | AN10 | ADM4 | Triaryl phosphate |
| 95B | 10-75% | POE (Lubricant 2) | AN4 | ADM6 | Trialkyl phosphate |
| 95C | 10-75% | POE (Lubricant 2) | AN4 | ADM6 | Triaryl phosphate |
| 96B | 10-75% | POE (Lubricant 2) | AN5 | ADM6 | Trialkyl phosphate |
| 96C | 10-75% | POE (Lubricant 2) | AN5 | ADM6 | Triaryl phosphate |
| 97B | 10-75% | POE (Lubricant 2) | AN10 | ADM6 | Trialkyl phosphate |
| 97C | 10-75% | POE (Lubricant 2) | AN10 | ADM6 | Triaryl phosphate |
| 98B | 10-75% | PVE | AN4 | ADM4 | Trialkyl phosphate |
| 98C | 10-75% | PVE | AN4 | ADM4 | Triaryl phosphate |
| 99B | 10-75% | PVE | AN5 | ADM4 | Trialkyl phosphate |
| 99C | 10-75% | PVE | AN5 | ADM4 | Triaryl phosphate |
| 100B | 10-75% | PVE | AN10 | ADM4 | Trialkyl phosphate |
| 100C | 10-75% | PVE | AN10 | ADM4 | Triaryl phosphate |
| 101B | 10-75% | PVE | AN4 | ADM6 | Trialkyl phosphate |
| 101C | 10-75% | PVE | AN4 | ADM6 | Triaryl phosphate |
| 102B | 10-75% | PVE | AN5 | ADM6 | Trialkyl phosphate |
| 102C | 10-75% | PVE | AN5 | ADM6 | Triaryl phosphate |
| 103B | 10-75% | PVE | AN10 | ADM6 | Trialkyl phosphate |
| 103C | 10-75% | PVE | AN10 | ADM6 | Triaryl phosphate |
| 104B | 10-75% | PVE (Lubricant 3) | AN4 | ADM4 | Trialkyl phosphate |
| 104C | 10-75% | PVE (Lubricant 3) | AN4 | ADM4 | Triaryl phosphate |
| 105B | 10-75% | PVE (Lubricant 3) | AN5 | ADM4 | Trialkyl phosphate |
| 105C | 10-75% | PVE (Lubricant 3) | AN5 | ADM4 | Triaryl phosphate |
| 16B | 10-75% | PVE (Lubricant 3) | AN10 | ADM4 | Trialkyl phosphate |
| 106C | 10-75% | PVE (Lubricant 3) | AN10 | ADM4 | Triaryl phosphate |
| 107B | 10-75% | PVE (Lubricant 3) | AN4 | ADM6 | Trialkyl phosphate |
| 107C | 10-75% | PVE (Lubricant 3) | AN4 | ADM6 | Triaryl phosphate |
| 108B | 10-75% | PVE (Lubricant 3) | AN5 | ADM6 | Trialkyl phosphate |
| 108C | 10-75% | PVE (Lubricant 3) | AN5 | ADM6 | Triaryl phosphate |
| 109B | 10-75% | PVE (Lubricant 3) | AN10 | ADM6 | Trialkyl phosphate |
| 109C | 10-75% | PVE (Lubricant 3) | AN10 | ADM6 | Triaryl phosphate |

Preferred heat transfer compositions of the present invention comprising a refrigerant of the present invention comprising from about 10% to about 75% of R1132(E) (as specified in Table 1-4), alkylated naphthalene, an epoxide-based acid depleting moiety and a phosphate are described, with concentrations ranges as appropriate, in the following Table 5.

TABLE 5

| Heat | COMPONENT AND AMOUNT IN HEAT TRANSFER COMPOSITION | | | | | | | | |
|---|---|---|---|---|---|---|---|---|---|
| Transfer | Total | | | Stabilizer, wt. % (based on weight | | | | | |
| Comp. | refrigerant, | Lubricant, | | of lubricant + stabilizer) | | | | | |
| (HTC) | wt. % in | wt. % in HTC | | AN | | ADM | | | |
| No. | HTC | Type | Wt. % | No | Wt. % | No. | Wt. % | Phosphate | Wt. % |
| 26B1A | 50-99.9 | POE | 0.1-50 | 4 | 0.1-20 | 1A | 0.05-2.5 | Trialkyl | 0.001-2.5 |
| | | | | | | | | phosphate | |
| 26B1B | 50-99.9 | PVE | 0.1-50 | 4 | 0.1-20 | 1A | 0.05-2.5 | Trialkyl | 0.001-2.5 |
| | | | | | | | | phosphate | |
| 26B2A | 50-99.9 | POE | 0.1-50 | 4 | 1.5-10 | 1A | 0.05-2.5 | Trialkyl | 0.001-2.5 |
| | | | | | | | | phosphate | |
| 26B2B | 50-99.9 | PVE | 0.1-50 | 4 | 1.5-10 | 1A | 0.05-2.5 | Trialkyl | 0.001-2.5 |
| | | | | | | | | phosphate | |
| 26B3A | 50-99.9 | POE | 0.1-50 | 4 | 1.5-8 | 1A | 0.05-2.5 | Trialkyl | 0.0012.5 |
| | | | | | | | | phosphate | |
| 26B3B | 50-99.9 | PVE | 0.1-50 | 4 | 1.5-8 | 1A | 0.05-2.5 | Trialkyl | 0.001-2.5 |
| | | | | | | | | phosphate | |
| 26B4A | 50-99.9 | POE | 0.1-50 | 4 | 1.5-6 | 1A | 0.05-2.5 | Trialkyl | 0.0012.5 |
| | | | | | | | | phosphate | |
| 26B4B | 50-99.9 | PVE | 0.1-50 | 4 | 1.5-6 | 1A | 0.05-2.5 | Trialkyl | 0.001-2.5 |
| | | | | | | | | phosphate | |
| 26B5A | 50-99.9 | POE | 0.1-50 | 4 | 2 | 1A | 0.05-2.5 | Trialkyl | 0.001-2.5 |
| | | | | | | | | phosphate | |
| 26B5B | 50-99.9 | PVE | 0.1-50 | 4 | 2 | 1A | 0.05-2.5 | Trialkyl | 0.001-2.5 |
| | | | | | | | | phosphate | |
| 26B6A | 50-99.9 | POE | 0.1-50 | 4 | 4 | 1A | 0.05-2.5 | NR | NR |
| 26B6B | 50-99.9 | PVE | 0.1-50 | 4 | 4 | 1A | 0.05-2.5 | NR | NR |
| 26C1A | 50-99.9 | POE | 0.1-50 | 4 | 0.1-20 | 1A | 0.05-2.5 | Triaryl | 0.001-2.5 |
| | | | | | | | | phosphate | |
| 26C1B | 50-99.9 | PVE | 0.1-50 | 4 | 0.1-20 | 1A | 0.05-2.5 | Triaryl | 0.001-2.5 |
| | | | | | | | | phosphate | |
| 26C2A | 50-99.9 | POE | 0.1-50 | 4 | 1.5-10 | 1A | 0.05-2.5 | Triaryl | 0.001-2.5 |
| | | | | | | | | phosphate | |
| 26C2B | 50-99.9 | PVE | 0.1-50 | 4 | 1.5-10 | 1A | 0.05-2.5 | Triaryl | 0.001-2.5 |
| | | | | | | | | phosphate | |
| 26C3A | 50-99.9 | POE | 0.1-50 | 4 | 1.5- | 1A | 0.05 | Triaryl | 0.001- |
| | | | | | 8 | | -2.5 | phosphate | 2.5 |
| 26C3B | 50-99.9 | PVE | 0.1-50 | 4 | 1.5- | 1A | 0.05 | Triaryl | 0.001- |
| | | | | | 8 | | -2.5 | phosphate | 2.5 |
| 26C4A | 50-99.9 | POE | 0.1-50 | 4 | 1.5- | 1A | 0.05 | Triaryl | 0.001- |
| | | | | | 6 | | -2.5 | phosphate | 2.5 |
| 26C4B | 50-99.9 | PVE | 0.1-50 | 4 | 1.5- | 1A | 0.05 | Triaryl | 0.001- |
| | | | | | 6 | | -2.5 | phosphate | 2.5 |
| 26C5A | 50-99.9 | POE | 0.1-50 | 4 | 2 | 1A | 0.05-2.5 | Triaryl | 0.001-2.5 |
| | | | | | | | | phosphate | |
| 26C5B | 50-99.9 | PVE | 0.1-50 | 4 | 2 | 1A | 0.05-2.5 | Triaryl | 0.001-2.5 |
| | | | | | | | | phosphate | |
| 26C6A | 50-99.9 | POE | 0.1-50 | 4 | 4 | 1A | 0.05-2.5 | NR | NR |
| 26C6B | 50-99.9 | PVE | 0.1-50 | 4 | 4 | 1A | 0.05-2.5 | NR | NR |
| 27B1A | 50-99.9 | POE | 0.1-50 | 4 | 0.1-20 | 1B | 0.05-2.5 | Trialkyl | 0.001-2.5 |
| | | | | | | | | phosphate | |
| 27B1B | 50-99.9 | PVE | 0.1-50 | 4 | 0.1-20 | 1B | 0.05-2.5 | Trialkyl | 0.001-2.5 |
| | | | | | | | | phosphate | |
| 27B2A | 50-99.9 | POE | 0.1-50 | 4 | 1.5-10 | 1B | 0.05-2.5 | Trialkyl | 0.0012.5 |
| | | | | | | | | phosphate | |
| 27B2B | 50-99.9 | PVE | 0.1-50 | 4 | 1.5-10 | 1B | 0.05-2.5 | Trialkyl | 0.001-2.5 |
| | | | | | | | | phosphate | |
| 27B3A | 50-99.9 | POE | 0.1-50 | 4 | 1.5-8 | 1B | 0.05-2.5 | Trialkyl | 0.001-2.5 |
| | | | | | | | | phosphate | |
| 27B3B | 50-99.9 | PVE | 0.1-50 | 4 | 1.5-8 | 1B | 0.05-2.5 | Trialkyl | 0.001-2.5 |
| | | | | | | | | phosphate | |
| 27B4A | 50-99.9 | POE | 0.1-50 | 4 | 1.5-6 | 1B | 0.05-2.5 | Trialkyl | 0.001-2.5 |
| | | | | | | | | phosphate | |
| 27B4B | 50-99.9 | PVE | 0.1-50 | 4 | 1.5-6 | 1B | 0.05-2.5 | Trialkyl | 0.001-2.5 |
| | | | | | | | | phosphate | |
| 27B5A | 50-99.9 | POE | 0.1-50 | 4 | 2 | 1B | 0.05-2.5 | Trialkyl | 0.001-2.5 |
| | | | | | | | | phosphate | |
| 27B5B | 50-99.9 | PVE | 0.1-50 | 4 | 2 | 1B | 0.05-2.5 | Trialkyl | 0.0012.5 |
| | | | | | | | | phosphate | |
| 27B6A | 50-99.9 | POE | 0.1-50 | 4 | 4 | 1B | 0.05-2.5 | NR | NR |
| 27B6B | 50-99.9 | PVE | 0.1-50 | 4 | 4 | 1B | 0.05-2.5 | NR | NR |
| 27C1A | 50-99.9 | POE | 0.1-50 | 4 | 0.1-20 | 1B | 0.05-2.5 | Triaryl | 0.001-2.5 |
| | | | | | | | | phosphate | |
| 27C1B | 50-99.9 | PVE | 0.1-50 | 4 | 0.1-20 | 1B | 0.05-2.5 | Triaryl | 0.0012.5 |
| | | | | | | | | phosphate | |
| 27C2A | 50-99.9 | POE | 0.1-50 | 4 | 1.5-10 | 1B | 0.05-2.5 | Triaryl | 0.001-2.5 |
| | | | | | | | | phosphate | |
| 27C2B | 50-99.9 | PVE | 0.1-50 | 4 | 1.5-10 | 1B | 0.05-2.5 | Triaryl | 0.001-2.5 |
| | | | | | | | | phosphate | |
| 27C3A | 50-99.9 | POE | 0.1-50 | 4 | 1.5-8 | 1B | 0.05-2.5 | Triaryl | 0.0012.5 |
| | | | | | | | | phosphate | |
| 27C3B | 50-99.9 | PVE | 0.1-50 | 4 | 1.5-8 | 1B | 0.05-2.5 | Triaryl | 0.001-2.5 |
| | | | | | | | | phosphate | |
| 27C4A | 50-99.9 | POE | 0.1-50 | 4 | 1.5-6 | 1B | 0.05-2.5 | Triaryl | 0.001-2.5 |
| | | | | | | | | phosphate | |
| 27C4B | 50-99.9 | PVE | 0.1-50 | 4 | 1.5-6 | 1B | 0.05-2.5 | Triaryl | 0.0012.5 |
| | | | | | | | | phosphate | |
| 27C5A | 50-99.9 | POE | 0.1-50 | 4 | 2 | 1B | 0.05-2.5 | Triaryl | 0.001-2.5 |
| | | | | | | | | phosphate | |
| 27C5B | 50-99.9 | PVE | 0.1-50 | 4 | 2 | 1B | 0.05-2.5 | Triaryl | 0.001-2.5 |
| | | | | | | | | phosphate | |
| 27C6A | 50-99.9 | POE | 0.1-50 | 4 | 4 | 1B | 0.05-2.5 | NR | NR |
| 27C6B | 50-99.9 | PVE | 0.1-50 | 4 | 4 | 1B | 0.05-2.5 | NR | NR |
| 28B1A | 50-99.9 | POE | 0.1-50 | 4 | 0.1-20 | 1C | 0.05-2.5 | Trialkyl | 0.001-2.5 |
| | | | | | | | | phosphate | |
| 28B1B | 50-99.9 | PVE | 0.1-50 | 4 | 0.1-20 | 1C | 0.05-2.5 | Trialkyl | 0.001-2.5 |
| | | | | | | | | phosphate | |
| 28B2A | 50-99.9 | POE | 0.1-50 | 4 | 1.5-10 | 1C | 0.05-2.5 | Trialkyl | 0.001-2.5 |
| | | | | | | | | phosphate | |
| 28B2B | 50-99.9 | PVE | 0.1-50 | 4 | 1.5-10 | 1C | 0.05-2.5 | Trialkyl | 0.0012.5 |
| | | | | | | | | phosphate | |
| 28B3A | 50-99.9 | POE | 0.1-50 | 4 | 1.5-8 | 1C | 0.05-2.5 | Trialkyl | 0.001-2.5 |
| | | | | | | | | phosphate | |
| 28B3B | 50-99.9 | PVE | 0.1-50 | 4 | 1.5-8 | 1C | 0.05-2.5 | Trialkyl | 0.001-2.5 |
| | | | | | | | | phosphate | |
| 28B4A | 50-99.9 | POE | 0.1-50 | 4 | 1.5-6 | 1C | 0.05-2.5 | Trialkyl | 0.001-2.5 |
| | | | | | | | | phosphate | |
| 28B4B | 50-99.9 | PVE | 0.1-50 | 4 | 1.5-6 | 1C | 0.05-2.5 | Trialkyl | 0.001-2.5 |
| | | | | | | | | phosphate | |
| 28B5A | 50-99.9 | POE | 0.1-50 | 4 | 2 | 1C | 0.05-2.5 | Trialkyl | 0.001-2.5 |
| | | | | | | | | phosphate | |
| 28B5B | 50-99.9 | PVE | 0.1-50 | 4 | 2 | 1C | 0.05-2.5 | Trialkyl | 0.001-2.5 |
| | | | | | | | | phosphate | |
| 28B6A | 50-99.9 | POE | 0.1-50 | 4 | 4 | 1C | 0.05-2.5 | NR | NR |
| 28B6B | 50-99.9 | PVE | 0.1-50 | 4 | 4 | 1C | 0.05-2.5 | NR | NR |
| 28C1A | 50-99.9 | POE | 0.1-50 | 4 | 0.1-20 | 1C | 0.05-2.5 | Triaryl | 0.001-2.5 |
| | | | | | | | | phosphate | |
| 28C1B | 50-99.9 | PVE | 0.1-50 | 4 | 0.1-20 | 1C | 0.05-2.5 | Triaryl | 0.001-2.5 |
| | | | | | | | | phosphate | |
| 28C2A | 50-99.9 | POE | 0.1-50 | 4 | 1.5-10 | 1C | 0.05-2.5 | Triaryl | 0.001-2.5 |
| | | | | | | | | phosphate | |
| 28C2B | 50-99.9 | PVE | 0.1-50 | 4 | 1.5-10 | 1C | 0.05-2.5 | Triaryl | 0.001-2.5 |
| | | | | | | | | phosphate | |
| 28C3A | 50-99.9 | POE | 0.1-50 | 4 | 1.5-8 | 1C | 0.05-2.5 | Triaryl | 0.0012.5 |
| | | | | | | | | phosphate | |
| 28C3B | 50-99.9 | PVE | 0.1-50 | 4 | 1.5-8 | 1C | 0.05-2.5 | Triaryl | 0.001-2.5 |
| | | | | | | | | phosphate | |
| 28C4A | 50-99.9 | POE | 0.1-50 | 4 | 1.5-6 | 1C | 0.05-2.5 | Triaryl | 0.001-2.5 |
| | | | | | | | | phosphate | |
| 28C4B | 50-99.9 | PVE | 0.1-50 | 4 | 1.5-6 | 1C | 0.05-2.5 | Triaryl | 0.0012.5 |
| | | | | | | | | phosphate | |
| 28C5A | 50-99.9 | POE | 0.1-50 | 4 | 4 | 1C | 0.05-2.5 | Triaryl | 0.001-2.5 |
| | | | | | | | | phosphate | |
| 28C5B | 50-99.9 | PVE | 0.1-50 | 4 | 4 | 1C | 0.05-2.5 | Triaryl | 0.0012.5 |
| | | | | | | | | phosphate | |
| 29B1A | 50-99.9 | POE | 0.1-50 | 4 | 0.1-20 | 1D | 0.05-2.5 | Trialkyl | 0.001-2.5 |
| | | | | | | | | phosphate | |
| 29B1B | 50-99.9 | PVE | 0.1-50 | 4 | 0.1-20 | 1D | 0.05-2.5 | Trialkyl | 0.001-2.5 |
| | | | | | | | | phosphate | |
| 29B2A | 50-99.9 | POE | 0.1-50 | 4 | 1.5-10 | 1D | 0.05-2.5 | Trialkyl | 0.001-2.5 |
| | | | | | | | | phosphate | |
| 29B2B | 50-99.9 | PVE | 0.1-50 | 4 | 1.5-10 | 1D | 0.05-2.5 | Trialkyl | 0.001-2.5 |
| | | | | | | | | phosphate | |
| 29B3A | 50-99.9 | POE | 0.1-50 | 4 | 1.5-8 | 1D | 0.05-2.5 | Trialkyl | 0.001-2.5 |
| | | | | | | | | phosphate | |
| 29B3B | 50-99.9 | PVE | 0.1-50 | 4 | 1.5-8 | 1D | 0.05-2.5 | Trialkyl | 0.001-2.5 |
| | | | | | | | | phosphate | |
| 29B4A | 50-99.9 | POE | 0.1-50 | 4 | 1.5-6 | 1D | 0.05-2.5 | Trialkyl | 0.001-2.5 |
| | | | | | | | | phosphate | |
| 29B4B | 50-99.9 | PVE | 0.1-50 | 4 | 1.5-6 | 1D | 0.05-2.5 | Trialkyl | 0.001-2.5 |
| | | | | | | | | phosphate | |
| 29B5A | 50-99.9 | POE | 0.1-50 | 4 | 2 | 1D | 0.05-2.5 | Trialkyl | 0.001-2.5 |
| | | | | | | | | phosphate | |
| 29B5B | 50-99.9 | PVE | 0.1-50 | 4 | 2 | 1D | 0.05-2.5 | Trialkyl | 0.001-2.5 |
| | | | | | | | | phosphate | |
| 29B6A | 50-99.9 | POE | 0.1-50 | 4 | 4 | 1D | 0.05-2.5 | NR | NR |
| 29B6B | 50-99.9 | PVE | 0.1-50 | 4 | 4 | 1D | 0.05-2.5 | NR | NR |
| 29C1A | 50-99.9 | POE | 0.1-50 | 4 | 0.1-20 | 1D | 0.05-2.5 | Triaryl | 0.001-2.5 |
| | | | | | | | | phosphate | |
| 29C1B | 50-99.9 | PVE | 0.1-50 | 4 | 0.1-20 | 1D | 0.05-2.5 | Triaryl | 0.001-2.5 |
| | | | | | | | | phosphate | |
| 29C2A | 50-99.9 | POE | 0.1-50 | 4 | 1.5-10 | 1D | 0.05-2.5 | Triaryl | 0.001-2.5 |
| | | | | | | | | phosphate | |
| 29C2B | 50-99.9 | PVE | 0.1-50 | 4 | 1.5-10 | 1D | 0.05-2.5 | Triaryl | 0.001-2.5 |
| | | | | | | | | phosphate | |
| 29C3A | 50-99.9 | POE | 0.1-50 | 4 | 1.5-8 | 1D | 0.05-2.5 | Triaryl | 0.001-2.5 |
| | | | | | | | | phosphate | |
| 29C3B | 50-99.9 | PVE | 0.1-50 | 4 | 1.5-8 | 1D | 0.05-2.5 | Triaryl | 0.001-2.5 |
| | | | | | | | | phosphate | |
| 29C4A | 50-99.9 | POE | 0.1-50 | 4 | 1.5-6 | 1D | 0.05-2.5 | Triaryl | 0.001-2.5 |
| | | | | | | | | phosphate | |
| 29C4B | 50-99.9 | PVE | 0.1-50 | 4 | 1.5-6 | 1D | 0.05-2.5 | Triaryl | 0.001-2.5 |
| | | | | | | | | phosphate | |
| 29C5A | 50-99.9 | POE | 0.1-50 | 4 | 2 | 1D | 0.05-2.5 | Triaryl | 0.001-2.5 |
| | | | | | | | | phosphate | |
| 29C5B | 50-99.9 | PVE | 0.1-50 | 4 | 2 | 1D | 0.05-2.5 | Triaryl | 0.001-2.5 |
| | | | | | | | | phosphate | |
| 29C6A | 50-99.9 | POE | 0.1-50 | 4 | 4 | 1D | 0.05-2.5 | NR | NR |
| 29C6B | 50-99.9 | PVE | 0.1-50 | 4 | 4 | 1D | 0.05-2.5 | NR | NR |
| 30B1A | 50-99.9 | POE | 0.1-50 | 4 | 0.1-20 | 2A | 0.05-2.5 | Trialkyl | 0.001-2.5 |
| | | | | | | | | phosphate | |
| 30B1B | 50-99.9 | PVE | 0.1-50 | 4 | 0.1-20 | 2A | 0.05-2.5 | Trialkyl | 0.001-2.5 |
| | | | | | | | | phosphate | |
| 30B2A | 50-99.9 | POE | 0.1-50 | 4 | 1.5-10 | 2A | 0.05-2.5 | Trialkyl | 0.001-2.5 |
| | | | | | | | | phosphate | |
| 30B2B | 50-99.9 | PVE | 0.1-50 | 4 | 1.5-10 | 2A | 0.05-2.5 | Trialkyl | 0.001-2.5 |
| | | | | | | | | phosphate | |
| 30B3A | 50-99.9 | POE | 0.1-50 | 4 | 1.5-8 | 2A | 0.05-2.5 | Trialkyl | 0.001-2.5 |
| | | | | | | | | phosphate | |
| 303B | 50-99.9 | PVE | 0.1-50 | 4 | 1.5-8 | 2A | 0.05-2.5 | Trialkyl | 0.001-2.5 |
| | | | | | | | | phosphate | |
| 30B4A | 50-99.9 | POE | 0.1-50 | 4 | 1.5-6 | 2A | 0.05-2.5 | Trialkyl | 0.001-2.5 |
| | | | | | | | | phosphate | |
| 30B4B | 50-99.9 | PVE | 0.1-50 | 4 | 1.5-6 | 2A | 0.05-2.5 | Trialkyl | 0.001-2.5 |
| | | | | | | | | phosphate | |
| 30B5A | 50-99.9 | POE | 0.1-50 | 4 | 2 | 2A | 0.05-2.5 | Trialkyl | 0.001-2.5 |
| | | | | | | | | phosphate | |
| 30B5B | 50-99.9 | PVE | 0.1-50 | 4 | 2 | 2A | 0.05-2.5 | Trialkyl | 0.001-2.5 |
| | | | | | | | | phosphate | |
| 30B6A | 50-99.9 | POE | 0.1-50 | 4 | 4 | 2A | 0.05-2.5 | NR | NR |
| 30B6B | 50-99.9 | PVE | 0.1-50 | 4 | 4 | 2A | 0.05-2.5 | NR | NR |
| 30C1A | 50-99.9 | POE | 0.1-50 | 4 | 0.1-20 | 2A | 0.05-2.5 | Triaryl | 0.001-2.5 |
| | | | | | | | | phosphate | |
| 30C1B | 50-99.9 | PVE | 0.1-50 | 4 | 0.1-20 | 2A | 0.05-2.5 | Triaryl | 0.001-2.5 |
| | | | | | | | | phosphate | |
| 30C2A | 50-99.9 | POE | 0.1-50 | 4 | 1.5-10 | 2A | 0.05-2.5 | Triaryl | 0.001-2.5 |
| | | | | | | | | phosphate | |
| 30C2B | 50-99.9 | PVE | 0.1-50 | 1 | 1.5-10 | 2A | 0.05-2.5 | Triaryl | 0.001-2.5 |
| | | | | | | | | phosphate | |
| 30C3A | 50-99.9 | POE | 0.1-50 | 4 | 1.5-8 | 2A | 0.05-2.5 | Triaryl | 0.001-2.5 |
| | | | | | | | | phosphate | |
| 30C3B | 50-99.9 | PVE | 0.1-50 | 4 | 1.5-8 | 2A | 0.05-2.5 | Triaryl | 0.001-2.5 |
| | | | | | | | | phosphate | |
| 30C4A | 50-99.9 | POE | 0.1-50 | 4 | 1.5-6 | 2A | 0.05-2.5 | Triaryl | 0.001-2.5 |
| | | | | | | | | phosphate | |
| 30C4B | 50-99.9 | PVE | 0.1-50 | 4 | 1.5-6 | 2A | 0.05-2.5 | Triaryl | 0.001-2.5 |
| | | | | | | | | phosphate | |
| 30C5A | 50-99.9 | POE | 0.1-50 | 4 | 2 | 2A | 0.05-2.5 | Triaryl | 0.001-2.5 |
| | | | | | | | | phosphate | |
| 30C5B | 50-99.9 | PVE | 0.1-50 | 4 | 2 | 2A | 0.05-2.5 | Triaryl | 0.001-2.5 |
| | | | | | | | | phosphate | |
| 30C6A | 50-99.9 | POE | 0.1-50 | 4 | 4 | 2A | 0.05-2.5 | NR | NR |
| 30C6B | 50-99.9 | PVE | 0.1-50 | 4 | 4 | 2A | 0.05-2.5 | NR | NR |
| 31B1A | 50-99.9 | POE | 0.1-50 | 4 | 0.1-20 | 2B | 0.05-2.5 | Trialkyl | 0.001-2.5 |
| | | | | | | | | phosphate | |
| 3128B1B | 50-99.9 | PVE | 0.1-50 | 4 | 0.1-20 | 2B | 0.05-2.5 | Trialkyl | 0.001-2.5 |
| | | | | | | | | phosphate | |
| 31B2A | 50-99.9 | POE | 0.1-50 | 4 | 1.5-10 | 2B | 0.05-2.5 | Trialkyl | 0.001-2.5 |
| | | | | | | | | phosphate | |
| 31B2B | 50-99.9 | PVE | 0.1-50 | 4 | 1.5-10 | 2B | 0.05-2.5 | Trialkyl | 0.001-2.5 |
| | | | | | | | | phosphate | |
| 31B3A | 50-99.9 | POE | 0.1-50 | 4 | 1.5-8 | 2B | 0.05-2.5 | Trialkyl | 0.001-2.5 |
| | | | | | | | | phosphate | |
| 31B3B | 50-99.9 | PVE | 0.1-50 | 4 | 1.5-8 | 2B | 0.05-2.5 | Trialkyl | 0.001-2.5 |
| | | | | | | | | phosphate | |
| 31B4A | 50-99.9 | POE | 0.1-50 | 4 | 1.5-6 | 2B | 0.05-2.5 | Trialkyl | 0.001-2.5 |
| | | | | | | | | phosphate | |
| 31B4B | 50-99.9 | PVE | 0.1-50 | 4 | 1.5-6 | 2B | 0.05-2.5 | Trialkyl | 0.001-2.5 |
| | | | | | | | | phosphate | |
| 31B5A | 50-99.9 | POE | 0.1-50 | 4 | 2 | 2B | 0.05-2.5 | Trialkyl | 0.001-2.5 |
| | | | | | | | | phosphate | |
| 31B5B | 50-99.9 | PVE | 0.1-50 | 4 | 2 | 2B | 0.05-2.5 | Trialkyl | 0.001-2.5 |
| | | | | | | | | phosphate | |
| 31B6A | 50-99.9 | POE | 0.1-50 | 4 | 4 | 2B | 0.05-2.5 | NR | NR |
| 31B6B | 50-99.9 | PVE | 0.1-50 | 4 | 4 | 2B | 0.05-2.5 | NR | NR |
| 31C1A | 50-99.9 | POE | 0.1-50 | 4 | 0.1-20 | 2B | 0.05-2.5 | Triaryl | 0.001-2.5 |
| | | | | | | | | phosphate | |
| 31C1B | 50-99.9 | PVE | 0.1-50 | 4 | 0.1-20 | 2B | 0.05-2.5 | Triaryl | 0.001-2.5 |
| | | | | | | | | phosphate | |
| 31C2A | 50-99.9 | POE | 0.1-50 | 4 | 1.5-10 | 2B | 0.05-2.5 | Triaryl | 0.001-2.5 |
| | | | | | | | | phosphate | |
| 31C2B | 50-99.9 | PVE | 0.1-50 | 4 | 1.5-10 | 2B | 0.05-2.5 | Triaryl | 0.001-2.5 |
| | | | | | | | | phosphate | |
| 31C3A | 50-99.9 | POE | 0.1-50 | 4 | 1.5-8 | 2B | 0.05-2.5 | Triaryl | 0.001-2.5 |
| | | | | | | | | phosphate | |
| 31C3B | 50-99.9 | PVE | 0.1-50 | 4 | 1.5-8 | 2B | 0.05-2.5 | Triaryl | 0.001-2.5 |
| | | | | | | | | phosphate | |
| 31C4A | 50-99.9 | POE | 0.1-50 | 4 | 1.5-6 | 2B | 0.05-2.5 | Triaryl | 0.001-2.5 |
| | | | | | | | | phosphate | |
| 31C4B | 50-99.9 | PVE | 0.1-50 | 4 | 1.5-6 | 2B | 0.05-2.5 | Triaryl | 0.001-2.5 |
| | | | | | | | | phosphate | |
| 318C5A | 50-99.9 | POE | 0.1-50 | 4 | 2 | 2B | 0.05-2.5 | Triaryl | 0.001-2.5 |
| | | | | | | | | phosphate | |
| 31C5B | 50-99.9 | PVE | 0.1-50 | 4 | 2 | 2B | 0.05-2.5 | Triaryl | 0.001-2.5 |
| | | | | | | | | phosphate | |
| 31C6A | 50-99.9 | POE | 0.1-50 | 4 | 4 | 2B | 0.05-2.5 | NR | NR |
| 31C6B | 50-99.9 | PVE | 0.1-50 | 4 | 4 | 2B | 0.05-2.5 | NR | NR |
| 32B1A | 50-99.9 | POE | 0.1-50 | 4 | 0.1-20 | 3A | 0.05-2.5 | Trialkyl | 0.001-2.5 |
| | | | | | | | | phosphate | |
| 32B1B | 50-99.9 | PVE | 0.1-50 | 4 | 0.1-20 | 3A | 0.05-2.5 | Trialkyl | 0.001-2.5 |
| | | | | | | | | phosphate | |
| 32B2A | 50-99.9 | POE | 0.1-50 | 4 | 1.5-10 | 3A | 0.05-2.5 | Trialkyl | 0.001-2.5 |
| | | | | | | | | phosphate | |
| 32B2B | 50-99.9 | PVE | 0.1-50 | 4 | 1.5-10 | 3A | 0.05-2.5 | Trialkyl | 0.001-2.5 |
| | | | | | | | | phosphate | |
| 32B3A | 50-99.9 | POE | 0.1-50 | 4 | 1.5-8 | 3A | 0.05-2.5 | Trialkyl | 0.001-2.5 |
| | | | | | | | | phosphate | |
| 32B3B | 50-99.9 | PVE | 0.1-50 | 4 | 1.5-8 | 3A | 0.05-2.5 | Trialkyl | 0.001-2.5 |
| | | | | | | | | phosphate | |
| 32B4A | 50-99.9 | POE | 0.1-50 | 4 | 1.5-6 | 3A | 0.05-2.5 | Trialkyl | 0.001-2.5 |
| | | | | | | | | phosphate | |
| 32B4B | 50-99.9 | PVE | 0.1-50 | 4 | 1.5-6 | 3A | 0.05-2.5 | Trialkyl | 0.001-2.5 |
| | | | | | | | | phosphate | |
| 32B5A | 50-99.9 | POE | 0.1-50 | 4 | 2 | 3A | 0.05-2.5 | Trialkyl | 0.001-2.5 |
| | | | | | | | | phosphate | |
| 32B5B | 50-99.9 | PVE | 0.1-50 | 4 | 2 | 3A | 0.05-2.5 | Trialkyl | 0.001-2.5 |
| | | | | | | | | phosphate | |
| 32B6A | 50-99.9 | POE | 0.1-50 | 4 | 4 | 3A | 0.05-2.5 | NR | NR |
| 32B6B | 50-99.9 | PVE | 0.1-50 | 4 | 4 | 3A | 0.05-2.5 | NR | NR |
| 32C1A | 50-99.9 | POE | 0.1-50 | 4 | 0.1-20 | 3A | 0.05-2.5 | Triaryl | 0.001-2.5 |
| | | | | | | | | phosphate | |
| 32C1B | 50-99.9 | PVE | 0.1-50 | 4 | 0.1-20 | 3A | 0.05-2.5 | Triaryl | 0.001-2.5 |
| | | | | | | | | phosphate | |
| 32C2A | 50-99.9 | POE | 0.1-50 | 4 | 1.5-10 | 3A | 0.05-2.5 | Triaryl | 0.001-2.5 |
| | | | | | | | | phosphate | |
| 32C2B | 50-99.9 | PVE | 0.1-50 | 4 | 1.5-10 | 3A | 0.05-2.5 | Triaryl | 0.001-2.5 |
| | | | | | | | | phosphate | |
| 32C3A | 50-99.9 | POE | 0.1-50 | 4 | 1.5-8 | 3A | 0.05-2.5 | Triaryl | 0.001-2.5 |
| | | | | | | | | phosphate | |
| 32C3B | 50-99.9 | PVE | 0.1-50 | 4 | 1.5-8 | 3A | 0.05-2.5 | Triaryl | 0.001-2.5 |
| | | | | | | | | phosphate | |
| 32C4A | 50-99.9 | POE | 0.1-50 | 4 | 1.5-6 | 3A | 0.05-2.5 | Triaryl | 0.001-2.5 |
| | | | | | | | | phosphate | |
| 32C4B | 50-99.9 | PVE | 0.1-50 | 4 | 1.5-6 | 3A | 0.05-2.5 | Triaryl | 0.001-2.5 |
| | | | | | | | | phosphate | |
| 32C5A | 50-99.9 | POE | 0.1-50 | 4 | 2 | 3A | 0.05-2.5 | Triaryl | 0.001-2.5 |
| | | | | | | | | phosphate | |
| 32C5B | 50-99.9 | PVE | 0.1-50 | 4 | 2 | 3A | 0.05-2.5 | Triaryl | 0.001-2.5 |
| | | | | | | | | phosphate | |
| 32C6A | 50-99.9 | POE | 0.1-50 | 4 | 4 | 3A | 0.05-2.5 | NR | NR |
| 32C6B | 50-99.9 | PVE | 0.1-50 | 4 | 4 | 3A | 0.05-2.5 | NR | NR |
| 33B1A | 50-99.9 | POE | 0.1-50 | 4 | 0.1-20 | 3B | 0.05-2.5 | Trialkyl | 0.001-2.5 |
| | | | | | | | | phosphate | |
| 33B1B | 50-99.9 | PVE | 0.1-50 | 4 | 0.1-20 | 3B | 0.05-2.5 | Trialkyl | 0.001-2.5 |
| | | | | | | | | phosphate | |
| 33B2A | 50-99.9 | POE | 0.1-50 | 4 | 1.5-10 | 3B | 0.05-2.5 | Trialkyl | 0.001-2.5 |
| | | | | | | | | phosphate | |
| 33B2B | 50-99.9 | PVE | 0.1-50 | 4 | 1.5-10 | 3B | 0.05-2.5 | Trialkyl | 0.001-2.5 |
| | | | | | | | | phosphate | |
| 33B3A | 50-99.9 | POE | 0.1-50 | 4 | 1.5-8 | 3B | 0.05-2.5 | Trialkyl | 0.001-2.5 |
| | | | | | | | | phosphate | |
| 33B3B | 50-99.9 | PVE | 0.1-50 | 4 | 1.5-8 | 3B | 0.05-2.5 | Trialkyl | 0.001-2.5 |
| | | | | | | | | phosphate | |
| 33B4A | 50-99.9 | POE | 0.1-50 | 4 | 1.5-6 | 3B | 0.05-2.5 | Trialkyl | 0.001-2.5 |
| | | | | | | | | phosphate | |
| 33B4B | 50-99.9 | PVE | 0.1-50 | 4 | 1.5-6 | 3B | 0.05-2.5 | Trialkyl | 0.001-2.5 |
| | | | | | | | | phosphate | |
| 33B5A | 50-99.9 | POE | 0.1-50 | 4 | 2 | 3B | 0.05-2.5 | Trialkyl | 0.001-2.5 |
| | | | | | | | | phosphate | |
| 33B5B | 50-99.9 | PVE | 0.1-50 | 4 | 2 | 3B | 0.05-2.5 | Trialkyl | 0.001-2.5 |
| | | | | | | | | phosphate | |
| 33B6A | 50-99.9 | POE | 0.1-50 | 4 | 4 | 3B | 0.05-2.5 | NR | NR |
| 33B6B | 50-99.9 | PVE | 0.1-50 | 4 | 4 | 3B | 0.05-2.5 | NR | NR |
| 33C1A | 50-99.9 | POE | 0.1-50 | 4 | 0.1-20 | 3B | 0.05-2.5 | Triaryl | 0.001-2.5 |
| | | | | | | | | phosphate | |
| 33C1B | 50-99.9 | PVE | 0.1-50 | 4 | 0.1-20 | 3B | 0.05-2.5 | Triaryl | 0.001-2.5 |
| | | | | | | | | phosphate | |
| 33C2A | 50-99.9 | POE | 0.1-50 | 4 | 1.5-10 | 3B | 0.05-2.5 | Triaryl | 0.001-2.5 |
| | | | | | | | | phosphate | |
| 33C2B | 50-99.9 | PVE | 0.1-50 | 4 | 1.5-10 | 3B | 0.05-2.5 | Triaryl | 0.001-2.5 |
| | | | | | | | | phosphate | |
| 33C3A | 50-99.9 | POE | 0.1-50 | 4 | 1.5-8 | 3B | 0.05-2.5 | Triaryl | 0.001-2.5 |
| | | | | | | | | phosphate | |
| 33C3B | 50-99.9 | PVE | 0.1-50 | 4 | 1.5-8 | 3B | 0.05-2.5 | Triaryl | 0.001-2.5 |
| | | | | | | | | phosphate | |
| 33C4A | 50-99.9 | POE | 0.1-50 | 4 | 1.5-6 | 3B | 0.05-2.5 | Triaryl | 0.001-2.5 |
| | | | | | | | | phosphate | |
| 33C4B | 50-99.9 | PVE | 0.1-50 | 4 | 1.5-6 | 3B | 0.05-2.5 | Triaryl | 0.001-2.5 |
| | | | | | | | | phosphate | |
| 33C5A | 50-99.9 | POE | 0.1-50 | 4 | 2 | 3B | 0.05-2.5 | Triaryl | 0.001-2.5 |
| | | | | | | | | phosphate | |
| 33C5B | 50-99.9 | PVE | 0.1-50 | 4 | 2 | 3B | 0.05-2.5 | Triaryl | 0.001-2.5 |
| | | | | | | | | phosphate | |
| 33C6A | 50-99.9 | POE | 0.1-50 | 4 | 4 | 3B | 0.05-2.5 | NR | NR |
| 33C6B | 50-99.9 | PVE | 0.1-50 | 4 | 4 | 3B | 0.05-2.5 | NR | NR |
| 340B1A | 50-99.9 | POE | 0.1-50 | 4 | 0.1-20 | 3C | 0.05-2.5 | Trialkyl | 0.001-2.5 |
| | | | | | | | | phosphate | |
| 34B1B | 50-99.9 | PVE | 0.1-50 | 4 | 0.1-20 | 3C | 0.05-2.5 | Trialkyl | 0.001-2.5 |
| | | | | | | | | phosphate | |
| 34B2A | 50-99.9 | POE | 0.1-50 | 4 | 1.5-10 | 3C | 0.05-2.5 | Trialkyl | 0.001-2.5 |
| | | | | | | | | phosphate | |
| 34B2B | 50-99.9 | PVE | 0.1-50 | 4 | 1.5-10 | 3C | 0.05-2.5 | Trialkyl | 0.001-2.5 |
| | | | | | | | | phosphate | |
| 34B3A | 50-99.9 | POE | 0.1-50 | 4 | 1.5-8 | 3C | 0.05-2.5 | Trialkyl | 0.001-2.5 |
| | | | | | | | | phosphate | |
| 34B3B | 50-99.9 | PVE | 0.1-50 | 4 | 1.5-8 | 3C | 0.05-2.5 | Trialkyl | 0.001-2.5 |
| | | | | | | | | phosphate | |
| 34B4A | 50-99.9 | POE | 0.1-50 | 4 | 1.5-6 | 3C | 0.05-2.5 | Trialkyl | 0.001-2.5 |
| | | | | | | | | phosphate | |
| 34B4B | 50-99.9 | PVE | 0.1-50 | 4 | 1.5-6 | 3C | 0.05-2.5 | Trialkyl | 0.001-2.5 |
| | | | | | | | | phosphate | |
| 34B5A | 50-99.9 | POE | 0.1-50 | 4 | 2 | 3C | 0.05-2.5 | Trialkyl | 0.001-2.5 |
| | | | | | | | | phosphate | |
| 34B5B | 50-99.9 | PVE | 0.1-50 | 4 | 2 | 3C | 0.05-2.5 | Trialkyl | 0.001-2.5 |
| | | | | | | | | phosphate | |
| 34B6A | 50-99.9 | POE | 0.1-50 | 4 | 4 | 3C | 0.05-2.5 | NR | NR |
| 34B6B | 50-99.9 | PVE | 0.1-50 | 4 | 4 | 3C | 0.05-2.5 | NR | NF |
| 34C1A | 50-99.9 | POE | 0.1-50 | 4 | 0.1-20 | 3C | 0.05-2.5 | Triaryl | 0.001-2.5 |
| | | | | | | | | phosphate | |
| 34C1B | 50-99.9 | PVE | 0.1-50 | 4 | 0.1-20 | 3C | 0.05-2.5 | Triaryl | 0.001-2.5 |
| | | | | | | | | phosphate | |
| 34C2A | 50-99.9 | POE | 0.1-50 | 4 | 1.5-10 | 3C | 0.05-2.5 | Triaryl | 0.001-2.5 |
| | | | | | | | | phosphate | |
| 34C2B | 50-99.9 | PVE | 0.1-50 | 4 | 1.5-10 | 3C | 0.05-2.5 | Triaryl | 0.001-2.5 |
| | | | | | | | | phosphate | |
| 341C3A | 50-99.9 | POE | 0.1-50 | 4 | 1.5-8 | 3C | 0.05-2.5 | Triaryl | 0.001-2.5 |
| | | | | | | | | phosphate | |
| 34C3B | 50-99.9 | PVE | 0.1-50 | 4 | 1.5-8 | 3C | 0.05-2.5 | Triaryl | 0.001-2.5 |
| | | | | | | | | phosphate | |
| 34C4A | 50-99.9 | POE | 0.1-50 | 4 | 1.5-6 | 3C | 0.05-2.5 | Triaryl | 0.001-2.5 |
| | | | | | | | | phosphate | |
| 34C4B | 50-99.9 | PVE | 0.1-50 | 4 | 1.5-6 | 3C | 0.05-2.5 | Triaryl | 0.001-2.5 |
| | | | | | | | | phosphate | |
| 34C5A | 50-99.9 | POE | 0.1-50 | 4 | 2 | 3C | 0.05-2.5 | Triaryl | 0.001-2.5 |
| | | | | | | | | phosphate | |
| 34C5B | 50-99.9 | PVE | 0.1-50 | 4 | 2 | 3C | 0.05-2.5 | Triaryl | 0.001-2.5 |
| | | | | | | | | phosphate | |
| 34C6A | 50-99.9 | POE | 0.1-50 | 4 | 4 | 3C | 0.05-2.5 | NR | NR |
| 34C6B | 50-99.9 | PVE | 0.1-50 | 4 | 4 | 3C | 0.05-2.5 | NR | NR |
| 35B1A | 50-99.9 | POE | 0.1-50 | 4 | 0.1-20 | 4 | 0.05-2.5 | Trialkyl | 0.001-2.5 |
| | | | | | | | | phosphate | |
| 35B1B | 50-99.9 | PVE | 0.1-50 | 4 | 0.1-20 | 4 | 0.05-2.5 | Trialkyl | 0.001-2.5 |
| | | | | | | | | phosphate | |
| 35B2A | 50-99.9 | POE | 0.1-50 | 4 | 1.5-10 | 4 | 0.05-2.5 | Trialkyl | 0.001-2.5 |
| | | | | | | | | phosphate | |
| 35B2B | 50-99.9 | PVE | 0.1-50 | 4 | 1.5-10 | 4 | 0.05-2.5 | Trialkyl | 0.001-2.5 |
| | | | | | | | | phosphate | |
| 35B3A | 50-99.9 | POE | 0.1-50 | 4 | 1.5-8 | 4 | 0.05-2.5 | Trialkyl | 0.001-2.5 |
| | | | | | | | | phosphate | |
| 35B3B | 50-99.9 | PVE | 0.1-50 | 4 | 1.5-8 | 4 | 0.05-2.5 | Trialkyl | 0.001-2.5 |
| | | | | | | | | phosphate | |
| 35B4A | 50-99.9 | POE | 0.1-50 | 4 | 1.5-6 | 4 | 0.05-2.5 | Trialkyl | 0.001-2.5 |
| | | | | | | | | phosphate | |
| 35B4B | 50-99.9 | PVE | 0.1-50 | 4 | 1.5-6 | 4 | 0.05-2.5 | Trialkyl | 0.001-2.5 |
| | | | | | | | | phosphate | |
| 35B5A | 50-99.9 | POE | 0.1-50 | 4 | 2 | 4 | 0.05-2.5 | Trialkyl | 0.001-2.5 |
| | | | | | | | | phosphate | |
| 35B5B | 50-99.9 | PVE | 0.1-50 | 4 | 2 | 4 | 0.05-2.5 | Trialkyl | 0.001-2.5 |
| | | | | | | | | phosphate | |
| 35B6A | 50-99.9 | POE | 0.1-50 | 4 | 4 | 4 | 0.05-2.5 | NR | NR |
| 35B6B | 50-99.9 | PVE | 0.1-50 | 4 | 4 | 4 | 0.05-2.5 | NR | NR |
| 35C1A | 50-99.9 | POE | 0.1-50 | 4 | 0.1-20 | 4 | 0.05-2.5 | Triaryl | 0.001-2.5 |
| | | | | | | | | phosphate | |
| 35C1B | 50-99.9 | PVE | 0.1-50 | 4 | 0.1-20 | 4 | 0.05-2.5 | Triaryl | 0.001-2.5 |
| | | | | | | | | phosphate | |
| 35C2A | 50-99.9 | POE | 0.1-50 | 4 | 1.5-10 | 4 | 0.05-2.5 | Triaryl | 0.001-2.5 |
| | | | | | | | | phosphate | |
| 35C2B | 50-99.9 | PVE | 0.1-50 | 4 | 1.5-10 | 4 | 0.05-2.5 | Triaryl | 0.001-2.5 |
| | | | | | | | | phosphate | |
| 35C3A | 50-99.9 | POE | 0.1-50 | 4 | 1.5-8 | 4 | 0.05-2.5 | Triaryl | 0.001-2.5 |
| | | | | | | | | phosphate | |
| 35C3B | 50-99.9 | PVE | 0.1-50 | 4 | 1.5-8 | 4 | 0.05-2.5 | Triaryl | 0.001-2.5 |
| | | | | | | | | phosphate | |
| 35C4A | 50-99.9 | POE | 0.1-50 | 4 | 1.5-6 | 4 | 0.05-2.5 | Triaryl | 0.001-2.5 |
| | | | | | | | | phosphate | |
| 35C4B | 50-99.9 | PVE | 0.1-50 | 4 | 1.5-6 | 4 | 0.05-2.5 | Triaryl | 0.001-2.5 |
| | | | | | | | | phosphate | |
| 35C5A | 50-99.9 | POE | 0.1-50 | 4 | 2 | 4 | 0.05-2.5 | Triaryl | 0.001-2.5 |
| | | | | | | | | phosphate | |
| 35C5B | 50-99.9 | PVE | 0.1-50 | 4 | 2 | 4 | 0.05-2.5 | Triaryl | 0.001-2.5 |
| | | | | | | | | phosphate | |
| 35C6A | 50-99.9 | POE | 0.1-50 | 4 | 4 | 4 | 0.05-2.5 | NR | NR |
| 35C6B | 50-99.9 | PVE | 0.1-50 | 4 | 4 | 4 | 0.05-2.5 | NR | NR |
| 36B1A | 50-99.9 | POE | 0.1-50 | 4 | 0.1-20 | 5A | 0.05-2.5 | Trialkyl | 0.001-2.5 |
| | | | | | | | | phosphate | |
| 36B1B | 50-99.9 | PVE | 0.1-50 | 4 | 0.1-20 | 5A | 0.05-2.5 | Trialkyl | 0.001-2.5 |
| | | | | | | | | phosphate | |
| 36B2A | 50-99.9 | POE | 0.1-50 | 4 | 1.5-10 | 5A | 0.05-2.5 | Trialkyl | 0.001-2.5 |
| | | | | | | | | phosphate | |
| 36B2B | 50-99.9 | PVE | 0.1-50 | 4 | 1.5-10 | 5A | 0.05-2.5 | Trialkyl | 0.001-2.5 |
| | | | | | | | | phosphate | |
| 36B3A | 50-99.9 | POE | 0.1-50 | 4 | 1.5-8 | 5A | 0.05-2.5 | Trialkyl | 0.001-2.5 |
| | | | | | | | | phosphate | |
| 36B3B | 50-99.9 | PVE | 0.1-50 | 4 | 1.5-8 | 5A | 0.05-2.5 | Trialkyl | 0.001-2.5 |
| | | | | | | | | phosphate | |
| 36B4A | 50-99.9 | POE | 0.1-50 | 4 | 1.5-6 | 5A | 0.05-2.5 | Trialkyl | 0.001-2.5 |
| | | | | | | | | phosphate | |
| 36B4B | 50-99.9 | PVE | 0.1-50 | 4 | 1.5-6 | 5A | 0.05-2.5 | Trialkyl | 0.001-2.5 |
| | | | | | | | | phosphate | |
| 36B5A | 50-99.9 | POE | 0.1-50 | 4 | 2 | 5A | 0.05-2.5 | Trialkyl | 0.001-2.5 |
| | | | | | | | | phosphate | |
| 36B5B | 50-99.9 | PVE | 0.1-50 | 4 | 4 | 5A | 0.05-2.5 | Trialkyl | 0.001-2.5 |
| | | | | | | | | phosphate | |
| 336B6A | 50-99.9 | POE | 0.1-50 | 4 | 4 | 5A | 0.05-2.5 | NR | NR |
| 36B6B | 50-99.9 | PVE | 0.1-50 | 4 | 4 | 5A | 0.05-2.5 | NR | NR |
| 36C1A | 50-99.9 | POE | 0.1-50 | 4 | 0.1-20 | 5A | 0.05-2.5 | Triaryl | 0.001-2.5 |
| | | | | | | | | phosphate | |
| 36C1B | 50-99.9 | PVE | 0.1-50 | 4 | 0.1-20 | 5A | 0.05-2.5 | Triaryl | 0.001-2.5 |
| | | | | | | | | phosphate | |
| 36C2A | 50-99.9 | POE | 0.1-50 | 4 | 1.5-10 | 5A | 0.05-2.5 | Triaryl | 0.001-2.5 |
| | | | | | | | | phosphate | |
| 36C2B | 50-99.9 | PVE | 0.1-50 | 4 | 1.5-10 | 5A | 0.05-2.5 | Triaryl | 0.001-2.5 |
| | | | | | | | | phosphate | |
| 336C3A | 50-99.9 | POE | 0.1-50 | 4 | 1.5-8 | 5A | 0.05-2.5 | Triaryl | 0.001-2.5 |
| | | | | | | | | phosphate | |
| 36C3B | 50-99.9 | PVE | 0.1-50 | 4 | 1.5-8 | 5A | 0.05-2.5 | Triaryl | 0.001-2.5 |
| | | | | | | | | phosphate | |
| 36C4A | 50-99.9 | POE | 0.1-50 | 4 | 1.5-6 | 5A | 0.05-2.5 | Triaryl | 0.001-2.5 |
| | | | | | | | | phosphate | |
| 3364B | 50-99.9 | PVE | 0.1-50 | 4 | 1.5-6 | 5A | 0.05-2.5 | Triaryl | 0.001-2.5 |
| | | | | | | | | phosphate | |
| 36C5A | 50-99.9 | POE | 0.1-50 | 4 | 2 | 5A | 0.05-2.5 | Triaryl | 0.001-2.5 |
| | | | | | | | | phosphate | |
| 36C5B | 50-99.9 | PVE | 0.1-50 | 4 | 2 | 5A | 0.05-2.5 | Triaryl | 0.001-2.5 |
| | | | | | | | | phosphate | |
| 36C6A | 50-99.9 | POE | 0.1-50 | 4 | 4 | 5A | 0.05-2.5 | NR | NR |
| 36C6B | 50-99.9 | PVE | 0.1-50 | 4 | 4 | 5A | 0.05-2.5 | NR | NR |
| 37B1A | 50-99.9 | POE | 0.1-50 | 5 | 0.1-20 | 6 | 0.05-2.5 | Trialkyl | 0.001-2.5 |
| | | | | | | | | phosphate | |
| 37B1B | 50-99.9 | PVE | 0.1-50 | 5 | 0.1-20 | 6 | 0.05-2.5 | Trialkyl | 0.001-2.5 |
| | | | | | | | | phosphate | |
| 37B2A | 50-99.9 | POE | 0.1-50 | 5 | 1.5-10 | 6 | 0.05-2.5 | Trialkyl | 0.001-2.5 |
| | | | | | | | | phosphate | |
| 37B2B | 50-99.9 | PVE | 0.1-50 | 5 | 1.5-10 | 6 | 0.05-2.5 | Trialkyl | 0.001-2.5 |
| | | | | | | | | phosphate | |
| 37B3A | 50-99.9 | POE | 0.1-50 | 5 | 1.5-8 | 6 | 0.05-2.5 | Trialkyl | 0.001-2.5 |
| | | | | | | | | phosphate | |
| 37B3B | 50-99.9 | PVE | 0.1-50 | 5 | 1.5-8 | 6 | 0.05-2.5 | Trialkyl | 0.001-2.5 |
| | | | | | | | | phosphate | |
| 37B4A | 50-99.9 | POE | 0.1-50 | 5 | 1.5-6 | 6 | 0.05-2.5 | Trialkyl | 0.001-2.5 |
| | | | | | | | | phosphate | |
| 37B4B | 50-99.9 | PVE | 0.1-50 | 5 | 1.5-6 | 6 | 0.05-2.5 | Trialkyl | 0.001-2.5 |
| | | | | | | | | phosphate | |
| 37B5A | 50-99.9 | POE | 0.1-50 | 5 | 2 | 6 | 0.05-2.5 | Trialkyl | 0.001-2.5 |
| | | | | | | | | phosphate | |
| 37B5B | 50-99.9 | PVE | 0.1-50 | 5 | 2 | 6 | 0.05-2.5 | Trialkyl | 0.001-2.5 |
| | | | | | | | | phosphate | |
| 37B6A | 50-99.9 | POE | 0.1-50 | 5 | 4 | 6 | 0.05-2.5 | NR | NR |
| 37B6B | 50-99.9 | PVE | 0.1-50 | 5 | 4 | 6 | 0.05-2.5 | NR | NR |
| 37C1A | 50-99.9 | POE | 0.1-50 | 5 | 0.1-20 | 6 | 0.05-2.5 | Triaryl | 0.001-2.5 |
| | | | | | | | | phosphate | |
| 37C1B | 50-99.9 | PVE | 0.1-50 | 5 | 0.1-20 | 6 | 0.05-2.5 | Triaryl | 0.001-2.5 |
| | | | | | | | | phosphate | |
| 37C2A | 50-99.9 | POE | 0.1-50 | 5 | 1.5-10 | 6 | 0.05-2.5 | Triaryl | 0.001-2.5 |
| | | | | | | | | phosphate | |
| 37C2B | 50-99.9 | PVE | 0.1-50 | 5 | 1.5-10 | 6 | 0.05-2.5 | Triaryl | 0.001-2.5 |
| | | | | | | | | phosphate | |
| 37C3A | 50-99.9 | POE | 0.1-50 | 5 | 1.5-8 | 6 | 0.05-2.5 | Triaryl | 0.001-2.5 |
| | | | | | | | | phosphate | |
| 37C3B | 50-99.9 | PVE | 0.1-50 | 5 | 1.5-8 | 6 | 0.05-2.5 | Triaryl | 0.001-2.5 |
| | | | | | | | | phosphate | |
| 37C4A | 50-99.9 | POE | 0.1-50 | 5 | 1.5-6 | 6 | 0.05-2.5 | Triaryl | 0.001-2.5 |
| | | | | | | | | phosphate | |
| 37C4B | 50-99.9 | PVE | 0.1-50 | 5 | 1.5-6 | 6 | 0.05-2.5 | Triaryl | 0.001-2.5 |
| | | | | | | | | phosphate | |
| 37C5A | 50-99.9 | POE | 0.1-50 | 5 | 2 | 6 | 0.05-2.5 | Triaryl | 0.001-2.5 |
| | | | | | | | | phosphate | |
| 37C5B | 50-99.9 | PVE | 0.1-50 | 5 | 2 | 6 | 0.05-2.5 | Triaryl | 0.001-2.5 |
| | | | | | | | | phosphate | |
| 37C6A | 50-99.9 | POE | 0.1-50 | 5 | 4 | 6 | 0.05-2.5 | NR | NR |
| 37C6B | 50-99.9 | PVE | 0.1-50 | 5 | 4 | 6 | 0.05-2.5 | NR | NR |
| 38B1A | 50-99.9 | POE | 0.1-50 | 5 | 0.1-20 | 3A | 0.05-2.5 | Trialkyl | 0.001-2.5 |
| | | | | | | | | phosphate | |
| 38B1B | 50-99.9 | PVE | 0.1-50 | 5 | 0.1-20 | 3A | 0.05-2.5 | Trialkyl | 0.001-2.5 |
| | | | | | | | | phosphate | |
| 38B2A | 50-99.9 | POE | 0.1-50 | 5 | 1.5-10 | 3A | 0.05-2.5 | Trialkyl | 0.001-2.5 |
| | | | | | | | | phosphate | |
| 38B2B | 50-99.9 | PVE | 0.1-50 | 5 | 1.5-10 | 3A | 0.05-2.5 | Trialkyl | 0.001-2.5 |
| | | | | | | | | phosphate | |
| 38B3A | 50-99.9 | POE | 0.1-50 | 5 | 1.5-8 | 3A | 0.05-2.5 | Trialkyl | 0.001-2.5 |
| | | | | | | | | phosphate | |
| 38B3B | 50-99.9 | PVE | 0.1-50 | 5 | 1.5-8 | 3A | 0.05-2.5 | Trialkyl | 0.001-2.5 |
| | | | | | | | | phosphate | |
| 38B4A | 50-99.9 | POE | 0.1-50 | 5 | 1.5-6 | 3A | 0.05-2.5 | Trialkyl | 0.001-2.5 |
| | | | | | | | | phosphate | |
| 38B4B | 50-99.9 | PVE | 0.1-50 | 5 | 1.5-6 | 3A | 0.05-2.5 | Trialkyl | 0.001-2.5 |
| | | | | | | | | phosphate | |
| 38B5A | 50-99.9 | POE | 0.1-50 | 5 | 2 | 3A | 0.05-2.5 | Trialkyl | 0.001-2.5 |
| | | | | | | | | phosphate | |
| 38B5B | 50-99.9 | PVE | 0.1-50 | 5 | 2 | 3A | 0.05-2.5 | Trialkyl | 0.001-2.5 |
| | | | | | | | | phosphate | |
| 38B6A | 50-99.9 | POE | 0.1-50 | 5 | 4 | 3A | 0.05-2.5 | NR | NR |
| 38B6B | 50-99.9 | PVE | 0.1-50 | 5 | 4 | 3A | 0.05-2.5 | NR | NR |
| 38C1A | 50-99.9 | POE | 0.1-50 | 5 | 0.1-20 | 3A | 0.05-2.5 | Triaryl | 0.001-2.5 |
| | | | | | | | | phosphate | |
| 38C1B | 50-99.9 | PVE | 0.1-50 | 5 | 0.1-20 | 3A | 0.05-2.5 | Triaryl | 0.001-2.5 |
| | | | | | | | | phosphate | |
| 38C2A | 50-99.9 | POE | 0.1-50 | 5 | 1.5-10 | 3A | 0.05-2.5 | Triaryl | 0.001-2.5 |
| | | | | | | | | phosphate | |
| 38C2B | 50-99.9 | PVE | 0.1-50 | 5 | 1.5-10 | 3A | 0.05-2.5 | Triaryl | 0.001-2.5 |
| | | | | | | | | phosphate | |
| 38C3A | 50-99.9 | POE | 0.1-50 | 5 | 1.5-8 | 3A | 0.05-2.5 | Triaryl | 0.001-2.5 |
| | | | | | | | | phosphate | |
| 38C3B | 50-99.9 | PVE | 0.1-50 | 5 | 1.5-8 | 3A | 0.05-2.5 | Triaryl | 0.001-2.5 |
| | | | | | | | | phosphate | |
| 38C4A | 50-99.9 | POE | 0.1-50 | 5 | 1.5-6 | 3A | 0.05-2.5 | Triaryl | 0.001-2.5 |
| | | | | | | | | phosphate | |
| 38C4B | 50-99.9 | PVE | 0.1-50 | 5 | 1.5-6 | 3A | 0.05-2.5 | Triaryl | 0.001-2.5 |
| | | | | | | | | phosphate | |
| 38C5A | 50-99.9 | POE | 0.1-50 | 5 | 2 | 3A | 0.05-2.5 | Triaryl | 0.001-2.5 |
| | | | | | | | | phosphate | |
| 38C5B | 50-99.9 | PVE | 0.1-50 | 5 | 2 | 3A | 0.05-2.5 | Triaryl | 0.001-2.5 |
| | | | | | | | | phosphate | |
| 38C6A | 50-99.9 | POE | 0.1-50 | 5 | 4 | 3A | 0.05-2.5 | NR | NR |
| 38C6B | 50-99.9 | PVE | 0.1-50 | 5 | 4 | 3A | 0.05-2.5 | NR | NR |
| 58B1A | 50-99.9 | POE | 0.1-50 | 5 | 0.1-20 | 4 | 0.05-2.5 | Trialkyl | 0.001-2.5 |
| | | | | | | | | phosphate | |
| 58B1B | 50-99.9 | PVE | 0.1-50 | 5 | 0.1-20 | 4 | 0.05-2.5 | Trialkyl | 0.001-2.5 |
| | | | | | | | | phosphate | |
| 58B2A | 50-99.9 | POE | 0.1-50 | 5 | 1.5-10 | 4 | 0.05-2.5 | Trialkyl | 0.001-2.5 |
| | | | | | | | | phosphate | |
| 58B2B | 50-99.9 | PVE | 0.1-50 | 5 | 1.5-10 | 4 | 0.05-2.5 | Trialkyl | 0.001-2.5 |
| | | | | | | | | phosphate | |
| 58B3A | 50-99.9 | POE | 0.1-50 | 5 | 1.5-8 | 4 | 0.05-2.5 | Trialkyl | 0.001-2.5 |
| | | | | | | | | phosphate | |
| 58B3B | 50-99.9 | PVE | 0.1-50 | 5 | 1.5-8 | 4 | 0.05-2.5 | Trialkyl | 0.001-2.5 |
| | | | | | | | | phosphate | |
| 58B4A | 50-99.9 | POE | 0.1-50 | 5 | 1.5-6 | 4 | 0.05-2.5 | Trialkyl | 0.001-2.5 |
| | | | | | | | | phosphate | |
| 58B4B | 50-99.9 | PVE | 0.1-50 | 5 | 1.5-6 | 4 | 0.05-2.5 | Trialkyl | 0.001-2.5 |
| | | | | | | | | phosphate | |
| 58B5A | 50-99.9 | POE | 0.1-50 | 5 | 2 | 4 | 0.05-2.5 | Trialkyl | 0.001-2.5 |
| | | | | | | | | phosphate | |
| 58B5B | 50-99.9 | PVE | 0.1-50 | 5 | 2 | 4 | 0.05-2.5 | Trialkyl | 0.001-2.5 |
| | | | | | | | | phosphate | |
| 58B6A | 50-99.9 | POE | 0.1-50 | 5 | 4 | 4 | 0.05-2.5 | NR | NR |
| 58B6B | 50-99.9 | PVE | 0.1-50 | 5 | 4 | 4 | 0.05-2.5 | NR | NR |
| 58C1A | 50-99.9 | POE | 0.1-50 | 5 | 0.1-20 | 4 | 0.05-2.5 | Triaryl | 0.001-2.5 |
| | | | | | | | | phosphate | |
| 58C1B | 50-99.9 | PVE | 0.1-50 | 5 | 0.1-20 | 4 | 0.05-2.5 | Triaryl | 0.001-2.5 |
| | | | | | | | | phosphate | |
| 58C2A | 50-99.9 | POE | 0.1-50 | 5 | 1.5-10 | 4 | 0.05-2.5 | Triaryl | 0.001-2.5 |
| | | | | | | | | phosphate | |
| 58C2B | 50-99.9 | PVE | 0.1-50 | 5 | 1.5-10 | 4 | 0.05-2.5 | Triaryl | 0.001-2.5 |
| | | | | | | | | phosphate | |
| 58C3A | 50-99.9 | POE | 0.1-50 | 5 | 1.5-8 | 4 | 0.05-2.5 | Triaryl | 0.001-2.5 |
| | | | | | | | | phosphate | |
| 58C3B | 50-99.9 | PVE | 0.1-50 | 5 | 1.5-8 | 4 | 0.05-2.5 | Triaryl | 0.001-2.5 |
| | | | | | | | | phosphate | |
| 58C4A | 50-99.9 | POE | 0.1-50 | 5 | 1.5-6 | 4 | 0.05-2.5 | Triaryl | 0.001-2.5 |
| | | | | | | | | phosphate | |
| 58C4B | 50-99.9 | PVE | 0.1-50 | 5 | 1.5-6 | 4 | 0.05-2.5 | Triaryl | 0.001-2.5 |
| | | | | | | | | phosphate | |
| 58C5A | 50-99.9 | POE | 0.1-50 | 5 | 2 | 4 | 0.05-2.5 | Triaryl | 0.001-2.5 |
| | | | | | | | | phosphate | |
| 58C5B | 50-99.9 | PVE | 0.1-50 | 5 | 2 | 4 | 0.05-2.5 | Triaryl | 0.001-2.5 |
| | | | | | | | | phosphate | |
| 58C6A | 50-99.9 | POE | 0.1-50 | 5 | 4 | 4 | 0.05-2.5 | NR | NR |
| 58C6B | 50-99.9 | PVE | 0.1-50 | 5 | 4 | 4 | 0.05-2.5 | NR | NR |
| 59B1A | 50-99.9 | POE | 0.1-50 | 5 | 0.1-20 | 5A | 0.05-2.5 | Trialkyl | 0.001-2.5 |
| | | | | | | | | phosphate | |
| 59B1B | 50-99.9 | PVE | 0.1-50 | 5 | 0.1-20 | 5A | 0.05-2.5 | Trialkyl | 0.001-2.5 |
| | | | | | | | | phosphate | |
| 591 B2A | 50-99.9 | POE | 0.1-50 | 5 | 1.5-10 | 5A | 0.05-2.5 | Trialkyl | 0.001-2.5 |
| | | | | | | | | phosphate | |
| 59B2B | 50-99.9 | PVE | 0.1-50 | 5 | 1.5-10 | 5A | 0.05-2.5 | Trialkyl | 0.001-2.5 |
| | | | | | | | | phosphate | |
| 59B3A | 50-99.9 | POE | 0.1-50 | 5 | 1.5-8 | 5A | 0.05-2.5 | Trialkyl | 0.001-2.5 |
| | | | | | | | | phosphate | |
| 59B3B | 50-99.9 | PVE | 0.1-50 | 5 | 1.5-8 | 5A | 0.05-2.5 | Trialkyl | 0.001-2.5 |
| | | | | | | | | phosphate | |
| 59B4A | 50-99.9 | POE | 0.1-50 | 5 | 1.5-6 | 5A | 0.05-2.5 | Trialkyl | 0.001-2.5 |
| | | | | | | | | phosphate | |
| 59B4B | 50-99.9 | PVE | 0.1-50 | 5 | 1.5-6 | 5A | 0.05-2.5 | Trialkyl | 0.001-2.5 |
| | | | | | | | | phosphate | |
| 59B5A | 50-99.9 | POE | 0.1-50 | 5 | 2 | 5A | 0.05-2.5 | Trialkyl | 0.001-2.5 |
| | | | | | | | | phosphate | |
| 59B5B | 50-99.9 | PVE | 0.1-50 | 5 | 2 | 5A | 0.05-2.5 | Trialkyl | 0.001-2.5 |
| | | | | | | | | phosphate | |
| 59B6A | 50-99.9 | POE | 0.1-50 | 5 | 4 | 5A | 0.05-2.5 | NR | NR |
| 59B6B | 50-99.9 | PVE | 0.1-50 | 5 | 4 | 5A | 0.05-2.5 | NR | NR |
| 59C1A | 50-99.9 | POE | 0.1-50 | 5 | 0.1-20 | 5A | 0.05-2.5 | Triaryl | 0.001-2.5 |
| | | | | | | | | phosphate | |
| 59C1B | 50-99.9 | PVE | 0.1-50 | 5 | 0.1-20 | 5A | 0.05-2.5 | Triaryl | 0.001-2.5 |
| | | | | | | | | phosphate | |
| 59C2A | 50-99.9 | POE | 0.1-50 | 5 | 1.5-10 | 5A | 0.05-2.5 | Triaryl | 0.001-2.5 |
| | | | | | | | | phosphate | |
| 59C2B | 50-99.9 | PVE | 0.1-50 | 5 | 1.5-10 | 5A | 0.05-2.5 | Triaryl | 0.001-2.5 |
| | | | | | | | | phosphate | |
| 59C3A | 50-99.9 | POE | 0.1-50 | 5 | 1.5-8 | 5A | 0.05-2.5 | Triaryl | 0.001- |
| | | | | | | | | phosphate | 2.5 |
| 59C3B | 50-99.9 | PVE | 0.1-50 | 5 | 1.5-8 | 5A | 0.05-2.5 | Triaryl | 0.001-2.5 |
| | | | | | | | | phosphate | |
| 59C4A | 50-99.9 | POE | 0.1-50 | 5 | 1.5-6 | 5A | 0.05-2.5 | Triaryl | 0.001-2.5 |
| | | | | | | | | phosphate | |
| 59C4B | 50-99.9 | PVE | 0.1-50 | 5 | 1.5-6 | 5A | 0.05-2.5 | Triaryl | 0.001-2.5 |
| | | | | | | | | phosphate | |
| 59C5A | 50-99.9 | POE | 0.1-50 | 5 | 2 | 5A | 0.05-2.5 | Triaryl | 0.001-2.5 |
| | | | | | | | | phosphate | |
| 59C5B | 50-99.9 | PVE | 0.1-50 | 5 | 2 | 5A | 0.05-2.5 | Triaryl | 0.001-2.5 |
| | | | | | | | | phosphate | |
| 59C6A | 50-99.9 | POE | 0.1-50 | 5 | 4 | 5A | 0.05-2.5 | NR | NR |
| 59C6B | 50-99.9 | PVE | 0.1-50 | 5 | 4 | 5A | 0.05-2.5 | NR | NR |
| 60B1A | 50-99.9 | POE | 0.1-50 | 5 | 0.1-20 | 6 | 0.05-2.5 | Trialkyl | 0.001-2.5 |
| | | | | | | | | phosphate | |
| 60B1B | 50-99.9 | PVE | 0.1-50 | 5 | 0.1-20 | 6 | 0.05-2.5 | Trialkyl | 0.001-2.5 |
| | | | | | | | | phosphate | |
| 60B2A | 50-99.9 | POE | 0.1-50 | 5 | 1.5-10 | 6 | 0.05-2.5 | Trialkyl | 0.001-2.5 |
| | | | | | | | | phosphate | |
| 60B2B | 50-99.9 | PVE | 0.1-50 | 5 | 1.5-10 | 6 | 0.05-2.5 | Trialkyl | 0.001-2.5 |
| | | | | | | | | phosphate | |
| 60B3A | 50-99.9 | POE | 0.1-50 | 5 | 1.5-8 | 6 | 0.05-2.5 | Trialkyl | 0.001-2.5 |
| | | | | | | | | phosphate | |
| 60B3B | 50-99.9 | PVE | 0.1-50 | 5 | 1.5-8 | 6 | 0.05-2.5 | Trialkyl | 0.001-2.5 |
| | | | | | | | | phosphate | |
| 60B4A | 50-99.9 | POE | 0.1-50 | 5 | 1.5-6 | 6 | 0.05-2.5 | Trialkyl | 0.001-2.5 |
| | | | | | | | | phosphate | |
| 60B4B | 50-99.9 | PVE | 0.1-50 | 5 | 1.5-6 | 6 | 0.05-2.5 | Trialkyl | 0.001-2.5 |
| | | | | | | | | phosphate | |
| 60B5A | 50-99.9 | POE | 0.1-50 | 5 | 2 | 6 | 0.05-2.5 | Trialkyl | 0.001-2.5 |
| | | | | | | | | phosphate | |
| 60B5B | 50-99.9 | PVE | 0.1-50 | 5 | 2 | 6 | 0.05-2.5 | Trialkyl | 0.001-2.5 |
| | | | | | | | | phosphate | |
| 60B6A | 50-99.9 | POE | 0.1-50 | 5 | 4 | 6 | 0.05-2.5 | NR | NR |
| 60B6B | 50-99.9 | PVE | 0.1-50 | 5 | 4 | 6 | 0.05-2.5 | NR | NR |
| 60C1A | 50-99.9 | POE | 0.1-50 | 5 | 0.1-20 | 6 | 0.05-2.5 | Triaryl | 0.001-2.5 |
| 60C1B | 50-99.9 | PVE | 0.1-50 | 5 | 0.1-20 | 6 | 0.05-2.5 | Triaryl | 0.001-2.5 |
| | | | | | | | | phosphate | |
| 60C2A | 50-99.9 | POE | 0.1-50 | 5 | 1.5-10 | 6 | 0.05-2.5 | Triaryl | 0.001-2.5 |
| | | | | | | | | phosphate | |
| 60C2B | 50-99.9 | PVE | 0.1-50 | 5 | 1.5-10 | 6 | 0.05-2.5 | Triaryl | 0.001-2.5 |
| | | | | | | | | phosphate | |
| 60C3A | 50-99.9 | POE | 0.1-50 | 5 | 1.5-8 | 6 | 0.05-2.5 | Triaryl | 0.001-2.5 |
| | | | | | | | | phosphate | |
| 60C3B | 50-99.9 | PVE | 0.1-50 | 5 | 1.5-8 | 6 | 0.05-2.5 | Triaryl | 0.001-2.5 |
| | | | | | | | | phosphate | |
| 60C4A | 50-99.9 | POE | 0.1-50 | 5 | 1.5-6 | 6 | 0.05-2.5 | Triaryl | 0.001-2.5 |
| | | | | | | | | phosphate | |
| 60C4B | 50-99.9 | PVE | 0.1-50 | 5 | 1.5-6 | 6 | 0.05-2.5 | Triaryl | 0.001-2.5 |
| | | | | | | | | phosphate | |
| 60C5A | 50-99.9 | POE | 0.1-50 | 5 | 2 | 6 | 0.05-2.5 | Triaryl | 0.001-2.5 |
| | | | | | | | | phosphate | |
| 60C5B | 50-99.9 | PVE | 0.1-50 | 5 | 2 | 6 | 0.05-2.5 | Triaryl | 0.001-2.5 |
| | | | | | | | | phosphate | |
| 60C6A | 50-99.9 | POE | 0.1-50 | 5 | 4 | 6 | 0.05-2.5 | NR | NR |
| 60C6B | 50-99.9 | PVE | 0.1-50 | 5 | 4 | 6 | 0.05-2.5 | NR | NR |
| 63B1A | 50-99.9 | POE | 0.1-50 | 10 | 0.1-20 | 4 | 0.05-2.5 | Trialkyl | 0.001-2.5 |
| | | | | | | | | phosphate | |
| 63B1B | 50-99.9 | PVE | 0.1-50 | 10 | 0.1-20 | 4 | 0.05-2.5 | Trialkyl | 0.001-2.5 |
| | | | | | | | | phosphate | |
| 63B2A | 50-99.9 | POE | 0.1-50 | 10 | 1.5-10 | 4 | 0.05-2.5 | Trialkyl | 0.001-2.5 |
| | | | | | | | | phosphate | |
| 63B2B | 50-99.9 | PVE | 0.1-50 | 10 | 1.5-10 | 4 | 0.05-2.5 | Trialkyl | 0.001-2.5 |
| | | | | | | | | phosphate | |
| 63B3A | 50-99.9 | POE | 0.1-50 | 10 | 1.5-8 | 4 | 0.05-2.5 | Trialkyl | 0.001-2.5 |
| | | | | | | | | phosphate | |
| 63B3B | 50-99.9 | PVE | 0.1-50 | 10 | 1.5-8 | 4 | 0.05-2.5 | Trialkyl | 0.001-2.5 |
| | | | | | | | | phosphate | |
| 63B4A | 50-99.9 | POE | 0.1-50 | 10 | 1.5-6 | 4 | 0.05-2.5 | Trialkyl | 0.001-2.5 |
| | | | | | | | | phosphate | |
| 63B4B | 50-99.9 | PVE | 0.1-50 | 10 | 1.5-6 | 4 | 0.05-2.5 | Trialkyl | 0.001-2.5 |
| | | | | | | | | phosphate | |
| 63B5A | 50-99.9 | POE | 0.1-50 | 10 | 2 | 4 | 0.05-2.5 | Trialkyl | 0.001-2.5 |
| | | | | | | | | phosphate | |
| 63B5B | 50-99.9 | PVE | 0.1-50 | 10 | 2 | 4 | 0.05-2.5 | Trialkyl | 0.001-2.5 |
| | | | | | | | | phosphate | |
| 63B6A | 50-99.9 | POE | 0.1-50 | 10 | 4 | 4 | 0.05-2.5 | NR | NR |
| 63B6B | 50-99.9 | PVE | 0.1-50 | 10 | 4 | 4 | 0.05-2.5 | NR | NR |
| 63C1A | 50-99.9 | POE | 0.1-50 | 10 | 0.1-20 | 4 | 0.05-2.5 | Triaryl | 0.001-2.5 |
| | | | | | | | | phosphate | |
| 63C1B | 50-99.9 | PVE | 0.1-50 | 10 | 0.1-20 | 4 | 0.05-2.5 | Triaryl | 0.001-2.5 |
| | | | | | | | | phosphate | |
| 63C2A | 50-99.9 | POE | 0.1-50 | 10 | 1.5-10 | 4 | 0.05-2.5 | Triaryl | 0.001-2.5 |
| | | | | | | | | phosphate | |
| 63C2B | 50-99.9 | PVE | 0.1-50 | 10 | 1.5-10 | 4 | 0.05-2.5 | Triaryl | 0.001-2.5 |
| | | | | | | | | phosphate | |
| 63C3A | 50-99.9 | POE | 0.1-50 | 10 | 1.5-8 | 4 | 0.05-2.5 | Triaryl | 0.001-2.5 |
| | | | | | | | | phosphate | |
| 63C3B | 50-99.9 | PVE | 0.1-50 | 10 | 1.5-8 | 4 | 0.05-2.5 | Triaryl | 0.001-2.5 |
| | | | | | | | | phosphate | |
| 63C4A | 50-99.9 | POE | 0.1-50 | 10 | 1.5-6 | 4 | 0.05-2.5 | Triaryl | 0.001-2.5 |
| | | | | | | | | phosphate | |
| 63C4B | 50-99.9 | PVE | 0.1-50 | 10 | 1.5-6 | 4 | 0.05-2.5 | Triaryl | 0.001-2.5 |
| | | | | | | | | phosphate | |
| 63C5A | 50-99.9 | POE | 0.1-50 | 10 | 2 | 4 | 0.05-2.5 | Triaryl | 0.001-2.5 |
| | | | | | | | | phosphate | |
| 63C5B | 50-99.9 | PVE | 0.1-50 | 10 | 2 | 4 | 0.05-2.5 | Triaryl | 0.001-2.5 |
| | | | | | | | | phosphate | |
| 63C6A | 50-99.9 | POE | 0.1-50 | 10 | 4 | 4 | 0.05-2.5 | NR | NR |
| 63C6B | 50-99.9 | PVE | 0.1-50 | 10 | 4 | 4 | 0.05-2.5 | NR | NR |
| 77B1A | 50-99.9 | POE | 0.1-50 | 10 | 0.1-20 | 6 | 0.05-2.5 | Trialkyl | 0.001-2.5 |
| | | | | | | | | phosphate | |
| 77B1B | 50-99.9 | PVE | 0.1-50 | 10 | 0.1- | 6 | 0.05-2.5 | Trialkyl | 0.001-2.5 |
| | | | | | 20 | | | phosphate | |
| 77B2A | 50-99.9 | POE | 0.1-50 | 10 | 1.5-10 | 6 | 0.05-2.5 | Trialkyl | 0.001-2.5 |
| | | | | | | | | phosphate | |
| 77B2B | 50-99.9 | PVE | 0.1-50 | 10 | 1.5-10 | 6 | 0.05-2.5 | Trialkyl | 0.001-2.5 |
| | | | | | | | | phosphate | |
| 77B3A | 50-99.9 | POE | 0.1-50 | 10 | 1.5-8 | 6 | 0.05-2.5 | Trialkyl | 0.001-2.5 |
| | | | | | | | | phosphate | |
| 77B3B | 50-99.9 | PVE | 0.1-50 | 10 | 1.5-8 | 6 | 0.05-2.5 | Trialkyl | 0.001-2.5 |
| | | | | | | | | phosphate | |
| 77B4A | 50-99.9 | POE | 0.1-50 | 10 | 1.5-6 | 6 | 0.05-2.5 | Trialkyl | 0.001-2.5 |
| | | | | | | | | phosphate | |
| 77B4B | 50-99.9 | PVE | 0.1-50 | 10 | 1.5-6 | 6 | 0.05-2.5 | Trialkyl | 0.001-2.5 |
| | | | | | | | | phosphate | |
| 77B5A | 50-99.9 | POE | 0.1-50 | 10 | 2 | 6 | 0.05-2.5 | Trialkyl | 0.001-2.5 |
| | | | | | | | | phosphate | |
| 77B5B | 50-99.9 | PVE | 0.1-50 | 10 | 2 | 6 | 0.05-2.5 | Trialkyl | 0.001-2.5 |
| | | | | | | | | phosphate | |
| 77B6A | 50-99.9 | POE | 0.1-50 | 10 | 4 | 6 | 0.05-2.5 | NR | NR |
| 77B6B | 50-99.9 | PVE | 0.1-50 | 10 | 4 | 6 | 0.05-2.5 | NR | NR |
| 77C1A | 50-99.9 | POE | 0.1-50 | 10 | 0.1-20 | 6 | 0.05-2.5 | Triaryl | 0.001-2.5 |
| | | | | | | | | phosphate | |
| 77C1B | 50-99.9 | PVE | 0.1-50 | 10 | 0.1-20 | 6 | 0.05-2.5 | Triaryl | 0.001-2.5 |
| | | | | | | | | phosphate | |
| 77C2A | 50-99.9 | POE | 0.1-50 | 10 | 1.5-10 | 6 | 0.05-2.5 | Triaryl | 0.001-2.5 |
| | | | | | | | | phosphate | |
| 77C2B | 50-99.9 | PVE | 0.1-50 | 10 | 1.5-10 | 6 | 0.05-2.5 | Triaryl | 0.001-2.5 |
| | | | | | | | | phosphate | |
| 77C3A | 50-99.9 | POE | 0.1-50 | 10 | 1.5-8 | 6 | 0.05-2.5 | Triaryl | 0.001-2.5 |
| | | | | | | | | phosphate | |
| 77C3B | 50-99.9 | PVE | 0.1-50 | 10 | 1.5-8 | 6 | 0.05-2.5 | Triaryl | 0.001-2.5 |
| | | | | | | | | phosphate | |
| 77C4A | 50-99.9 | POE | 0.1-50 | 10 | 1.5-6 | 6 | 0.05-2.5 | Triaryl | 0.001-2.5 |
| | | | | | | | | phosphate | |
| 77C4B | 50-99.9 | PVE | 0.1-50 | 10 | 1.5-6 | 6 | 0.05-2.5 | Triaryl | 0.001-2.5 |
| | | | | | | | | phosphate | |
| 77C5A | 50-99.9 | POE | 0.1-50 | 10 | 2 | 6 | 0.05-2.5 | Triaryl | 0.001-2.5 |
| | | | | | | | | phosphate | |
| 77C5B | 50-99.9 | PVE | 0.1-50 | 10 | 2 | 6 | 0.05-2.5 | Triaryl | 0.001-2.5 |
| | | | | | | | | phosphate | |
| 77C6A | 50-99.9 | POE | 0.1-50 | 10 | 4 | 6 | 0.05-2.5 | NR | NR |
| 77C6B | 50-99.9 | PVE | 0.1-50 | 10 | 4 | 6 | 0.05-2.5 | NR | NR |

### Methods, Uses and Systems

The heat transfer compositions disclosed herein, including each of Heat Transfer Compositions 1-109, are provided for use in heat transfer applications, including air conditioning applications, with highly preferred air conditioning applications including residential air conditioning, commercial air conditioning applications (such as roof top applications, VRF applications and chillers).

The present invention also includes methods for providing heat transfer including methods of refrigeration, including low and medium temperature refrigeration, air conditioning, with highly preferred air conditioning methods including providing residential air conditioning, providing commercial air conditioning (such as methods of providing roof top air conditioning, methods of providing VRF air conditioning and methods of providing air conditioning using chillers), wherein the methods use heat transfer compositions of the present invention, including each of Heat Transfer Compositions 1-109.

The present invention also includes heat transfer systems, including refrigeration, including low and medium temperature refrigeration, air conditioning systems, with highly preferred air conditioning systems including residential air conditioning, commercial air conditioning systems (such as roof top air conditioning systems, VRF air conditioning systems and air conditioning chiller systems), wherein the methods use heat transfer compositions of the present invention, including each of Heat Transfer Compositions 1-109.

The invention also provides uses of the heat transfer compositions, including each of Heat Transfer Compositions 1-109, methods using the heat transfer compositions and systems containing the heat transfer compositions in connection with refrigeration, heat pumps and chillers (including portable water chillers and central water chillers.

Any reference to the heat transfer composition of the invention refers to each and any of the heat transfer compositions as described herein. Thus, for the following discussion of the uses, methods, systems or applications of the composition of the invention, the heat transfer composition may comprise or consist essentially of any of Heat Transfer Compositions 1-109.

For heat transfer systems of the present invention that include a compressor and lubricant for the compressor in the system, the system can comprises a loading of refrigerant and lubricant such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

The heat transfer systems according to the present invention can comprise a compressor, an evaporator, a condenser and an expansion device, in fluid communication with each other, a Heat Transfer Compositions 1-109 and a sequestration material in the system, wherein said sequestration material preferably comprises: i. copper or a copper alloy, or ii. activated alumina, or iii. a zeolite molecular sieve comprising copper, silver, lead or a combination thereof, or iv. an anion exchange resin, or v. a moisture-removing material, preferably a moisture-removing molecular sieve, or vi. a combination of two or more of the above.

The present invention also includes methods for transferring heat of the type comprising evaporating refrigerant liquid to produce a refrigerant vapor, compressing in a compressor at least a portion of the refrigerant vapor and condensing refrigerant vapor in a plurality of repeating cycles, said method comprising:
(a) providing a heat transfer composition according to the present invention, including each of Heat Transfer Compositions 1-109;
(b) optionally but preferably providing lubricant for said compressor; and
(b) exposing at least a portion of said refrigerant and/or at least a portion of said lubricant to a sequestration material.

### Uses, Equipment and Systems

The present invention includes the use of heat transfer compositions of the present invention, including each of Heat Transfer Compositions 1-109, in a residential air conditioning system.

The present invention includes the use of heat transfer compositions of the present invention, including each of Heat Transfer Compositions 1-109, in a chiller system.

Examples of commonly used compressors, for the purposes of this invention include reciprocating, rotary (including rolling piston and rotary vane), scroll, screw, and centrifugal compressors. Thus, the present invention provides each and any of the refrigerants and/or heat transfer compositions as described herein for use in a heat transfer system comprising a reciprocating, rotary (including rolling piston and rotary vane), scroll, screw, or centrifugal compressor.

Examples of commonly used expansion devices, for the purposes of this invention include a capillary tube, a fixed orifice, a thermal expansion valve and an electronic expansion valve. Thus, the present invention provides each and any of the refrigerants and/or heat transfer compositions as described herein for use in a heat transfer system comprising a capillary tube, a fixed orifice, a thermal expansion valve or an electronic expansion valve.

For the purposes of this invention, the evaporator and the condenser can each be in the form of a heat exchanger, preferably selected from a finned tube heat exchanger, a microchannel heat exchanger, a shell and tube, a plate heat exchanger, and a tube-in-tube heat exchanger. Thus, the present invention provides each and any of the refrigerants and/or heat transfer compositions as described herein for use in a heat transfer system wherein the evaporator and condenser together form a finned tube heat exchanger, a microchannel heat exchanger, a shell and tube, a plate heat exchanger, or a tube-in-tube heat exchanger.

The systems of the present invention thus preferably include a sequestration material in contact with at least a portion of a refrigerant and/or at least a portion of a the lubricant according to the present invention wherein the temperature of said sequestration material and/or the temperature of said refrigerant and/or the temperature of said lubricant when in said contact are at a temperature that is preferably at least about 10° C. wherein the sequestration material preferably comprises a combination of: an anion exchange resin, activated alumina, a zeolite molecular sieve comprising silver, and a moisture-removing material, preferably a moisture-removing molecular sieve.

As used in this application, the term “in contact with at least a portion” is intended in its broad sense to include each of said sequestration materials and any combination of sequestration materials being in contact with the same or separate portions of the refrigerant and/or the lubricant in the system and is intended to include but not necessarily limited to embodiments in which each type or specific sequestration material is: (i) located physically together with each other type or specific material, if present; (ii) is located physically separate from each other type or specific material, if present, and (iii) combinations in which two or more materials are physically together and at least one sequestration material is physically separate from at least one other sequestration material.

The heat transfer composition of the invention can be used in heating and cooling applications.

In a particular feature of the invention, the heat transfer composition can be used in a method of cooling comprising condensing a heat transfer composition and subsequently evaporating said composition in the vicinity of an article or body to be cooled.

Thus, the invention relates to a method of cooling in a heat transfer system comprising an evaporator, a condenser and a compressor, the process comprising i) condensing a heat transfer composition as described herein; and
ii) evaporating the composition in the vicinity of body or article to be cooled; wherein the evaporator temperature of the heat transfer system is in the range of from about −40° C. to about +10° C.

Alternatively, or in addition, the heat transfer composition can be used in a method of heating comprising condensing the heat transfer composition in the vicinity of an article or body to be heated and subsequently evaporating said composition.

Thus, the invention relates to a method of heating in a heat transfer system comprising an evaporator, a condenser and a compressor, the process comprising i) condensing a heat transfer composition as described herein, in the vicinity of a body or article to be heated and
ii) evaporating the composition; wherein the evaporator temperature of the heat transfer system is in the range of about −30° C. to about 5° C.

The heat transfer composition of the invention is provided for use in air conditioning applications including both transport and stationary air conditioning applications. Thus, any of the heat transfer compositions described herein can be used in any one of:
an air conditioning application including mobile air conditioning, particularly in trains and buses conditioning,
a mobile heat pump, particularly an electric vehicle heat pump;
a chiller, particularly a positive displacement chiller, more particularly an air cooled or water-cooled direct expansion chiller, which is either modular or conventionally singularly packaged,
a residential air conditioning system, particularly a ducted split or a ductless split air conditioning system,
a residential heat pump,
a residential air to water heat pump/hydronic system,
an industrial air conditioning system,
a commercial air conditioning system, particularly a packaged rooftop unit and a variable refrigerant flow (VRF) system and
a commercial air source, water source or ground source heat pump system.

The heat transfer composition of the invention is provided for use in a refrigeration system. The term “refrigeration system” refers to any system or apparatus or any part or portion of such a system or apparatus which employs a refrigerant to provide cooling. Thus, any of the heat transfer compositions described herein can be used in any one of:
a low temperature refrigeration system,
a medium temperature refrigeration system,
a commercial refrigerator,
a commercial freezer,
an ice machine,
a vending machine,
a transport refrigeration system,
a domestic freezer,
a domestic refrigerator,
an industrial freezer,
an industrial refrigerator and
a chiller.

Each of the heat transfer compositions described herein, including Heat Transfer Compositions 1-109, is particularly provided for use in a residential air-conditioning system (with an evaporator temperature in the range of about 0 to about 10° C., particularly about 7° C. for cooling and/or in the range of about −20 to about 3° C., particularly about 0.5° C. for heating). Alternatively, or additionally, each of the heat transfer compositions described herein, including each of Heat Transfer Compositions 1-109, is particularly provided for use in a residential air conditioning system with a reciprocating, rotary (rolling-piston or rotary vane) or scroll compressor.

Each of the heat transfer compositions described, including Heat Transfer Compositions 1-109, is particularly provided for use in an air-cooled chiller (with an evaporator temperature in the range of about 0 to about 10° C., particularly about 4.5° C.), particularly an air-cooled chiller with a positive displacement compressor, more particular an air-cooled chiller with a reciprocating scroll compressor.

Each of the heat transfer compositions described herein, including Heat Transfer Compositions 1-109, is particularly provided for use in a residential air to water heat pump hydronic system (with an evaporator temperature in the range of about −20 to about 3° C., particularly about 0.5° C. or with an evaporator temperature in the range of about −30 to about 5° C., particularly about 0.5° C.).

Each of the heat transfer compositions described herein, including Heat Transfer Compositions 1-109, is particularly provided for use in a medium temperature refrigeration system (with an evaporator temperature in the range of about −12 to about 0° C., particularly about −8° C.).

Each of the heat transfer compositions described herein, including Heat Transfer Compositions 1-109, is particularly provided for use in a low temperature refrigeration system (with an evaporator temperature in the range of about −40 to about −12° C., particularly about from about −40° C. to about −23° C. or preferably about −32° C.).

The heat transfer composition of the invention, including Heat Transfer Compositions 1-109, is provided for use in a residential air conditioning system, wherein the residential air-conditioning system is used to supply cool air (said air having a temperature of for example, about 10° C. to about 17° C., particularly about 12° C.) to buildings for example, in the summer.

The heat transfer composition of the invention, including Heat Transfer Compositions 1-109, is thus provided for use in a split residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-109, is thus provided for use in a ducted split residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-109, is thus provided for use in a window residential air conditioning system, wherein the residential air-conditioning system is used to supply cool air (said air having a temperature of for example, about 10° C. to about 17° C., particularly about 12° C.).

The heat transfer composition of the invention, including Heat Transfer Compositions 1-109 is thus provided for use in a portable residential air conditioning system, wherein the residential air-conditioning system is used to supply cool air (said air having a temperature of for example, about 10° C. to about 17° C., particularly about 12° C.).

The residential air conditions systems as described herein, including in the immediately preceding paragraphs, preferably have an air-to-refrigerant evaporator (indoor coil), a compressor, an air-to-refrigerant condenser (outdoor coil), and an expansion valve. The evaporator and condenser can be round tube plate fin, a finned tube or microchannel heat exchanger. The compressor can be a reciprocating or rotary (rolling-piston or rotary vane) or scroll compressor. The expansion valve can be a capillary tube, thermal or electronic expansion valve. The refrigerant evaporating temperature is preferably in the range of 0° C. to 10° C. The condensing temperature is preferably in the range of 40° C. to 70° C.

The heat transfer composition of the invention, including Heat Transfer Compositions 1-109, is provided for use in a residential heat pump system, wherein the residential heat pump system is used to supply warm air (said air having a temperature of for example, about 18° C. to about 24° C., particularly about 21° C.) to buildings in the winter. It can be the same system as the residential air-conditioning system, while in the heat pump mode the refrigerant flow is reversed, and the indoor coil becomes condenser, and the outdoor coil becomes evaporator. Typical system types are split and mini-split heat pump system. The evaporator and condenser are usually a round tube plate fin, a finned or microchannel heat exchanger. The compressor is usually a reciprocating or rotary (rolling-piston or rotary vane) or scroll compressor. The expansion valve is usually a thermal or electronic expansion valve. The refrigerant evaporating temperature is preferably in the range of about −20 to about 3° C. or about −30° C. to about 5° C. The condensing temperature is preferably in the range of about 35° C. to about 50° C.

The heat transfer composition of the invention, including Heat Transfer Compositions 1-109, is provided for use in a commercial air-conditioning system wherein the commercial air conditioning system can be a chiller which is used to supply chilled water (said water having a temperature of for example about 7° C.) to large buildings such as offices and hospitals, etc. Depending on the application, the chiller system may be running all year long. The chiller system may be air-cooled or water-cooled. The air-cooled chiller usually has a plate, tube-in-tube or shell-and-tube evaporator to supply chilled water, a reciprocating or scroll compressor, a round tube plate fin, a finned tube or microchannel condenser to exchange heat with ambient air, and a thermal or electronic expansion valve. The water-cooled system usually has a shell-and-tube evaporator to supply chilled water, a reciprocating, scroll, screw or centrifugal compressor, a shell-and-tube condenser to exchange heat with water from cooling tower or lake, sea and other natural recourses, and a thermal or electronic expansion valve. The refrigerant evaporating temperature is preferably in the range of about 0° C. to about 10° C. The condensing temperature is preferably in the range of about 40° C. to about 70° C.

The heat transfer composition of the invention, including Heat Transfer Compositions 1-109, is provided for use in a residential air-to-water heat pump hydronic system, wherein the residential air-to-water heat pump hydronic system is used to supply hot water (said water having a temperature of for example about 50° C. or about 55° C.) to buildings for floor heating or similar applications in the winter. The hydronic system usually has a round tube plate fin, a finned tube or microchannel evaporator to exchange heat with ambient air, a reciprocating, scroll or rotary compressor, a plate, tube-in-tube or shell-in-tube condenser to heat the water, and a thermal or electronic expansion valve. The refrigerant evaporating temperature is preferably in the range of about −20° C. to about 3° C., or −30° C. to about 5° C. The condensing temperature is preferably in the range of about 50° C. to about 90° C.

The heat transfer composition of the invention, including Heat Transfer Compositions 1-109, is provided for use in a medium temperature refrigeration system, wherein the refrigerant has and evaporating temperature preferably in the range of about −12° C. to about 0° C., and in such systems the refrigerant has a condensing temperature preferably in the range of about 40° C. to about 70° C., or about 20° C. to about 70° C.

The present invention thus provides a medium temperature refrigeration system used to chill food or beverages, such as in a refrigerator or a bottle cooler, wherein the refrigerant has an evaporating temperature preferably in the range of about −12° C. to about 0° C., and in such systems the refrigerant has a condensing temperature preferably in the range of about 40° C. to about 70° C., or about 20° C. to about 70° C.

The medium temperature systems of the present invention, including the systems as described in the immediately preceding paragraphs, preferably have an air-to-refrigerant evaporator to provide chilling, for example to the food or beverage contained therein, a reciprocating, scroll or screw or rotary compressor, an air-to-refrigerant condenser to exchange heat with the ambient air, and a thermal or electronic expansion valve. The heat transfer composition of the invention, including Heat Transfer Compositions 1-109, is provided for use in a low temperature refrigeration system, wherein the refrigerant has an evaporating temperature that is preferably in the range of about −40° C. to about −12° C. and the refrigerant has a condensing temperature that is preferably in the range of about 40° C. to about 70° C., or about 20° C. to about 70° C.

The present invention thus provides a low temperature refrigeration system used to provide cooling in a freezer wherein the heat transfer composition of the invention, including Heat Transfer Compositions 1-109 includes a refrigerant that has an evaporating temperature that is preferably in the range of about −40° C. to about −12° C. and the refrigerant has a condensing temperature that is preferably in the range of about 40° C. to about 70° C., or about 20 to about 70° C.

The present invention thus also provides a low temperature refrigeration system used to provide cooling in an cream machine wherein the heat transfer composition of the invention, including Heat Transfer Compositions 1-109 includes a refrigerant that has an evaporating temperature that is preferably in the range of about −40° C. to about −12° C. and the refrigerant has a condensing temperature that is preferably in the range of about 40° C. to about 70° C., or about 20° C. to about 70° C.

The low temperature systems of the present invention, including the systems as described in the immediately preceding paragraphs, preferably have an air-to-refrigerant evaporator to chill the food or beverage, a reciprocating, scroll or rotary compressor, an air-to-refrigerant condenser to exchange heat with the ambient air, and a thermal or electronic expansion valve.

The present invention therefore provides the use in a chiller of a heat transfer composition of the present invention, including each of Heat Transfer Compositions 1-109 wherein said alkylated naphthalene is AN5 wherein said heat transfer composition further comprises BHT, wherein the AN 5 is provided in an amount of from about 0.001% by weight to about 5% by weight based on the weight of the lubricant and the BHT is provided in an amount of from about 0.001% by weight to about 5% by weight based on the weight of the lubricant.

The present invention therefore provides the use in a chiller of a heat transfer composition of the present invention, including each of Heat Transfer Compositions 1-109 wherein said alkylated naphthalene is AN5 wherein said heat transfer composition further comprises BHT, wherein the AN5 is present in an amount of from about 0.001% by weight to about 5% by weight based on the weight of the lubricant and the BHT is present in an amount of from about 0.001% by weight to about 5% by weight based on the weight of the lubricant.

The present invention therefore provides the use in a chiller of a heat transfer composition of the present invention, including each of Heat Transfer Compositions 1-109 wherein said heat transfer composition further comprises BHT, wherein the AN5 is present in an amount of from about 0.001% by weight to about 5% by weight based on the weight of the heat transfer composition and the BHT is present in an amount of from about 0.001% by weight to about 5% by weight based on the weight of heat transfer composition.

For the purposes of this invention, each heat transfer composition in accordance with the present invention, including each of Heat Transfer Compositions 1-109, is provided for use in a chiller with an evaporating temperature in the range of about 0° C. to about 10° C. and a condensing temperature in the range of about 40° C. to about 70° C. The chiller is provided for use in air conditioning or refrigeration, and preferably for commercial air conditioning. The chiller is preferably a positive displacement chiller, more particularly an air cooled or water-cooled direct expansion chiller, which is either modular or conventionally singularly packaged.

The present invention therefore provides the use of each heat transfer composition in accordance with the present invention, including each of Heat Transfer Compositions 1-109, in stationary air conditioning, particularly residential air conditioning, industrial air conditioning or commercial air conditioning.

The present invention therefore provides the use in stationary air conditioning, particularly residential air conditioning, industrial air conditioning or commercial air conditioning, of a heat transfer composition of the present invention, including each of Heat Transfer Compositions 1-109 wherein said alkylated naphthalene is AN5 and wherein said heat transfer composition further comprises BHT, wherein the AN5 is present in an amount of from about 0.001% by weight to about 5% by weight based on the weight of the lubricant and the BHT is present in an amount of from about 0.001% by weight to about 5% by weight based on the weight of the lubricant.

The present invention therefore provides the use in stationary air conditioning, particularly residential air conditioning, industrial air conditioning or commercial air conditioning, of a heat transfer composition of the present invention, including each of Heat Transfer Compositions 1-109 wherein said alkylated naphthalene is AN5 and wherein said heat transfer composition further comprises BHT, wherein the AN5 is present in an amount of from about 0.001% by weight to about 5% by weight based on the weight of the heat transfer composition and the BHT is present in an amount of from about 0.001% by weight to about 5% by weight based on the weight of heat transfer composition.

Each heat transfer composition in accordance with the present invention, including each of Heat Transfer Compositions 1-109, is provided as a low GWP replacement for the refrigerant R-410A.

Each heat transfer composition in accordance with the present invention, including each of Heat Transfer Compositions 1-109, is provided as a low GWP retrofit for the refrigerant R-410A.

The heat transfer compositions and the refrigerants of the present invention, including each of Heat Transfer Compositions 1-109, therefore can be used as a retrofit refrigerant/heat transfer composition or as a replacement refrigerant/heat transfer composition.

The present invention thus includes methods of retrofitting existing heat transfer system designed for and containing R-410A refrigerant, without requiring substantial engineering modification of the existing system, particularly without modification of the condenser, the evaporator and/or the expansion valve.

The present invention thus also includes methods of using a refrigerant or heat transfer composition of the present invention as a replacement for R-410A, and in particular as a replacement for R-410A in residential air conditioning refrigerant, without requiring substantial engineering modification of the existing system, particularly without modification of the condenser, the evaporator and/or the expansion valve.

The present invention thus also includes methods of using a refrigerant or heat transfer composition of the present invention as a replacement for R-410A, and in particular as a replacement for R-410A in a residential air conditioning system.

The present invention thus also includes methods of using a refrigerant or heat transfer composition of the present invention as a replacement for R-410A, and in particular as a replacement for R-410A in a chiller system.

There is therefore provided a method of retrofitting an existing heat transfer system that contains R-410A refrigerant, said method comprising replacing at least a portion of the existing R-410A refrigerant with a heat transfer composition of the present invention, including each of Heat Transfer Compositions 1-109.

The step of replacing preferably comprises removing at least a substantial portion of, and preferably substantially all of, the existing refrigerant (which can be but is not limited to R-410A) and introducing a heat transfer composition, including each of Heat Transfer Compositions 1-109, without any substantial modification of the system to accommodate the refrigerant of the present invention. Preferably, the method comprises removing at least about 5%, about 10%, about 25%, about 50%, or about 75% by weight of the R-410A from the system and replacing it with the heat transfer compositions of the invention.

Alternatively, the heat transfer composition can be used in a method of retrofitting an existing heat transfer system designed to contain or containing R410A refrigerant, wherein the system is modified for use with a Heat Transfer Composition of the present invention.

Alternatively, the heat transfer composition can be used as a replacement in a heat transfer system which is designed to contain or is suitable for use with R-410A refrigerant.

It will be appreciated that the invention encompasses the use of the heat transfer compositions of the invention, including each of Heat Transfer Compositions 1-109, as a low Global Warming replacement for R-410A or is used in a method of retrofitting an existing heat transfer system or is used in a heat transfer system which is suitable for use with R-410A refrigerant as described herein.

It will be appreciated by the skilled person that when the heat transfer composition is provided for use in a method of retrofitting an existing heat transfer system as described above, the method preferably comprises removing at least a portion of the existing R-410A refrigerant from the system. Preferably, the method comprises removing at least about 5%, about 10%, about 25%, about 50% or about 75% by weight of the R-410A from the system and replacing it with the heat transfer compositions of the invention, including each of Heat Transfer Compositions 1-109.

The heat transfer compositions of the invention, including each of Heat Transfer Compositions 1-109, may be employed as a replacement in systems which are used or are suitable for use with R-410A refrigerant, such as existing or new heat transfer systems.

The compositions of the present invention, including each of Heat Transfer Compositions 1-109, exhibit many of the desirable characteristics of R-410A but have a GWP that is substantially lower than that of R-410A while at the same time having operating characteristics i.e., capacity and/or efficiency (COP) that are substantially similar to or substantially match, and preferably are as high as or higher than R-410A. This allows the present compositions, including each of Heat Transfer Compositions 1-109, to replace R-410A in existing heat transfer systems without requiring any significant system modification for example of the condenser, the evaporator and/or the expansion valve. The present compositions, including each of Heat Transfer Compositions 1-109, can therefore be used as a direct replacement for R-410A in heat transfer systems.

The heat transfer compositions of the invention, including each of Heat Transfer Compositions 1-109, therefore preferably exhibit operating characteristics compared with R-410A wherein the efficiency (COP) of the composition is greater than 90% of the efficiency of R-410A in the heat transfer system.

The heat transfer composition of the invention, including each of Heat Transfer Compositions 1-109, therefore preferably exhibits operating characteristics compared with R-410A wherein the capacity is from 95 to 105% of the capacity of R-410A in the heat transfer system.

It will be appreciated that R-410A is an azeotrope-like composition. Thus, in order for the claimed compositions to be a good match for the operating characteristics of R-410A, the refrigerants included in the heat transfer compositions of the invention, including each of Heat Transfer Compositions 1-109, desirably show a low level of glide. Thus, the refrigerants included in the heat transfer compositions of the invention, including each of Heat Transfer Compositions 1-109, according to invention as described herein may provide an evaporator glide of less than 2° C., preferably less than 1.5° C.

The heat transfer composition of the invention, including each of Heat Transfer Compositions 1-109, therefore preferably exhibits operating characteristics compared with R-410A wherein the efficiency (COP) of the composition is from 100 to 102% of the efficiency of R-410A in the heat transfer system and wherein the capacity is from 92 to 102% of the capacity of R-410A in the heat transfer system.

Preferably, the heat transfer composition of the invention, including each of Heat Transfer Compositions 1-109, preferably exhibits operating characteristics compared with R-410A wherein:
the efficiency (COP) of the composition is from 100 to 105% of the efficiency of R-410A; and/or
the capacity is from 92 to 102% of the capacity of R-410A,
   in heat transfer systems, in which the compositions of the invention are to replace the R-410A refrigerant.

In order to enhance the reliability of the heat transfer system, it is preferred that the heat transfer composition of the invention, including each of Heat Transfer Compositions 1-109, further exhibit the following characteristics compared with R-410A:
the discharge temperature is not greater than 10° C. higher than that of R-410A; and/or
the compressor pressure ratio is from 98 to 102% of the compressor pressure ratio of R-410A,
   in heat transfer systems, in which the composition of the invention is used to replace the R-410A refrigerant.

The present heat transfer compositions, including each of Heat Transfer Compositions 1-109, is used to replace R-410A in air conditioning systems, including both mobile and stationary air conditioning systems. As used here, the term mobile air conditioning systems means mobile, non-passenger car air conditioning systems, such as air conditioning systems in trucks, buses and trains. Thus, each of the heat transfer compositions as described herein, including each of Heat Transfer Compositions 1-109, can be used to replace R-410A in any one of:
an air conditioning system including a mobile air conditioning system, particularly air conditioning systems in trucks, buses and trains,
a mobile heat pump, particularly an electric vehicle heat pump;
a chiller, particularly a positive displacement chiller, more particularly an air cooled or water-cooled direct expansion chiller, which is either modular or conventionally singularly packaged,
a residential air conditioning system, particularly a ducted split or a ductless split air conditioning system,
a residential heat pump,
a residential air to water heat pump/hydronic system,
an industrial air conditioning system and
a commercial air conditioning system particularly a packaged rooftop unit and a variable refrigerant flow (VRF) system;
a commercial air source, water source or ground source heat pump system.

The heat transfer composition of the invention, including each of Heat Transfer Compositions 1-109, may also be provided to replace R410A in refrigeration systems. Thus, each of the heat transfer compositions as described herein, including each of Heat Transfer Compositions 1-109, can be used to replace R10A in in any one of:
a low temperature refrigeration system,
a medium temperature refrigeration system,
a commercial refrigerator,
a commercial freezer,
an ice machine,
a vending machine,
a transport refrigeration system,
a domestic freezer,
a domestic refrigerator,
an industrial freezer,
an industrial refrigerator and
a chiller.

Each of the heat transfer compositions described herein, including each of Heat Transfer Compositions 1-109, is particularly provided to replace R-410A in a residential air-conditioning system (with an evaporator temperature in the range of about 0 to about 10° C., particularly about 7° C. for cooling and/or in the range of about −20 to about 3° C. or 30 to about 5° C., particularly about 0.5° C. for heating). Alternatively, or additionally, each of the heat transfer compositions described herein, including each of Heat Transfer Compositions 1-109, is particularly provided to replace R-410A in a residential air conditioning system with a reciprocating, rotary (rolling-piston or rotary vane) or scroll compressor.

Each of the heat transfer compositions described herein, including each of Heat Transfer Compositions 1-109, is particularly provided to replace R-410A in an air-cooled chiller (with an evaporator temperature in the range of about 0 to about 10° C., particularly about 4.5° C.), particularly an air-cooled chiller with a positive displacement compressor, more particular an air cooled chiller with a reciprocating scroll compressor.

Each of the heat transfer compositions described herein, including each of Heat Transfer Compositions 1-109, is particularly provided to replace R-410A in a residential air to water heat pump hydronic system (with an evaporator temperature in the range of about −20 to about 3° C. or about −30 to about 5° C., particularly about 0.5° C.).

Each of the heat transfer compositions described herein, including each of Heat Transfer Compositions 1-109, is particularly provided to replace R-410A in a medium temperature refrigeration system (with an evaporator temperature in the range of about −12 to about 0° C., particularly about −8° C.).

Each of the heat transfer compositions described herein, including each of Heat Transfer Compositions 1-109, is particularly provided to replace R-410A in a low temperature refrigeration system (with an evaporator temperature in the range of about −40 to about −12° C., particularly from about −40° C. to about −23° C. or preferably about −32° C.).

There is therefore provided a method of retrofitting an existing heat transfer system designed to contain or containing R-410A refrigerant or which is suitable for use with R-410A refrigerant, said method comprising replacing at least a portion of the existing R-410A refrigerant with a heat transfer composition of the present invention, including each of Heat Transfer Compositions 1-109.

There is therefore provided a method of retrofitting an existing heat transfer system designed to contain or containing R-410A refrigerant or which is suitable for use with R-410A refrigerant, said method comprising replacing at least a portion of the existing R-410A refrigerant with a heat transfer composition according to the present invention, including each of Heat Transfer Compositions 1-109.

The invention further provides a heat transfer system comprising a compressor, a condenser and an evaporator in fluid communication, and a heat transfer composition in said system, said heat transfer composition according to the present invention, including each of Heat Transfer Compositions 1-109, wherein the heat transfer system is a residential air-conditioning system (with an evaporator temperature in the range of about 0 to about 10° C., particularly about 7° C. for cooling and/or in the range of about −20 to about 3° C. or about −30 to about 5° C., particularly about 0.5° C. for heating).

The invention further provides a heat transfer system comprising a compressor, a condenser and an evaporator in fluid communication, and a heat transfer composition in said system, said heat transfer composition according to the present invention, including each of Heat Transfer Compositions 1-109, wherein, the heat transfer system is an air-cooled chiller (with an evaporator temperature in the range of about 0° C. to about 10° C., particularly about 4.5° C.), particularly an air-cooled chiller with a positive displacement compressor, more particular an air cooled chiller with a reciprocating or scroll compressor.

The invention further provides a heat transfer system comprising a compressor, a condenser and an evaporator in fluid communication, and a heat transfer composition in said system, said heat transfer composition according to the present invention, including each of Heat Transfer Compositions 1-109, wherein heat transfer system is a residential air to water heat pump hydronic system (with an evaporator temperature in the range of about −20° C. to about 3° C. or about −30° C. to about 5° C., particularly about 0.5° C.).

The invention further provides a heat transfer system comprising a compressor, a condenser and an evaporator in fluid communication, and a heat transfer composition in said system, said heat transfer composition according to the present invention, including each of Heat Transfer Compositions 1-109, wherein heat transfer system can be a refrigeration system, such as a low temperature refrigeration system, a medium temperature refrigeration system, a commercial refrigerator, a commercial freezer, an ice machine, a vending machine, a transport refrigeration system, a domestic freezer, a domestic refrigerator, an industrial freezer, an industrial refrigerator and a chiller.

### EXAMPLES

The refrigerant compositions identified in Table EA below as Refrigerants A1 and A2 are refrigerants within the scope of the present invention as described herein. The parameters selected for conducting the analysis were: same compressor displacement for all refrigerants, same operating conditions for all refrigerants, same compressor isentropic and volumetric efficiency for all refrigerants.

TABLE EA
Refrigerants evaluated for Performance Examples

| | HFC-32 | HFO-1234yf | R1132(E) |
|---|---|---|---|
| Refrigerant | (wt. %) | (wt. %) | (wt. %) |
| A1 | 0% | 50% | 50% |
| A2 | 20% | 40% | 40% |

Refrigerant A1 consists of the two compounds listed in Table EA and Refrigerant A2 consists of the three compounds listed in Table EA in their relative percentages.

### Example 1A—Residential Air-Conditioning System (Cooling)

Residential air-conditioning system is used to supply cool air (26.7° C.) to buildings in the summer. Refrigerants A1 and A2 are used in a residential air-conditioning system as described above and the performance was acceptable. The operating conditions are: condensing temperature=46° C.; condenser sub-cooling=5.5° C.; evaporating temperature=7° C.; evaporator superheat=5.5° C.; isentropic Efficiency=70%; volumetric efficiency=100%; and temperature rise in Suction Line=5.5° C.

### Example 1B.—Residential Air-Conditioning System with POE Lubricant and Stabilizer Comprising AN4 and ADM4 (Cooling)

A residential air-conditioning system is configured to supply cool air in accordance with Example 1A, and POE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05% to about 2.5%, based on the weight of the lubricant plus stabilizer). The system so configured operates continuously for an extended period of days, and after such operation the lubricant is tested and is found to have remained stable during such actual operation.

### Example 1C.—Residential Air-Conditioning System with PVE Lubricant and Stabilizer Comprising AN4 and ADM4 (Cooling)

A residential air-conditioning system is configured to supply cool air in accordance with Example 1A, and PVE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05% to about 2.5% based on the weight of the lubricant plus stabilizer). The system so configured operates continuously for an extended period of days, and after such operation the lubricant is tested and is found to have remained stable during such actual operation.

### Example 1D.—Residential Air-Conditioning System with POE Lubricant and Stabilizer Comprising AN4 and ADM6 (Cooling)

A residential air-conditioning system is configured to supply cool air in accordance with Example 1A, and POE lubricant was included in the system and was stabilized with alkylated naphthalene according to the present invention (AN4 in an amount of from about 2% to about 10% based on the weight of the lubricant) and ADM according to the present invention (ADM6 in an amount of about 0.05% to about 2.5% based on the weight of the lubricant plus stabilizer). The system so configured operated continuously for an extended period of days, and after such operation the lubricant was tested and was found to have remained stable during such actual operation.

### Example 1E.—Residential Air-Conditioning System with PVE Lubricant and Stabilizer Comprising AN4 and ADM6 (Cooling)

A residential air-conditioning system is configured to supply cool air in accordance with Example 1A, and PVE lubricant was included in the system and was stabilized with alkylated naphthalene according to the present invention (AN4 in an amount of from about 2% to about 10% based on the weight of the lubricant) and ADM according to the present invention (ADM6 in an amount of about 0.05% to about 2.5% based on the weight of the lubricant plus stabilizer). The system so configured operated continuously for an extended period of days, and after such operation the lubricant was tested and was found to have remained stable during such actual operation.

### Example 1F.—Residential Air-Conditioning System with Heat Transfer Compositions 1 Through 109 (Cooling)

A residential air-conditioning system is configured to supply cool air in accordance with Example 1A except that each of Heat Transfer Compositions 1-109 is used in a separate run as heat transfer composition instead of the composition in Example 1A. In each case with each of Heat Transfer Compositions 1-109, the system so configured operates continuously for an extended period of days, and after such operation the heat transfer composition, and any lubricant included in the composition, is tested and is found to have remained stable during such actual operation.

### Example 2A—Residential Heat Pump System (Heating)

A residential heat pump system is used to supply warm air (21.1° C.) to buildings in the winter. Refrigerants A1 and A2 are used in a residential heat pump system as described above and the performance was found to be acceptable. The operating conditions are: condensing temperature=41° C.; condenser sub-cooling=5.5° C.; evaporating temperature=0.5° C.; evaporator superheat=5.5° C.; isentropic efficiency=70%; volumetric efficiency=100%; and temperature rise in suction line=5.5° C.

### Example 2B.—Residential Heat Pump System with POE Lubricant and Stabilizer Comprising AN4 and ADM4 (Heating)

A heat pump system is configured in accordance with Example 2A, and POE lubricant was included in the system with alkylated naphthalene stabilizer according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 2B.—Residential Heat Pump System with PVE Lubricant and Stabilizer Comprising AN4 and ADM4 (Heating)

A heat pump system is configured in accordance with Example 2A, and PVE lubricant was included in the system with alkylated naphthalene stabilizer according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 2D.—Residential Heat Pump System with POE Lubricant and Stabilizer Comprising AN4 and ADM6 (Heating)

A heat pump system was configured in accordance with Example 2A in which POE lubricant was included in the system and was stabilized with alkylated naphthalene according to the present invention (AN4 in an amount of from about 2% to about 10% based on the weight of the lubricant) and ADM according to the present invention (ADM6 in an amount of about 0.05-2.5% by weight based on the weight of the lubricant). The system so configured operated continuously for an extended period of days, and after such operation the lubricant was tested and was found to have remained stable during such actual operation.

### Example 2E.—Residential Heat Pump System with PVE Lubricant and Stabilizer Comprising AN4 and ADM6 (Heating)

A heat pump system was configured in accordance with Example 2A in which PVE lubricant was included in the system and was stabilized with alkylated naphthalene according to the present invention (AN4 in an amount of from about 2% to about 10% based on the weight of the lubricant) and ADM according to the present invention (ADM6 in an amount of about 0.05-2.5% by weight based on the weight of the lubricant). The system so configured operated continuously for an extended period of days, and after such operation the lubricant was tested and was found to have remained stable during such actual operation.

### Example 2F.—Residential Heat Pump System with Heat Transfer Compositions 1 Through 109 (Heating)

A system is configured in accordance with Example 2A except that each of Heat Transfer Compositions 1-109 is used in a separate run instead of the heat transfer composition of Example 2A. In each case with each of Heat Transfer Compositions 1-109, the system so configured operates continuously for an extended period of days, and after such operation the heat transfer composition, and any lubricant included in the composition, is tested and is found to have remained stable during such actual operation.

### Example 3A—Commercial Air-Conditioning System—Chiller

Commercial air-conditioning system (chiller) is used to supply chilled water (7° C.) to large buildings such as office and hospital, etc. Refrigerants A1 and A2 are used in a commercial air-conditioning system as described above and the performance was found to be acceptable. The operating conditions are: condensing temperature=46° C.; condenser sub-cooling=5.5° C.; evaporating temperature=4.5° C.; evaporator superheat=5.5° C.; isentropic efficiency=70%; volumetric efficiency=100%; and temperature rise in suction line=2° C.

### Example 3B. Commercial Air-Conditioning System with POE Lubricant and Stabilizer Comprising AN4 and ADM4—Chiller

A commercial air conditioning is configured in accordance with Example 3A in which POE lubricant is included in the system and is stabilized with alkylated naphthalene according to the present invention (AN4 in an amount of from about 2% to about 10% based on the weight of the lubricant) and ADM according to the present invention (ADM4 in an amount of about 0.05-2.5% by weight based on the weight of the lubricant). The system so configured operates continuously for an extended period of days, and after such operation the lubricant is tested and was found to have remained stable during such actual operation.

### Example 3C. Commercial Air-Conditioning System with PVE Lubricant and Stabilizer Comprising AN4 and ADM4—Chiller

A commercial air conditioning is configured in accordance with Example 3A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 3D. Commercial Air-Conditioning System with POE Lubricant and Stabilizer Comprising AN4 and ADM6—Chiller

A commercial air conditioning is configured in accordance with Example 3A in which POE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 3E. Commercial Air-Conditioning System with PVE Lubricant and Stabilizer Comprising AN4 and ADM6—Chiller

A commercial air conditioning is configured in accordance with Example 3A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 3F. Commercial Air-Conditioning System with Heat Transfer Compositions 1 Through 109—Chiller

A system is configured in accordance with Example 3A except that each of Heat Transfer Compositions 1-109 is used in a separate run instead of the heat transfer composition of Example 3A. In each case with each of HTCs 1-109, the system so configured operates continuously for an extended period of days, and after such operation the heat transfer composition, and any lubricant included in the composition, is tested and is found to have remained stable during such actual operation.

### Example 4A—Residential Air-to-Water Heat Pump—Hydronic System

Residential air-to-water heat pump hydronic system is used to supply hot water (50° C.) to buildings for floor heating or similar applications in the winter. Refrigerants A1 and A2 were used in a residential heat pump system as described above and the performance is found to be acceptable. The operating conditions are: condensing temperature=60° C.; condenser sub-cooling=5.5° C.; evaporating temperature=0.5° C.; evaporator superheat=5.5° C.; isentropic efficiency=70%; volumetric Efficiency=100%; and temperature rise in suction line=2° C.

### Example 4B.—Residential Air-to-Water Heat Pump Hydronic System with POE Lubricant and Stabilizer Comprising AN4 and ADM4

A residential air-to-water heat pump hydronic system is configured in accordance with Example 4A in which POE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 4C.—Residential Air-to-Water Heat Pump Hydronic System with PVE Lubricant and Stabilizer Comprising AN4 and ADM4

A residential air-to-water heat pump hydronic system is configured in accordance with Example 4A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 4D.—Residential Air-to-Water Heat Pump Hydronic System with POE Lubricant and Stabilizer Comprising AN4 and ADM6

A residential air-to-water heat pump hydronic system is configured in accordance with Example 4A in which POE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 4E.—Residential Air-to-Water Heat Pump Hydronic System with PVE Lubricant and Stabilizer Comprising AN4 and ADM6

A residential air-to-water heat pump hydronic system is configured in accordance with Example 4A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 4F.—Residential Air-to-Water Heat Pump Hydronic System with Heat Transfer Compositions 1 Through 109

A system is configured in accordance with Example 4A except that each of Heat Transfer Compositions 1-109 is used in a separate run instead of the heat transfer composition of Example 4A. In each case with each of Heat Transfer Compositions 1-109, the system so configured operates continuously for an extended period of days, and after such operation the heat transfer composition, and any lubricant included in the composition, is tested and is found to have remained stable during such actual operation.

### Example 5A—Medium Temperature Refrigeration System

Medium temperature refrigeration system is used to chill the food or beverage such as in refrigerator and bottle cooler. Refrigerants A1 and A2 are used in a simulation of a medium temperature refrigeration system as described above and the performance is acceptable. The operating conditions: condensing temperature=40.6° C.; condenser sub-cooling=0° C. (system with receiver); evaporating temperature=−6.7° C.; evaporator superheat=5.5° C.; isentropic efficiency=70%; volumetric efficiency=100%; and degree of superheat in the suction line=19.5° C.

### Example 5B. Medium Temperature Refrigeration System with POE Lubricant and Stabilizer Comprising AN4 and ADM4

A medium temperature refrigeration system is configured to chill food or beverages such as in a refrigerator and bottle cooler is configured in accordance with Example 5A in which POE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 5C. Medium Temperature Refrigeration System with PVE Lubricant and Stabilizer Comprising AN4 and ADM4

A medium temperature refrigeration system is configured to chill food or beverages such as in a refrigerator and bottle cooler is configured in accordance with Example 5A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 5D. Medium Temperature Refrigeration System with POE Lubricant and Stabilizer Comprising AN4 and ADM6

A medium temperature refrigeration system is configured to chill food or beverages such as in a refrigerator and bottle cooler is configured in accordance with Example 5A in which POE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 5E. Medium Temperature Refrigeration System with PVE Lubricant and Stabilizer Comprising AN4 and ADM6

A medium temperature refrigeration system is configured to chill food or beverages such as in a refrigerator and bottle cooler is configured in accordance with Example 5A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 5F.—Medium Temperature Refrigeration System with Heat Transfer Compositions 1 Through 109

A system is configured in accordance with Example 5A except that each of Heat Transfer Compositions 1-109 is used in a separate run instead of the heat transfer composition of Example 5A. In each case with each of Heat Transfer Compositions 1-109, the system so configured operates continuously for an extended period of days, and after such operation the heat transfer composition, and any lubricant included in the composition, is tested and is found to have remained stable during such actual operation.

### Example 6A—Low Temperature Refrigeration System

Low temperature refrigeration system is used to freeze the food such as in ice cream machine and freezer. Refrigerants A1 and A2a are used in a low temperature refrigeration system as described above and the performance is found to be acceptable. The operating conditions: condensing temperature=40.6° C.; condenser sub-cooling=0° C. (system with receiver); evaporating temperature=−28.9° C.; degree of superheat at evaporator outlet=5.5° C.; isentropic efficiency=65%; volumetric efficiency=100%; and degree of superheat in the suction line=44.4° C.

### Example 6B. Low Temperature Refrigeration System with POE Lubricant and Stabilizer Comprising AN4 and ADM4

A low temperature refrigeration system is configured to freeze food such as in an ice cream machine and a freezer is configured in accordance with Example 6A in which POE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 6C. Low Temperature Refrigeration System with PVE Lubricant and Stabilizer Comprising AN4 and ADM4

A low temperature refrigeration system is configured to freeze food such as in an ice cream machine and a freezer is configured in accordance with Example 6A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 6D. Low Temperature Refrigeration System with POE Lubricant and Stabilizer Comprising AN4 and ADM6

A low temperature refrigeration system is configured to freeze food such as in an ice cream machine and a freezer is configured in accordance with Example 6A in which POE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 6E. Low Temperature Refrigeration System with PVE Lubricant and Stabilizer Comprising AN4 and ADM6

A low temperature refrigeration system is configured to freeze food such as in an ice cream machine and a freezer is configured in accordance with Example 6A in which PVE lubricant is included in the system and is stabilized with alkylated naphthalene according to the present invention (AN4 in an amount of from about 2% to about 10% based on the weight of the lubricant) and ADM according to the present invention (ADM4 in an amount of about 0.05-2.5 by weight based on the weight of the lubricant). The system so configured operates continuously for an extended period of days, and after such operation the lubricant is tested and was found to have remained stable during such actual operation.

### Example 6F—Low Temperature Refrigeration System with Heat Transfer Compositions 1-109

A system is configured in accordance with Example 6A except that each of Heat Transfer Compositions 1-109 is used in a separate run instead of the heat transfer composition of Example 6A. In each case with each of Heat Transfer Compositions 1-109, the system so configured operates continuously for an extended period of days, and after such operation the heat transfer composition, and any lubricant included in the composition, is tested and is found to have remained stable during such actual operation.

### Example 7A. Commercial Air-Conditioning System—Packaged Rooftops

A packaged rooftop commercial air conditioning system configured to supply cooled or heated air to buildings is tested. The experimental system includes a packaged rooftop air-conditioning/heat pump systems and has an air-to-refrigerant evaporator (indoor coil), a compressor, an air-to-refrigerant condenser (outdoor coil), and an expansion valve. The testing described herein is representative of the results from such systems. The operating conditions for the test are:
1. Condensing temperature=about 46° C. (corresponding outdoor ambient temperature=about 67° C.)
2. Condenser sub-cooling=about 5.5° C.
3. Evaporating temperature=about 7° C. (corresponding indoor ambient temperature=26.7° C.)
4. Evaporator Superheat=about 5.5° C.
5. Isentropic Efficiency=70%
6. Volumetric Efficiency=100%
7. Temperature Rise in Suction Line=5.5° C.

The performance with each of refrigerants A1 and A2 is found to be acceptable.

### Example 7B. Commercial Air-Conditioning System with POE Lubricant and Stabilizer Comprising AN4 and ADM4—Packaged Rooftops

A packaged rooftop commercial air conditioning system is configured to supply cooled or heated air to buildings in accordance with Example 7A in which POE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and is found to have remained stable during such actual operation.

### Example 7C. Commercial Air-Conditioning System with PVE Lubricant and Stabilizer Comprising AN4 and ADM4—Packaged Rooftops

A packaged rooftop commercial air conditioning system is configured to supply cooled or heated air to buildings in accordance with Example 7A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and is found to have remained stable during such actual operation.

### Example 7D. Commercial Air-Conditioning System with POE Lubricant and Stabilizer Comprising AN4 and ADM6—Packaged Rooftops

A packaged rooftop commercial air conditioning system is configured to supply cooled or heated air to buildings in accordance with Example 7A in which POE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and is found to have remained stable during such actual operation.

### Example 7E. Commercial Air-Conditioning System with PVE Lubricant and Stabilizer Comprising AN4 and ADM6—Packaged Rooftops

A packaged rooftop commercial air conditioning system is configured to supply cooled or heated air to buildings in accordance with Example 7A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and is found to have remained stable during such actual operation.

### Example 7F. Commercial Air-Conditioning System with Heat Transfer Compositions 1 Through 109—Packaged Rooftops

A system is configured in accordance with Example 7A except that each of Heat Transfer Compositions 1-109 is used in a separate run instead of the heat transfer composition of Example 7A. In each case with each of Heat Transfer Compositions 1-109, the system so configured operates continuously for an extended period of days, and after such operation the heat transfer composition, and any lubricant included in the composition, is tested and is found to have remained stable during such actual operation.

### Example 8A—Commercial Air-Conditioning System—Variable Refrigerant Flow Systems

A commercial air-conditioning system with variable refrigerant flow is configured to supply cooled or heated air to buildings is tested. The experimental system includes multiple (4 or more) air-to-refrigerant evaporators (indoor coils), a compressor, an air-to-refrigerant condenser (outdoor coil), and an expansion valve. The testing described herein is representative of the results from such systems. The operating conditions for the test are:
1. Condensing temperature=about 46° C., Corresponding outdoor ambient temperature=67° C.
2. Condenser sub-cooling=about 5.5° C.
3. Evaporating temperature=about 7° C. (corresponding indoor ambient temperature=26.7° C.)
4. Evaporator Superheat=about 5.5° C.
5. Isentropic Efficiency=70%
6. Volumetric Efficiency=100%
7. Temperature Rise in Suction Line=5.5° C. The performance with each of refrigerants A1 and A2 is found to be acceptable.

### Example 8B. Commercial Air-Conditioning System with POE Lubricant and Stabilizer Comprising AN4 and ADM4—Variable Flow Refrigerant

A commercial air-conditioning system with variable refrigerant flow is configured to supply cooled or heated air to buildings is configured in accordance with Example 8A in which POE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 8C. Commercial Air-Conditioning System with PVE Lubricant and Stabilizer Comprising AN4 and ADM4—Variable Flow Refrigerant

A commercial air-conditioning system with variable refrigerant flow is configured to supply cooled or heated air to buildings is configured in accordance with Example 8A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM4 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 8D. Commercial Air-Conditioning System with POE Lubricant and Stabilizer Comprising AN4 and ADM6—Variable Flow Refrigerant

A commercial air-conditioning system with variable refrigerant flow is configured to supply cooled or heated air to buildings is configured in accordance with Example 8A in which POE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 8E. Commercial Air-Conditioning System with PVE Lubricant and Stabilizer Comprising AN4 and ADM6—Variable Flow Refrigerant

A commercial air-conditioning system with variable refrigerant flow is configured to supply cooled or heated air to buildings is configured in accordance with Example 8A in which PVE lubricant is included in the system and is stabilized with alkylated naphthalene according to the present invention (AN4 in an amount of from about 2% to about 10% based on the weight of the lubricant plus stabilizer) and ADM according to the present invention (ADM6 in an amount of about 0.05-2.5% by weight based on the weight of the lubricant plus stabilizer). The system so configured operates continuously for an extended period of days, and after such operation the lubricant is tested and was found to have remained stable during such actual operation.

### Example 8F. Commercial Air-Conditioning System with Heat Transfer Compositions 1 Through 109—Variable Flow Refrigerant

A system is configured in accordance with Example 8A except that each of Heat Transfer Compositions 1-109 is used in a separate run instead of the heat transfer composition of Example 8A. In each case with each of Heat Transfer Compositions 1-109, the system so configured operates continuously for an extended period of days, and after such operation the heat transfer composition, and any lubricant included in the composition, is tested and is found to have remained stable during such actual operation.

### Comparative Example 1—Heat Transfer Compositions Comprising Refrigerant and POE Lubricant and BHT

A heat transfer composition of the present invention is tested in accordance with ASHRAE Standard 97—“Sealed Glass Tube Method to Test the Chemical Stability of Materials for Use within Refrigerant Systems” to simulate long-term stability of the heat transfer compositions by accelerated aging. The tested refrigerant consists of 50% by weight HFO-1234yf and 50% by weight of R1132(E)), with 1.7 volume % air in the refrigerant. The POE lubricant tested was an ISO 32 POE having a viscosity at 40° C. of about 32 cSt and having a moisture content of 300 ppm or less (Lubricant A). Included with the lubricant is the stabilizer BHT, but no alkylated naphthalene and no ADM were included. After testing, the fluid is observed evidence of instability is found.

### Example 9—Stabilizers for Heat Transfer Compositions Comprising Refrigerant and Lubricant

The test of Comparative Example 1 is repeated except that 2% by weight of alkylated naphthalene (AN4) based on the weight of the lubricant is added, and after testing as indicated in Comparative Example 1, stability is found to be unexpectedly improved. Example 10—Stabilizers for Heat Transfer Compositions Comprising Refrigerant and Lubricant

The test of Example 9 is repeated except that 4% by weight of alkylated naphthalene (AN4) based on the weight of the lubricant is added. The results are similar to the results of Example 9.

### Example 11—Stabilizers for Heat Transfer Compositions Comprising Refrigerant and Lubricant

The test of Example 9 is repeated except that 6% by weight of alkylated naphthalene (AN4) based on the weight of the lubricant is added. The results are similar to the results of Example 9.

### Example 12—Stabilizers for Heat Transfer Compositions Comprising Refrigerant and Lubricant

The test of Example 9 is repeated except that 8% by weight of alkylated naphthalene (AN4) based on the weight of the lubricant is added. The results are similar to the results of Example 9.

### Example 13—Stabilizers for Heat Transfer Compositions Comprising Refrigerant and Lubricant

The test of Example 9 is repeated except that 10% by weight of alkylated naphthalene (AN4) based on the weight of the lubricant is added. The results are similar to the results of Example 9.

### Example 13A—Stabilizers for Heat Transfer Compositions Comprising Refrigerant and Lubricant

The test of Example 13 is repeated except that in addition to the 10% by weight of alkylated naphthalene (AN4) based on the weight of the lubricant being added, 1000 ppm by weight (0.1% by weight) of ADM (ADM4) is also added. Unexpectedly improved results are achieved

### Example 13B—Stabilizers for Heat Transfer Compositions Comprising Refrigerant and Lubricant

The test of Example 13A is repeated except that in addition to the 10% by weight of alkylated naphthalene (AN4) based on the weight of the lubricant being added, 1000 ppm by weight (0.1% by weight) of ADM (ADM6) is also added. The results are similar to Example 13A.

### Comparative Example 2—Heat Transfer Compositions Comprising Refrigerant and PVE Lubricant and BHT

A heat transfer composition of the present invention is tested in accordance with ASHRAE Standard 97—“Sealed Glass Tube Method to Test the Chemical Stability of Materials for Use within Refrigerant Systems” to simulate long-term stability of the heat transfer compositions by accelerated aging. The tested refrigerant consists of 50% by weight HFO-1234yf and 50% by weight of R1132(E)), with 1.7 volume % air in the refrigerant. The PVE lubricant tested was ISO 68 PVE having a viscosity at 40° C. of about 68 cSt and having a moisture content of 300 ppm or less (Lubricant B). Included with the lubricant is the stabilizer BHT, but no alkylated naphthalene and no ADM are included. After testing, the fluid is observed and evidence of instability is found.

### Example 14—Stabilizers for Heat Transfer Compositions Comprising Refrigerant and PVE Lubricant

The test of Comparative Example 2 is repeated except that 2% by weight of alkylated naphthalene (AN4) based on the weight of the lubricant is added, and after testing as indicated in Comparative Example 2, stability is found to be unexpectedly improved.

### Example 15—Stabilizers for Heat Transfer Compositions Comprising Refrigerant and Lubricant

The test of Example 14 is repeated except that 4% by weight of alkylated naphthalene (AN4) based on the weight of the lubricant is added. The results are similar to the results of Example 14.

### Example 16—Stabilizers for Heat Transfer Compositions Comprising Refrigerant and PVE Lubricant

The test of Example 14 is repeated except that 6% by weight of alkylated naphthalene (AN4) based on the weight of the lubricant is added. The results are similar to the results of Example 14.

### Example 17—Stabilizers for Heat Transfer Compositions Comprising Refrigerant and Lubricant

The test of Example 14 is repeated except that 8% by weight of alkylated naphthalene (AN4) based on the weight of the lubricant is added. The results are similar to the results of Example 14.

### Example 18—Stabilizers for Heat Transfer Compositions Comprising Refrigerant and Lubricant

The test of Example 14 is repeated except that 10% by weight of alkylated naphthalene (AN4) based on the weight of the lubricant is added. The results are similar to the results of Example 14.

### Example 18A—Stabilizers for Heat Transfer Compositions Comprising Refrigerant and PVE Lubricant

The test of Example 18 is repeated except that in addition to the 10% by weight of alkylated naphthalene (AN4) based on the weight of the lubricant being added, 1000 ppm by weight (0.1% by weight) of ADM (ADM4) is also added. Unexpectedly improved results are achieved.

### Example 18B—Stabilizers for Heat Transfer Compositions Comprising Refrigerant and PVE Lubricant

The test of Example 18A is repeated except that in addition to the 10% by weight of alkylated naphthalene (AN4) based on the weight of the lubricant being added, 1000 ppm by weight (0.1% by weight) of ADM (ADM6) is also added. The results are similar to Example 18A.

1. A heat transfer composition comprising refrigerant, lubricant and stabilizer, said refrigerant comprising from about 5% by weight to 100% by weight of trans-1,2-difluorethylene (R1132(E)), said lubricant comprising polyol ester (POE) lubricant and/or polyvinyl ether (PVE) lubricant, and said stabilizer comprising from 1% to less than 10% by weight of AN4 and from about 0.05 to % about 2.5% of one or more compounds according to AMD1, wherein said amounts of said stabilizer components is based on the weight of the lubricant and stabilizer.

2. The heat transfer composition of claim 1 wherein said alkylated naphthalene is present in the composition in an amount of from 1% to 8% by weight based on the weight of the lubricant and the stabilizer.

3. The heat transfer composition of claim 1 wherein said alkylated naphthalene is present in the composition in an amount of from 1.5% to 6% by weight based on the weight of the lubricant and the stabilizer.

4. The heat transfer composition claim 1 wherein said lubricant is a PVE lubricant.

5. The heat transfer composition claim 1 wherein said lubricant is a PVE lubricant.

6. The heat transfer composition claim 4 wherein said at least one compound according to AMD1 comprises ADM4.

7. The heat transfer composition claim 4 wherein said at least one compound according to AMD1 comprises ADM6.

8. The heat transfer composition claim 5 wherein said at least one compound according to AMD1 comprises ADM4.

9. The heat transfer composition claim 5 wherein said at least one compound according to AMD1 comprises ADM6.

10. The heat transfer composition claim 1 wherein said stabilizer comprises from about 40% by weight to about 99.9% of AN4 and from 0.05% to about 50% by weight of said ADM6 based on the weight of the stabilizer.

11. The heat transfer composition of claim 10 wherein said stabilizer further comprises a phenol.

12. The heat transfer composition of claim 10 wherein said stabilizer further comprises a phosphate.

13. The heat transfer composition of claim 10 wherein said stabilizer further comprises a triaryl phosphate.

14. The heat transfer composition of claim 10 wherein said stabilizer further comprises a trialkyl phosphate.

15. A heat transfer composition comprising refrigerant, lubricant and stabilizer, said refrigerant comprising from about 5% by weight to 100% by weight of trans-1,2-difluorethylene (R1132(E)), said lubricant comprising polyol ester (POE) lubricant and/or polyvinyl ether (PVE) lubricant, and said stabilizer comprising AN4, AN5 or AN10 and combinations of these and an ADM comprising ADM4, ADM5, ADM5A or ADM6 and combinations of these, wherein said ANs and ADMs together comprises from 1% to less than 10% by weight based on the weight of the ANs, ADMs and the lubricant.

16. The heat transfer composition of claim 15 wherein said stabilizer comprises AN10 and ADM4.

17. The heat transfer composition of claim 15 wherein said stabilizer comprises AN5 and ADM6.

18. The heat transfer composition of claim 15 wherein said stabilizer comprises AN10 and ADM6.

19. The heat transfer composition of claim 15 wherein said stabilizer comprises AN4 and ADM5A.

20. The heat transfer composition of claim 15 wherein said stabilizer comprises AN10 and ADM5A.
